(19) United States
(12) Patent Application Publication
(10) Pub. No.: US 2026/0350540 A1
(43) Pub. Date: Nov. 5, 2026

(54) System and Method for AI-Powered Dynamic Advertisement Generation, Testing, and Optimization Across Multiple Channels

(71) Applicant: TapText llc, Coral Springs, FL (US)

(72) Inventor: Steve Doumar, Fort Lauderdale, FL (US)

(21) Appl. No.: 19/740,547

(22) Filed: Jul. 14, 2026

Related U.S. Application Data
(63) Continuation-in-part of application No. 18/952,899, filed on Nov. 19, 2024, now Pat. No. 12,718,198.
Application No. 18/952,899 is a continuation of application No. 18/365,953, filed on Aug. 4, 2023, now Pat. No. 12,147,996.
Application No. 18/365,953 is a continuation of application No. 17/967,606, filed on Oct. 17, 2022, now Pat. No. 12,293,379.
Application No. 17/967,606 is a continuation-in-part of application No. 17/879,605, filed on Aug. 2, 2022, now Pat. No. 11,657,424.
Application No. 17/879,605 is a continuation-in-part of application No. 17/209,474, filed on Mar. 23, 2021, now Pat. No. 11,599,916.
Application No. 17/209,474 is a continuation-in-part of application No. 17/208,059, filed on Mar. 22, 2021, now Pat. No. 11,562,407.
Application No. 17/208,059 is a continuation-in-part of application No. 17/191,977, filed on Mar. 4, 2021, now abandoned.
Application No. 17/191,977 is a continuation-in-part of application No. 17/190,260, filed on Mar. 2, 2021, now Pat. No. 11,532,020.
Application No. 17/190,260 is a continuation-in-part of application No. 17/153,426, filed on Jan. 20, 2021, now abandoned.
Application No. 17/879,605 is a continuation-in-part of application No. 16/930,816, filed on Jul. 16, 2020, now Pat. No. 11,403,666.
Application No. 17/967,606 is a continuation-in-part of application No. 17/351,321, filed on Jun. 18, 2021, now Pat. No. 11,201,965.
Application No. 17/351,321 is a continuation of application No. 17/349,659, filed on Jun. 16, 2021, now Pat. No. 11,488,188.
Application No. 17/349,659 is a continuation of application No. 17/348,660, filed on Jun. 15, 2021, now Pat. No. 11,232,471.
Application No. 17/348,660 is a continuation of application No. 17/344,695, filed on Jun. 10, 2021, now Pat. No. 11,354,691.
Application No. 17/344,695 is a continuation of application No. 17/229,251, filed on Apr. 13, 2021, now abandoned.
Application No. 17/229,251 is a continuation-in-part of application No. 17/209,474, filed on Mar. 23, 2021, now Pat. No. 11,599,916.
(60) Provisional application No. 63/154,357, filed on Feb. 26, 2021.
(60) Provisional application No. 63/166,391, filed on Mar. 26, 2021.
(60) Provisional application No. 63/235,785, filed on Aug. 22, 2021.

(51) Int. Cl. G06Q 10/10; G06F 16/955; G06F 21/32; G06F 21/62; G06K 7/14; G06K 19/06; G06N 20/00; G06Q 10/0631; G06Q 10/40; G06Q 30/016; G06Q 30/0201; G06Q 30/0207; G06Q 30/0251; H04M 3/523; H04M 3/527; H04M 3/533; H04W 4/14

(52) U.S. Cl. CPC G06Q 10/10; G06F 16/9554; G06F 16/9558; G06F 21/32; G06F 21/6245; G06K 7/1417; G06K 19/06037; G06N 20/00; G06Q 10/06315; G06Q 10/40; G06Q 30/016; G06Q 30/0201; G06Q 30/0207; G06Q 30/0212; H04M 3/523; H04M 3/527; H04M 3/53308; H04M 3/53333; H04W 4/14; G06F 2221/2139; G06Q 30/0267

(57) ABSTRACT

A system and method for AI-powered dynamic advertisement generation, testing, and optimization. The system comprises a multi-platform adaptive ad campaign manager, an AI-powered advertisement generator, a personalization engine, a dynamic advertisement engine, a campaign database, and an omnichannel text-based communicator. The system utilizes artificial intelligence including deep learning, computer vision, natural language processing, and reinforcement learning to automatically generate and optimize advertisement variants. The system processes customer interactions, establishes real-time personalized media streams between customers and business representatives, and monitors engagement through analytics. Machine learning models analyze performance data to determine variant effectiveness and predict future performance, while generative AI creates new variants and real-time personalization engines customize content delivery. This integrated system combines automated content generation, intelligent testing, and advanced analytics into a continuous learning advertising platform.

### CROSS-REFERENCE TO RELATED APPLICATION

Priority is claimed in the application data sheet to the following patents or patent applications, each of which is expressly incorporated herein by reference in its entirety:
Ser. No. 18/952,899
Ser. No. 18/365,953
Ser. No. 17/967,606
Ser. No. 17/879,605
63/235,785
Ser. No. 17/209,474
Ser. No. 17/208,059
Ser. No. 17/191,977
Ser. No. 17/190,260
Ser. No. 17/153,426
63/154,357
Ser. No. 16/930,816
Ser. No. 17/351,321
Ser. No. 17/349,659
Ser. No. 17/348,660
Ser. No. 17/344,695
Ser. No. 17/229,251
63/166,391

### BACKGROUND OF THE INVENTION

### Field of the Art

The disclosure relates to the field of artificial intelligence-enhanced advertising systems, specifically to systems combining deep learning, computer vision, natural language processing, and reinforcement learning for dynamic advertisement generation and optimization. More particularly, the disclosure relates to integrated systems that combine AI-powered advertisement creation, real-time personalization, multi-channel optimization, and intelligent communication routing to create, test, and optimize advertising content while facilitating seamless customer-business interactions through omnichannel communications.

### Discussion of the State of the Art

Business enterprises often communicate with their customers in a siloed non-contextual approach offering one generic customer experience for in-store interactions; another for Internet website accessed via a fixed compute device; and yet another experience from a mobile device. In each case, generic communications modes are made available to the customer requiring them to navigate various screens and options when all they really want is assistance with their pre- or post-sales transaction from a resource knowing their unique history using a communication mode of their choosing. Moreover, when a customer does require assistance with their transaction, they want to accomplish it without introducing unnecessary delay while using their preferred mode of communication, whether text, chat or email. From the business enterprise perspective, they are often already heavily invested in traditional call centers systems and human resources (agents) and therefore drive their customers to these resources when oftentimes better resources existing outside the call center. Additionally, businesses struggle to create and optimize advertising content that resonates with individual customers across multiple channels, relying instead on generic, non-personalized advertisements that fail to leverage historical performance data or real-time customer behavior. The end result is often a near-term suboptimal experience for the customer and potential loss of sale and long-term viability for the business.

There is currently no system that combines AI-powered advertisement generation and optimization with omnichannel customer communication across all business enterprise resources that address these shortcomings. Existing systems lack the ability to automatically generate, test, and optimize advertisement variants using machine learning, computer vision, and natural language processing while simultaneously personalizing content delivery and managing customer interactions in real-time.

What is needed is an integrated system and method that combines AI-powered advertisement generation and optimization with optimized omnichannel customer interaction, utilizing advanced machine learning techniques for content creation, real-time personalization, and intelligent communication routing. Such a system should leverage deep learning models for pattern recognition, computer vision for visual element analysis, natural language processing for copy optimization, and reinforcement learning for cross-channel optimization, while maintaining seamless text-based communication resulting in short and long-term business competitive advantage and viability.

### SUMMARY OF THE INVENTION

Accordingly, the inventor has conceived, and reduced to practice, a system and method for AI-powered dynamic advertisement generation and testing. The system comprises a multi-platform adaptive ad campaign manager, a personalization engine, a dynamic advertisement engine, a campaign database, and an omnichannel text-based communicator. The system utilizes advanced artificial intelligence techniques including deep learning, computer vision, natural language processing, and reinforcement learning to automatically generate, test, and optimize advertisement variants. The system receives customer interactions with advertisement test variants, establishes a real-time media stream between a customer device and a second user device, and monitors the media stream to collect data related to effectiveness of the advertisement variants. The system analyzes media stream data together with a plurality of other data types using machine learning models to statistically determine variant performance and predict future outcomes. The system uses generative AI models to create new advertisement variants and implements real-time personalization for content delivery across multiple channels.

According to a first preferred embodiment, a system for AI-powered dynamic advertisement testing and generation, comprising: an AI-powered advertisement generator that analyzes historical data using deep learning models, implements computer vision analysis, performs natural language processing, and uses generative AI models; a personalization engine that analyzes user profiles in real-time, dynamically adjusts advertisement elements, implements multi-armed bandit algorithms, and optimizes content delivery; enhanced machine learning capabilities for routing and optimization; predictive analytics using neural networks; real-time personalization features; a campaign database, the campaign database comprising ad campaign data and test plan data, wherein the test plan data comprises a test plan goal and an element variant list; a multi-platform adaptive ad campaign manager comprising a first plurality of programming instructions stored in a memory of, and operable on a processor of, a computing device, wherein the first plurality of programming instructions, when operating on the processor of the computing device, cause the computing device to: initialize an advertisement variant test, the advertisement variant test comprising a baseline advertisement and a variant advertisements; receive a customer interaction with a test advertisement from a first user device; generate a call-to-action text-based message to be displayed on the first user device; and receive a new advertisement variant from a dynamic advertisement engine; and an omnichannel text-based communicator comprising a second plurality of programming instructions stored in a memory of, and operable on a processor of, a computing device, wherein the second plurality of programming instructions, when operating on the processor of the computing device, cause the computing device to: receive an electronic request from the first user device to establish a text-based connection from the first user device to a second user device, the second user device being any mobile device belonging to a group of user devices within an enterprise; create an interaction instance to fulfill the electronic request from the first user device; store the interaction instance in an interaction database; select the second user device from the group of user devices within an enterprise to route the interaction, the selection based off a predetermined priority set by the enterprise; set up interaction control legs between the first user device and the second user device; establish at least one real-time media stream between the first user device and the second user device; and monitor the real-time media stream to collect media stream data and interaction data; and a dynamic advertisement engine comprising a third plurality of programming instructions stored in a memory of, and operable on a processor of, a computing device, wherein the third plurality of programming instructions, when operating on the processor of the computing device, cause the computing device to: receive the test plan data from the campaign database; analyze the media stream data, the test plan data, and the interaction data to statistically determine which of the baseline advertisement or the variant advertisement satisfied the test plan goals; and suggest an advertisement element variant from the element variant list to apply to a new advertisement variant and send the new advertisement variant to the multi-platform adaptive ad campaign manager.

According to a second preferred embodiment, a method for AI-powered dynamic advertisement testing and generation, comprising the steps of: analyzing historical performance data using deep learning models; implementing computer vision and natural language processing analysis; using generative AI models for content creation; applying reinforcement learning for cross-channel optimization; real-time personalization and dynamic content adjustment; initializing an advertisement variant test, the advertisement variant test comprising a baseline advertisement and a variant advertisements; receiving a customer interaction with a test advertisement from a first user device; generating a call-to-action text-based message to be displayed on the first user device; receiving a new advertisement variant from a dynamic advertisement engine; receiving an electronic request from the first user device to establish a text-based connection from the first user device to a second user device, the second user device being any mobile device belonging to a group of user devices within an enterprise; creating an interaction instance to fulfill the electronic request from the first user device; storing the interaction instance in an interaction database; selecting the second user device from the group of user devices within an enterprise to route the interaction, the selection based off a predetermined priority set by the enterprise; setting up interaction control legs between the first user device and the second user device; establishing at least one real-time media stream between the first user device and the second user device; monitoring the real-time media stream to collect media stream data and interaction data; receiving the test plan data from the campaign database; analyzing the media stream data, the test plan data, and the interaction data to statistically determine which of the baseline advertisement or the variant advertisement satisfied the test plan goals; and suggesting an advertisement element variant from the element variant list to apply to a new advertisement variant and send the new advertisement variant to the multi-platform adaptive ad campaign manager.

According to various aspects of the embodiment, wherein the computer vision analysis comprises convolutional neural networks for layout analysis, color scheme evaluation, and object detection; wherein the natural language processing comprises transformer models for sentiment analysis and content optimization; wherein the multi-armed bandit optimization implements Thompson Sampling for variant selection; wherein the reinforcement learning implementation maintains state representations and optimizes long-term performance; wherein the real-time personalization features analyze behavior patterns and dynamically assemble content; wherein the media stream of the first user device is converted to a suitable format to be received by the second user device; and the media stream of the second user device is converted to a suitable format to be received by the first user device; wherein the predetermined priority comprises priority ordered routing, circular ordered, percentage-based algorithms, and a timeout feature that re-routes the interaction if the interaction is not answered within allotted time; wherein the predetermined priority leverages artificial intelligence comprising machine learning and deep learning techniques based on prior customer interaction data, customer relationship management data, sales and marketing data, and enterprise operation data; wherein the predetermined priority comprises queues of one or more enterprise mobile devices and a timeout feature that re-routes the one real-time media stream to any mobile device belonging to the group of user devices within an enterprise or a call center if the interaction if it is not handled within a given time limit; wherein the first user device makes use of a mobile application to initiate electronic communication with the second user device by clicking or tapping on a picture or graphic; wherein the interaction in its entirety, between the first user mobile device and the second user mobile device, from initiation to termination is stored in a database and made available for analysis by artificial intelligence processing.

### BRIEF DESCRIPTION OF THE DRAWING FIGURES

The accompanying drawings illustrate several aspects and, together with the description, serve to explain the principles of the disclosed embodiments. It will be appreciated by one skilled in the art that the particular arrangements illustrated in the drawings are merely exemplary, and are not to be considered as limiting of the scope of the claims herein in any way.

FIG. 1A is a system diagram of an omni-channel text-based communicator platform with TCPA compliant mobile device.

FIG. 1B is a method diagram of an omni-channel text-based communicator platform with TCPA compliant mobile device.

FIG. 1C is a system diagram of an advertisement campaign tracking and management system using an adaptive ad campaign manager.

FIG. 2 is a system diagram of a standard TV ad campaign system managed regionally without using an adaptive ad campaign manager.

FIG. 3 is a system diagram of an email ad campaign system without using an adaptive ad campaign manager.

FIG. 4 is a system diagram of a social media ad campaign system without using an adaptive ad campaign manager.

FIG. 5 is a method diagram illustrating steps for defining, altering, and executing ad campaigns on multiple platforms and mediums using an adaptive ad campaign manager.

FIG. 6 is a method diagram illustrating steps for specifying a TV ad campaign using an adaptive ad campaign manager, according to a preferred aspect.

FIG. 7 is a method diagram illustrating steps for specifying an email ad campaign using an adaptive ad campaign manager, according to a preferred aspect.

FIG. 8 is a method diagram illustrating steps for specifying a social media ad campaign using an adaptive ad campaign manager, according to a preferred aspect.

FIG. 9 is a method diagram illustrating users interacting with TV ads using an adaptive ad campaign manager, according to a preferred aspect.

FIG. 10 is a method diagram illustrating users interacting with email ads using an adaptive ad campaign manager, according to a preferred aspect.

FIG. 11 is a method diagram illustrating users interacting with social media ads using an adaptive ad campaign manager, according to a preferred aspect.

FIG. 12 is a system diagram illustrating a Near-Field Communications (“NFC”) device broadcasting a referral link programmed into it, according to an aspect.

FIG. 13 is a method diagram illustrating methods for a NFC device to broadcast a referral link programmed into it and a mobile device act on the received link, according to an aspect

FIG. 14 is a system diagram illustrating a computer device such as a laptop, desktop, or mobile phone, utilizing a referral link, for the purposes of a mobile device detection system to differentiate between mobile phones and non-mobile devices, such as personal computers, according to a preferred aspect.

FIG. 15 is a flowchart illustrating steps for a computer device such as a laptop, desktop, or mobile phone, utilizing a referral link, being categorized so that an appropriate referral link is sent to the requesting device, according to a preferred aspect.

FIG. 16 is a block diagram illustrating an exemplary hardware architecture of a computing device.

FIG. 17 is a block diagram illustrating an exemplary logical architecture for a client device.

FIG. 18 is a block diagram showing an exemplary architectural arrangement of clients, servers, and external services.

FIG. 19 is another block diagram illustrating an exemplary hardware architecture of a computing device.

FIG. 20 is a message flow diagram illustrating the flow of messages and operations from a campaign manager specifying and serving a television advertisement, to a user completing all interactions with that advertisement and all intermediate steps, according to an embodiment of the invention.

FIG. 21 is a message flow diagram illustrating the flow of messages and operations from a campaign manager specifying and serving an email-based advertisement, to a user completing all interactions with that advertisement and all intermediate steps, according to an embodiment of the invention.

FIG. 22 is a message flow diagram illustrating the flow of messages and operations from a campaign manager specifying and serving a social media advertisement, to a user completing all interactions with that advertisement and all intermediate steps, according to an embodiment of the invention.

FIG. 23 is a message flow diagram illustrating the flow of messages and operations from a campaign manager specifying and embedding a referral link in an NFC beacon, to a user completing all interactions with that link and all intermediate steps, according to an embodiment of the invention.

FIG. 24 is a method diagram illustrating the function of an application capable of providing enhanced identity verification, according to an embodiment.

FIG. 25 is a diagram illustrating the function of an NFC beacon smart order link, according to an embodiment.

FIG. 26 is a block diagram representation of an example of an environment for use with an embodiment of an adaptive ad campaign management system.

FIG. 27 is a flow chart representation of a method of using an embodiment of an adaptive ad campaign management system to create an ad campaign.

FIG. 28 is an illustration of an example of a Vehicle Details Page (“VDP”) generated by an embodiment of an adaptive ad campaign management system for display on a customer computing device including an embodiment of a tap button indicator.

FIG. 29 is an illustration of an example of a VDP generated by an embodiment of an adaptive ad campaign management system for display on a customer computing device including an embodiment of a call initiator.

FIG. 30 is an illustration of an example of a VDP generated by an embodiment of an adaptive ad campaign management system for display on a customer computing device including an embodiment of a text message initiator.

FIG. 31 is a flow chart representation of an example of a method of responding to an activation of a call initiator on a product description page displayed on a customer computing device using an embodiment of an adaptive ad campaign management system.

FIG. 32 is a flow chart representation of an example of a method of responding to an activation of a call initiator on product description page displayed on a customer computing device using an embodiment of an adaptive ad campaign management system.

FIG. 33 is a flow chart representation of an example of a method of responding to an activation of a text message initiator on a product description page displayed on a customer computing device using an embodiment of an adaptive ad campaign management system.

FIG. 34 is a flow chart illustrating the use of an automotive ad campaign being utilized for both generic and highly tailored, user-specific interactions, while generating deep analytics of ad interactivity, according to an embodiment.

FIG. 35 is a diagram of a system for adaptive advertisement within a mobile application, according to an embodiment.

FIG. 36 is a method diagram for a system of adaptive advertisement within a mobile application, according to an embodiment.

FIG. 37 is a message flow diagram for a system of adaptive advertisement within a mobile application, according to an embodiment.

FIG. 38 is a flowchart showing an exemplary conversion of SMS, voice, and email data, for an exemplary automotive dealer interaction.

FIG. 39 is a diagram of a system for adaptive advertisement within a mobile application using speech recognition, according to an embodiment.

FIG. 40 is a method diagram for a system of adaptive advertisement within a mobile application using speech recognition, according to an embodiment.

FIG. 41 is a message flow diagram for a system of adaptive advertisement within a mobile application using speech recognition, according to an embodiment.

FIG. 42 is a system diagram of an interaction control system.

FIG. 43 is a system diagram of a routing system.

FIG. 44 is a system diagram of a media translation system.

FIG. 45 is a method diagram illustrating interaction control between two user devices, according to an embodiment.

FIG. 46 is a method diagram illustrating interaction routing between two user devices, according to an embodiment.

FIG. 47 is a method diagram illustrating media translation and communication between two user devices, according to an embodiment.

FIG. 48 is a method diagram illustrating transfer of communication from one user device to another user device, according to an embodiment.

FIG. 49 is a method diagram illustrating voice communication from one user device to a voicemail system with a subsequent text-based communication from another user device, according to an embodiment.

FIG. 50 is a method diagram illustrating authentication of TCPA compliant mobile device with an interaction control system, according to an embodiment.

FIG. 51 is a method diagram illustrating routing of communications between a customer and one or more agents, according to an embodiment.

FIG. 52 is a method diagram illustrating omnichannel conversion to SMS between a customer and one or more agents, according to an embodiment.

FIG. 53 is a system diagram of an omni-channel text-based communicator platform comprising an API and URL/UI generator.

FIG. 54 is a method diagram illustrating omni-channel text-based communicator platform integration with third-party ad campaigns.

FIG. 55 is a diagram of a customer's mobile device showing an advertisement with a call-to-action communication initiator.

FIG. 56 (PRIOR ART) is a flow diagram of current methods used to receive a digital coupon from a business using a website.

FIG. 57 is a flow diagram of an exemplary method used to receive a digital coupon from a business using a tap-to-text button on a website.

FIG. 58 is a block diagram of an exemplary system architecture for a multi-channel dynamic advertisement system, according to an embodiment.

FIG. 59 is a block diagram illustrating an exemplary aspect of the multi-channel dynamic advertisement system, the dynamic advertisement engine.

FIG. 60 is a diagram illustrating an exemplary process for conducting an advertisement variant test, according to some embodiments.

FIG. 61 is a method flow diagram of an exemplary process for performing advertisement variant testing, according to some embodiments.

FIG. 62 illustrates a system diagram depicting an exemplary architecture of an AI-powered advertisement variant generation and optimization system.

FIG. 63 presents a comprehensive architecture diagram of the deep learning subsystem, which forms the core intelligence of the advertisement variant generation system.

FIG. 64 illustrates a detailed system diagram of the Multi-Armed Bandit (MAB) implementation for dynamic advertisement variant optimization.

FIG. 65 illustrates a detailed system diagram of the Computer Vision Analysis Pipeline for analyzing visual elements in advertisements.

FIG. 66 presents a sophisticated Natural Language Processing Flow system that functions as an intelligent copywriting and optimization engine.

FIG. 67 presents a sophisticated Reinforcement Learning System continuously learning and adapting every campaign decision.

FIG. 68 showcases the Real-Time Personalization Engine's sophisticated architecture, designed to deliver highly customized advertising experiences.

FIG. 69 presents the sophisticated architecture of the Generative AI Creative System, which functions as an AI-powered creative agency.

FIG. 70 is the sophisticated Cross-Channel Optimization System coordinating multiple advertising platforms.

FIG. 71 is the sophisticated Data Flow Architecture a sophisticated system of the entire advertising intelligence platform.

FIG. 72 is a block diagram illustrating an exemplary architecture for the AI-powered advertisement generation and optimization system's Machine Learning Engine.

### DETAILED DESCRIPTION OF THE INVENTION

The inventor has conceived and reduced to practiced, a system and method for AI-powered dynamic advertisement generation, testing, and optimization. The system comprises a multi-platform adaptive ad campaign manager, an AI-powered advertisement generator, a personalization engine, a dynamic advertisement engine, a campaign database, and an omnichannel text-based communicator. The system leverages advanced artificial intelligence techniques, including deep learning, computer vision, natural language processing, and reinforcement learning, to automatically generate and optimize advertisement variants. The system receives customer interactions with advertisement variants, establishes a real-time media stream between a customer device and a second user device, and monitors the media stream to collect data related to effectiveness of the advertisement variants. The system analyzes media stream data together with a plurality of other data types using machine learning models to statistically determine variant performance and predict future outcomes. The system uses generative AI models to create new advertisement variants and implements real-time personalization for content delivery across multiple channels.

According to one embodiment, a system for allowing seamless integration of an omni-channel communication platform into third-party ad campaigns is disclosed. An omni-channel communication platform comprises an interaction control system, an interaction routing system, and a media translation system. Users perform function calls via an application programming interface (API) to a URL generator in order to receive a custom redirect URL that may be hosted on a user's advertisement. The redirect URL intercepts customer interactions with that advertisement and allows the customer and user to communication over the customer's and user's preferred method, converting the user's communication technology to the customer's communication technology and vice-versa. Furthermore, the user may request a generated user-interface graphic that is associated with the redirect URL via the same or a different function call.

According to one embodiment, the embodiment allowing seamless communication between customers using a web chat integrated into a webpage and business representatives receiving and replying to the customer's web chat messages via text messaging over a mobile device. The system and method used an omnichannel text-based communicator that integrates omnichannel communications and converts the communications into other formats of electronic messages. According to various embodiments, a consumer views one or more forms of advertisement, e.g., webpage banner, Internet browser popup, billboard, poster, business card with QR code, etc., and initiates interest in the product of service the advertisement is promoting. The advertisement may be static or dynamic depending on the medium used. Dynamic (electronic-based) advertisements may change in real-time based on a variety of factors not limited to, audience, time, location, device, facial recognition, etc. Initiation of interest by the customer (i.e., sales lead) may also take many forms. Non-interactive mediums such as posters, billboards, and flyers may have a specific phone number to call or QR code which auto populates a phone number or text on the users mobile device and upon the user activating, the system will autogenerate a text-based communication to be sent to the caller in response. Electronic advertisements may have a button, hyperlink, or swipe function to auto generate a communication with the system. Some advertisements may be limited to one or more communication methods, other advertisements may allow for all forms of communication. Communication methods used may be SMS, social media messaging, webchat (chatting over Internet communication protocols such as HTTP), phone call, etc. Some embodiments make use of a chatbot, utilizing Artificial Intelligence (AI), or natural language processing, or third-party services that initiates a conversation with the user after the user has interacted with the advertisement or initiated contact. The chatbot may ask a series of questions related to the product or service in question. These questions may be stored in a database, predetermined, however, other embodiments anticipate natural language processing to respond in-kind to the user's questions. The chatbot may recognize when a customer does not want to answer the questions posed and initiate a transfer to a sales agent for the desired product or service. However, in any situation, any and all pertinent information collected by the chatbot is forwarded to the sales agent thus increasing the sales agent's awareness and saving time for the customer.

As one example, the omnichannel text-based communicator receives one or more of the various forms of communication (e.g., text, call, webchat, etc.) from a customer via the customer's mobile device about some product or service. This communication triggers a message, typically a SMS message but may comprise other forms of messaging, to be sent to the customer's device with further information about the product and service as well as a follow up questions from an automated chatbot. This chatbot uses AI to communicate with the customer and request information from the customer such as desired product features, price range, location, or other metrics relating to the customer and the product or service. After this automated chatbot experience, the customer is presented with one or more communication options to continue the conversation with a real person, i.e., an agent or sales staff. The system finds an available agent via one or more methods such as a round-robin style search function. Once an agent has accepted, the conversation communication will be transferred and any pertinent information collected from the chatbot experience (may be metadata, customer profile information, desired product features, etc.) will be forwarded to the sales agent via the agent's or business preferred communication method. This enhances sales lead acquisition, retention, and closes.

According to one embodiment, an advertisement (e.g., webpage) for a vehicle is seen by a potential customer. A tap text link—a URL that requests the customer's phone number—is present on the advertisement. The potential customer clicks on the tap text link and enters their phone number. The phone number and vehicle information are received by the system which then triggers the chatbot to respond to the potential customer. The chatbot follows up with questions regarding credit history, location, trade-ins, down payments, and/or anything that may be desired information by a vehicle dealership. Additionally, all follow up questions are related to the specific vehicle due to the transmission of one or more unique identification numbers associated with the advertisement the customer clicked the tap text link from. Once the series of questions are complete, or upon request from the customer, the system forwards the potential customer to a sales agent along with any and all pertinent information collected. A series of methods are described herein allowing various methods to choose which sales agent receives which call and in what priority. The chatbot may generate a message to the customer with a link or button allowing the customer to auto-populate their communication device with the sales agent's contact information. The contact information may or may not be the actual information of the sales agent as the system may mask all customer and sales agent uniquely identifying information for compliance with standards. All interactions and information collected may be stored in an analytics database for further use.

According to one embodiment, when a customer is using an electronic device such as a laptop, desktop, cellular smartphone, and other like devices, the customer may be presented with a button or hyperlink to text, message, or webchat with a live representative. According to this embodiment, the omnichannel text-based communicator receives the choice of communication method (text, message, email, or webchat) from the customer and facilitates an immediate real-time conversion from the customer's preferred method of communication to SMS (or other mobile device messaging service e.g., MMS, iMessage, RCS). For example, if the customer desired to use an Internet browser chat window, message input there from the customer will be converted to the messaging service of the live agent without the need for the agent to be on the same Internet browser chat service. Another example is if a customer desired to converse over emails, the email content will be converted to the agent's preferred message service format and replies from the agent to the customer will be converted into emails. Phone numbers and other identifying information is masked by the omnichannel text-based communicator.

The conversion of web chat—which is sometimes referred to as live support software, is a chat software integrated into a website to allow customers to chat with the business representative or the website owner. Live support on a web chat channel can be provided by both human agents as well as virtual agents and chatbots. In many cases, both humans and live chat tools work in tandem to improve the digital customer experience. Furthermore, web chat is a type of Internet online chat distinguished by its simplicity and accessibility to users who do not wish to take the time to install and learn to use specialized chat software. Considering the ease of use and popularity of web chat, various embodiments described herein directly convert web chat entries from a customer to SMS messages (or any other type of messaging protocol) sent to a mobile device, typically used by a business agent. Messages sent from the mobile device are converted into web chat entries for the customer to view in the web chat screen.

According to another embodiment, the system implements sophisticated AI capabilities for advertisement generation and optimization. The system utilizes computer vision analysis with convolutional neural networks to evaluate visual elements, including layout patterns, color schemes, and object detection. Natural language processing with transformer models analyzes and optimizes advertisement copy, evaluating sentiment, tone, and brand voice consistency. A multi-armed bandit system with Thompson sampling optimizes variant selection across channels, while reinforcement learning maintains state representations of the advertising environment to optimize long-term performance.

The system includes a real-time personalization engine that analyzes user profiles and behavioral data to dynamically adjust advertisement elements. This engine implements advanced machine learning models to process user interactions, customize content delivery, and optimize advertisement timing and placement. The system maintains user vectors and content vectors for precise matching of content to user preferences, while continuously updating its understanding through a sophisticated feedback loop.

The system's generative AI capabilities enable automated creation of new advertisement variants based on learned patterns and performance data. Using a combination of StyleGAN architectures for visual content and GPT-based models for text generation, the system can create numerous variations while maintaining brand consistency and quality standards. A comprehensive quality control system employing deep neural networks ensures all generated content meets brand guidelines and performance standards.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in said arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

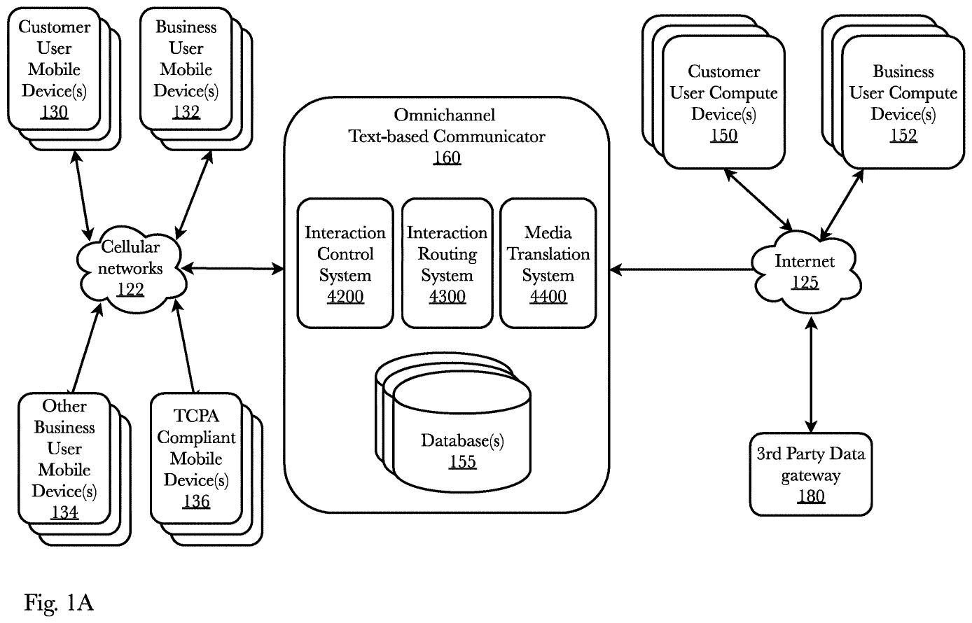

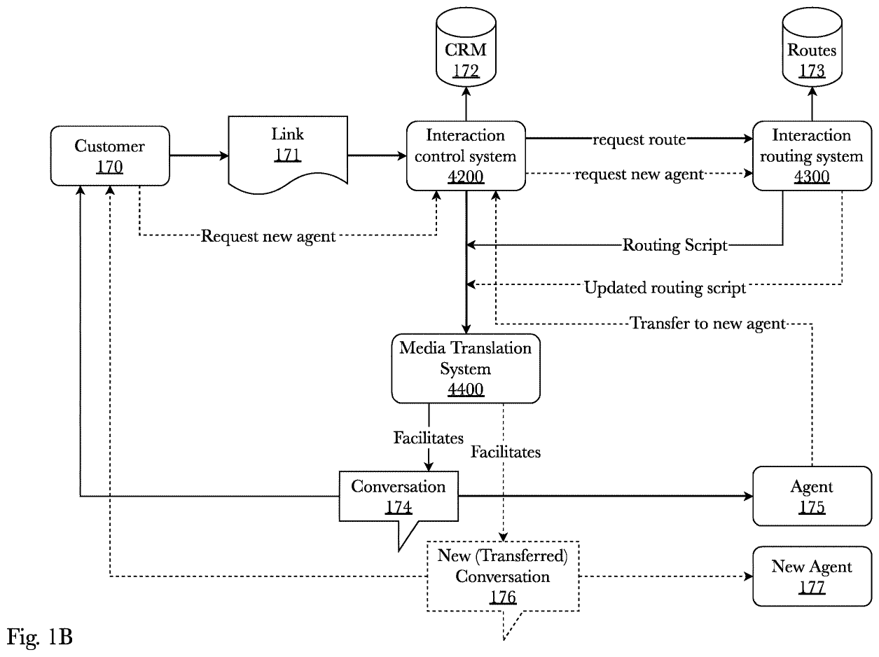

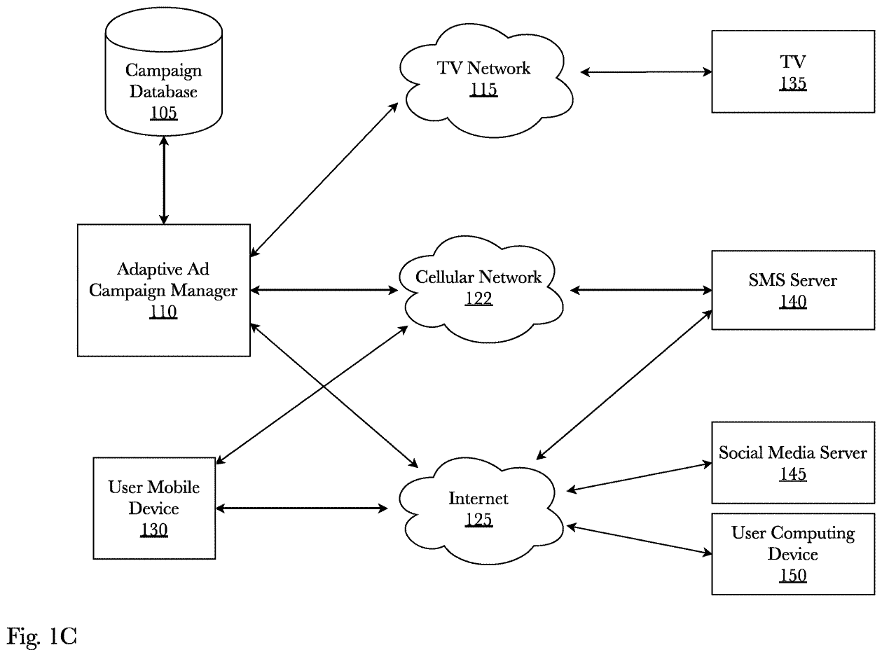

FIG. 1A is a block diagram illustrating an exemplary system architecture 160 for an omnichannel text-based communicator system and FIG. 1B is an exemplary method diagram thereof. According to a preferred aspect, system 160 comprises an interaction control system 4200, a routing system 4300, a media translation system 4400, and databases 155. Customers 170 and their user mobile device(s) 130, agents 175, 177 and their business user mobile device(s) 132, other business user device(s) 134, and TCPA compliant mobile device(s) 136 used by agents 175, 177, may connect to omnichannel text-based communicator system 160, typically via a cellular phone network 122, although connections may be made through other means, as well, such as through the Internet 125 via a Wi-Fi router for example. Similarly, customer user compute devices 150 may connect to omnichannel text-based communicator system 160 over a Local Area Network (“LAN”) or Wide Area Network (“WAN”), the Internet 125, a direct physical connection to another device, or some other network connection. System 160 may connect to third-party or external systems or components, such as Customer Relationship Management (“CRM”) systems, Private Branch Exchange (“PBX”), traditional telephony call center agents, voicemail systems, and so forth, through third-party data gateway 180.

According to an aspect, a business may access a business user mobile device 132, business TCPA compliant mobile device 136, or business user compute device 152 to enter or update a variety of business information or business operational data that may be stored in a database 155, 172, 173. Examples of the types of information or operational data that a business may enter include, but are not limited to: business name, branch name, location, types of product or server provided (e.g. vehicle make/model/year, maintenance/repair/cleaning), item pricing, credit terms, special pricing promotions, business hours of operation, inventory information, promotional information, staff and employee training and skill information, and other business operational data.

According to another aspect, TCPA compliant mobile device 136, which is a device that is in compliance with the Telephone Consumer Protection Act (TCPA) of 1991, after an initial device power on sequence, must connect with interaction control system 4200 and request business user (agent 175) authentication, business user authentication may involve user data input, user data input may include what the user knowns (e.g. user name, user password, personal identification number, etc.), what the user has (e.g. mobile push authenticator, multi-factor authentication code generated from third-party device such as GEMALTO™, GOOGLE AUTHENTICATOR™, or other device), something the user is (e.g. biometric data from retinal scan, fingerprint, DNA sample and the like), or some other verification technique available to those skilled in the art. Once interaction control system 4200 has enabled communication of business user mobile device 136, business user mobile device may select customer mobile device 130 from an interaction database 155, enterprise CRM system 172 or other data repository, through third-party data gateway 180 and request to initiate an interaction through interaction control system 4200. An interaction control system 4200 will initiate communication through media translation system 4400 which in turn will mask (“ghost”) business user mobile device 136 from customer use mobile device 130, and mask customer user mobile device 130 from business user mobile device 136, setup an interaction between customer user mobile device 130 and business user mobile device 136, interaction details may be logged in database 155.

Similarly, a customer may access customer user compute mobile device 130 or customer compute device 150 to create and update user profile information that may be stored in database 155, 172. Examples of the type of information a customer may enter include but are not limited to: name, address, contact information, preferred method of contact (e.g. mobile phone, email), payment (WELLSFARGO™, VENMO™, PAYPAL™) or credit card information (e.g. VISA™, MASTERCARD™, DISCOVER™) other personal information such as interests or hobbies (e.g. playing board games including but not limited to Backgammon or Go, creative writing, sports cars, growing microgreens, brewing craft beer, camping, hiking and the like).

Data stored in database 155 may be used by an interaction control system 4200, routing system 4300, media translation system 4400, or third-party CRM system 172 to optimize business communications between customers and a business entity. Database 155 may take the form of a managed or unmanaged database, document-oriented database system, or a Structured Query Language (“SQL”) database. Examples of types of database software that may operate include MYSQL™, ORACLE DATABASE™, MONGODB™, and others. It may exist as a distinct physical device or be operating on another computing device that may perform other functions aside from operating, hosting and serving the database 155. If it is a distinct physical device, the database may be connected over a LAN or WAN, the Internet, a direct physical connection to another device, or some other network connection.

In an aspect, system 160 may be able to determine certain information by accessing third-party data gateway 180 such as a CRM system or CRM database 172, mapping websites and applications. For example, system 160 may access an existing CRM system which the business maintains and contains, for example, customer purchase history, customer preferred contact method (e.g. mobile phone, e-mail), customer preferred contact times, customer previous interaction history and so forth. Further, system 160 may access a publicly available mapping website such as GOOGLE™, which may contain information about the business location, product availability, hours of operation, phone number, etc. Thus, in some aspects, it is not necessary for the business to enter certain information through portal, as the information may be automatically obtained from third-party data gateway 180.

In another aspect, when a customer user mobile device 130 when prompted by a link (tap text link) or call to action 171 connects to interaction control system 4200 and requests to communicate with a business representative 175 (e.g. salesperson, support specialist, agent etc.), interaction control system 4200 queries database 155, 172 for customer profile data, interaction control system requests target routing information from routing system 4300. Routing system will execute routing script that may query database 155, 173 to access and send target routing information to interaction control system 4200. An interaction control system 4200 will send a request to a media translation system 4400 to set up an interaction (i.e., conversations 174) between customer user mobile device 130 and business user mobile device 132. Upon termination of interaction, which may be initiated by customer user mobile device 130, or business user mobile device 132, and acted upon by interaction control system 4200 in concert with media translation system 4400, interaction details may be logged in database 155.

In an aspect, when a customer user mobile device 130 connects to interaction control system 4200 and requests to communicate with a business representative (e.g. salesperson, support specialist, etc.), interaction control system 4200 queries database 155 for customer profile data, interaction control system requests target routing information from routing system 4300. Routing system will execute routing script that may query database 155 to access and send target routing information to interaction control system 4200. An interaction control system 4200 will send a request to a media translation system 4400 to set up an interaction between customer user mobile device 130 and business user mobile device 132. Once communication is established, a different business user 134 may necessitate a transfer of the interaction from business user 132 to business user 134 and a subsequent termination between the customer user mobile device 130 and business user mobile device 132. An interaction transfer 176 may be initiated by customer user mobile device 130, or business user mobile device 132, and acted upon by interaction control system 4200 in concert with media translation system 4400, interaction details may be logged in database 155. Routing system will execute routing script that may query database 155 to access and send target routing information to interaction control system 4200. An interaction control system 4200 will send a request to a media translation system 4400 to set up an interaction between customer user mobile device 130 and business user mobile device 134 132.

In another aspect, an interaction transfer may be initiated without the explicit use of routing system 4300. In this example, business user mobile device 132 may select business mobile device 134 destination address from an interaction database 155, enterprise CRM system or other data repository, through third-party data gateway 180 and request a transfer through interaction control system 4200. An interaction control system 4200 will initiate transfer through media translation system 4400 which in turn will mask (“ghost”) business user mobile device 134 from customer use mobile device 130, and mask customer user mobile device 130 from business user mobile device 134, setup an interaction between customer user mobile device 130 and business user mobile device 134 and terminate interaction with business user mobile device 132, interaction details may be logged in database 155.

In an aspect, when a customer user mobile device 130 connects to interaction control system 4200 and requests to communicate via voice with a business representative (e.g. salesperson, support specialist, etc.); interaction control system 4200 queries database 155 for customer profile data, interaction control system requests target routing information from routing system 4300. Routing system will execute routing script that may query database 155 to determine target resource; and send target routing information to interaction control system 4200. An interaction control system 4200 will send a request to a media translation system 4400 to set up an interaction between customer user mobile device 130 and business user mobile device 132. Media translation system may mask information and data so that customer user device 130 cannot be identified by business user device 132, and business user device 132 cannot be identified by customer user device 130. Should business user mobile device 132 not accept the request to connect, interaction control system 4200 may request another enterprise resource via the routing system 4300 which in turn will execute routing script that may query database 155 to determine next target resource which will repeat until all enterprise resources are exhausted (i.e. no enterprise resource is available to accept the call) or call has been accepted by the business user mobile device 132. Should all enterprise resources be exhausted, the voice call may be routed to a voicemail system corresponding to one of the enterprise resources or a general voicemail box. When customer user device 130 connects with voicemail box via third-party data gateway 180 and leaves a voicemail, or not, an electronic notification (e.g. text message) is sent via interaction control system 4200 to business user 132 of customer user device 130 failed attempt to connect with a live enterprise resource. Business user mobile device 132 may send an electronic message (e.g. text) to customer user device 130 who may accept request or not. If accepted an interaction (e.g. voice, text or other) may be set up between customer user device 130 and business user device 132 via interaction control system 4200 in concert with media translation system 4400 such that media translation system 4400 may mask information and data so that customer user device 130 cannot be identified by business user device 132, and business user device 132 cannot be identified by customer user device 130; interaction details may be logged in database 155 or CRM system via third-party data gateway 180 which may be made available for future reporting and analytics.

In some other aspect, routing system 4300, through business user mobile device 132, may provide information to the business user of upcoming staffing needs which the business user may accept or decline. If the business has entered information such as incentive pay, routing system 4300 may use that information to offer the business staff additional monetary or other incentives (e.g. future vacation day with pay) to accept a shift schedule. Such incentives may be adjusted for busy periods at the business, either automatically based on the business's history as stored in a database 155, or by retrieving information stored in a database 155 that has been manually entered by the business through business compute device 152 or business mobile device 132.

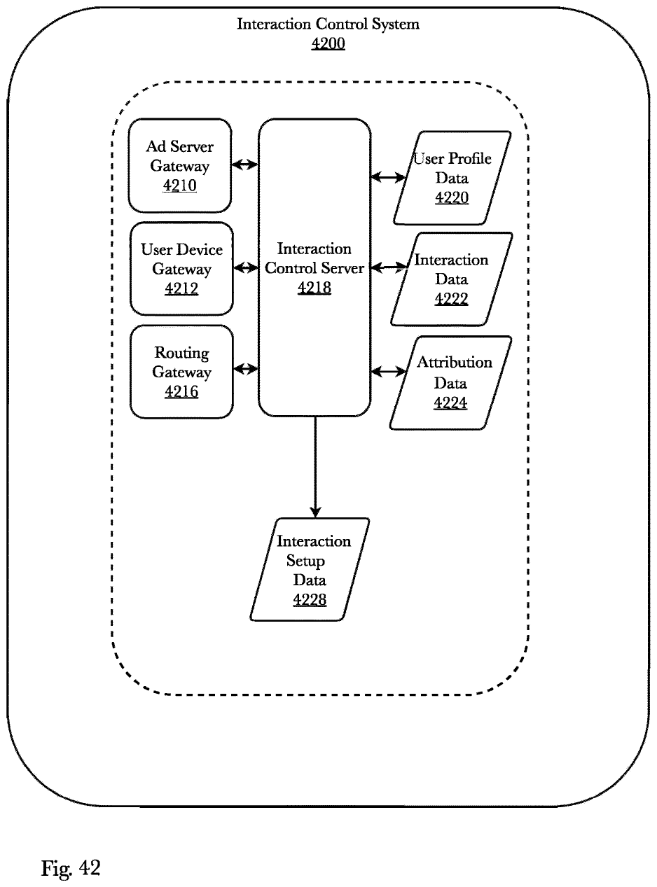

Now turning our attention to FIG. 42 illustrating an exemplary block diagram architecture for an interaction control system 4200. According to an aspect, an interaction control system 4200 comprises interaction control server 4218, ad server gateway 4210, user device gateway 4212, routing gateway 4216, user profile data 4220, interaction data 4222, attribution data 4224, and interaction setup data 4228. In operation, interaction control server 4218 may connect, for a bi-lateral data exchange, between ad server gateway 4210, user device gateway 4212, routing gateway 4216; may receive user profile 4220, interaction data 4221, attribution data 4222; may provide as output call interaction data 4228.

In an aspect, customer mobile user device 130 that may include a smart phone, or table device, or similar user device capable of sending and receiving electronic messages, may receive a CTA electronic message (e.g. text, chat, email or other electronic message format) from interaction control server 4218 via user device gateway 4212 which abstracts away any potential communication protocol (e.g. HTTP, RTP, SMS, SIMPLE, TCP, UDP or other protocols that may be in use) that may exist between interaction control server 4218 and customer user mobile device 130 or customer user compute device 150. A CTA may include a link to an online retail portal, a referral to a product or service website, directions to a store, discount coupon code, or some other information or content that may cause the customer to act in some way, for example tapping on an electronic picture, clicking on a link or the like; and may be a result of an advertisement campaign or some other indication that a customer may be interested in further engagement with business entity. Upon receiving CTA, a customer through user mobile device 130 may indicate desire to further engage with business by interacting with CTA which may include clicking or tapping on electronic message or some other means that will result in an electronic notification being received by interaction control server 4218. An interaction control server 4218 upon receiving notification from customer user mobile device 130, may access customer user profile data 4220, customer profile data may include name, address, phone number, email, preferred contact method, historical purchase information, customer tiering level (e.g. bronze, silver, gold), personal information (e.g. marital status, number of dependents, net worth, interests/hobbies) or other data that may have been directly provided by customer or obtained by other means including a business CRM system accessible via third-party data gateway 180, and may aid the business in optimally handling the customer request to engage with the business; may access interaction data 4222, interaction data may include but is not limited to interactions that customer has previously had with business, brand, product, or if available competitor business, brand or product, product or service purchased, amount of purchase, prior communications(e.g. text, chat, email, snail mail, voice call, call center interaction, in-person, telegram or other communication that may be in use) with business or business partner; may access attribution data 4224, attribution data may include advertising campaigns run including media channel (e.g. TV, social media, near-field communication, in-store offers, targeted email), dates and times of ad campaigns, aggerate sales data associated with each advertising campaign, customer-specific sales outcome and any other data related to media and marketing efforts and associated business sales outcomes. Once interaction control server 4218 has a complete data set of the business-customer relation, this is sent along with a route request via routing gateway 4216 to routing system 4300.

In another aspect, ad server gateway 4210 may provide referral information of a customer interested in receiving additional information (aka CTA) from said business to interaction control server 4218, referred information may include customer name, contact information, business name, product or service of interest any other data that may be of use to optimize communication and business outcomes between customer and business.

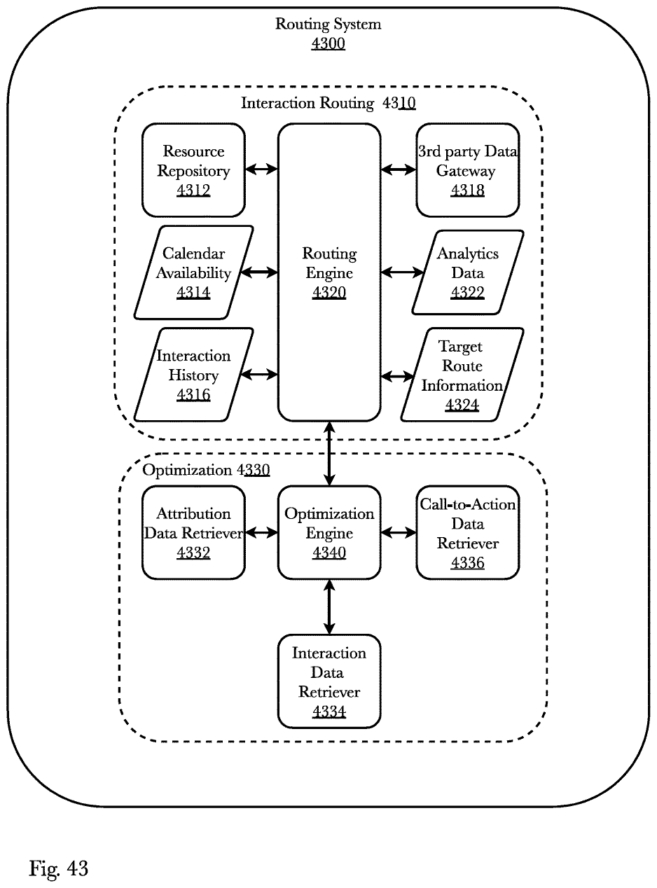

Referring now to FIG. 43 illustrating an exemplary block diagram architecture for a routing system 4300. According to an aspect, a routing system 4300 comprises interaction routing 4310 subsystem and optimization 4330 subsystem. An interaction routing 4310 subsystem further comprising a routing engine 4320, routing repository 4312, calendar availability 4314, routing scripts 4316, third-party data gateway 4318, analytics data 4322, target route information 4324. An optimization 4330 subsystem further comprising optimization engine 4340, attribution data retriever 4332, call-to-action data retriever 4336 and interaction data retriever 4334.

In operation, routing engine 4320 may connect, for a bi-lateral data exchange between optimization engine 4340; may receive routing repository 4312, calendar availability 4314, interaction history 4316, third-party data gateway 4318, analytics data 4318; and provide target route information 4324. An optimization engine 4340 may connect for bi-lateral data exchange with routing engine 4320, attribution data retriever 4332, interaction data retriever 4334, and call-to-action data retriever 4336.

In an aspect, routing engine 4320 receives a route request from interaction control server 4218, routing engine may execute routing logic that may be implemented within routing script 4316, routing logic may take into account sequential, ‘round robin’, or percent-based allocations to distribute to target or may utilize resource repository 4312, resource repository may include available routing resources including call center agents, traditional IVR, voice portals, AI-driven chatbots or voice portals, non-traditional agent sources including sales personnel, field sales, support specialist or other resources that may be able to interact with customer; may utilize calendar availability 4314, calendar availability may include available time from target routable resources (e.g. sales person, support specialist), calendar systems may in third-party systems such as MICROSOFT OUTLOOK™, GOOGLE CALENDAR™, LOTUS NOTES™ SALESFORCE™ CRM, SUGAR™ CRM; may utilize analytics data 4322, analytics data may include operational data, sales data, customer data or any other data that may assist with routing decisions; generate target route information 4324, target route information may include resources from business entity traditional call center including but not limited to: traditional phone-based agents, multi-media (including email, chat, text) agents, AI-based or traditional interactive voice response (“IVR”) systems, AI-driven chat bots or speech bots; non-traditional resources including but not limited to field sales and support or other resources that have access to user mobile devices 132 or business compute device 152 and may include resource name (e.g. Jim Johnson), title (e.g. car sales advocate), destination address (e.g. 360.867.5309), and any other information that may be useful in delivering interaction; and provide results to interaction control server 4218 to determine optimal target to deliver customer interaction.

In another aspect, routing logic may be implemented within routing script 4316 and use Artificial Intelligence (“AI”) techniques known to those skilled in the art including deep learning algorithms and incorporate data resources as listed in previous paragraph along with an array of other factors including but not limited to time-of-day, day-of-week, store hours, resource availability, service level requirements, previous customer interaction and transactions, customer tiering structure, data from third-party systems including but not limited to CRM systems, location-based services, weather-services and so forth.

Note that this example is simplified for clarity, and that routing system 4300 may employ a much broader set of factors and variables, as described elsewhere herein. The optimization engine 4340 may use any number of optimization algorithms, including machine learning algorithms or others known in the art, to find routing targets to optimize business outcomes based upon a large number of variables presented.

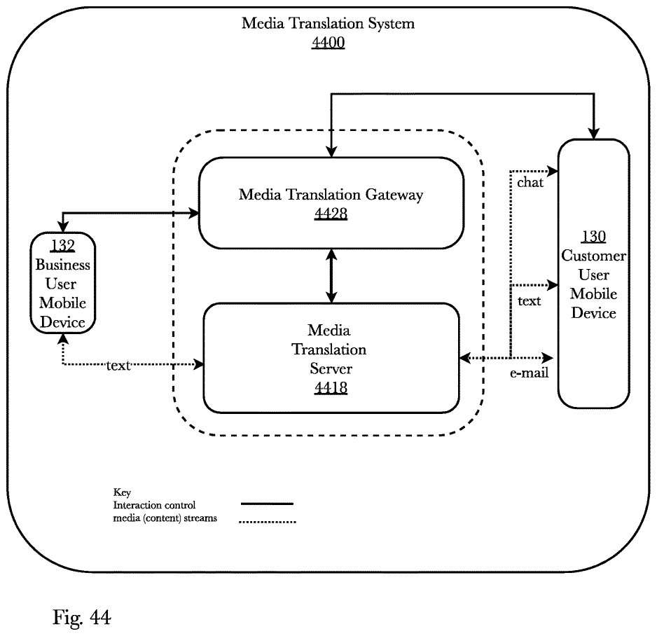

Referring now to FIG. 44 illustrating an exemplary block diagram architecture for a media translation system 4400. According to an aspect, a media translation system 4400 comprises media translation gateway 4418, media translation server 4428. A customer user mobile device 130, other customer compute device 150, or a business user mobile device 132 may connect via a cellular network 122 and establish a bi-lateral data exchange.

In operation, when the media translation gateway 4418 receives call interaction data 4228 from interaction control server 4218, it will establish interaction control legs between business user mobile device 132 and customer user mobile device 130 masking any identifying information of customer or customer user mobile device 130 and of business user mobile device 132 such that neither business user mobile device 132 nor customer user mobile device 130 will know the particular identity of the device. In some aspects, the customer user mobile 130 device or business user mobile device 132 may be allowed to know some information about the user endpoints which may be configurable by users of the system.

In some other aspects, business user mobile device 132 may without changing applications or devices use text messages (e.g. SMS or other protocols known to those skilled in the art) to interact with and respond to customer mobile device 130 or customer user compute device 150 through media translation server 4428 which enables media translation from one electronic form (e.g. SMS) of communications to other electronic forms(e.g. SMS, email, chat).

Now consider FIG. 1C illustrating a system diagram exemplifying an advertisement (“ad”) campaign tracking and management system. A campaign database 105 exists which may take the form of a managed or unmanaged database, document-oriented database system, or a SQL database. Examples of types of database software that may operate include MYSQL™, ORACLE DATABASE™, MONGODB™, and others. It may exist as a distinct physical device or be operating on another computing device that may perform other functions aside from operating, hosting and serving the campaign database 105. If it is a distinct physical device, the database may be connected over a LAN or WAN, the Internet, a direct physical connection to another device, or some other network connection. A campaign database 105 may operate on a compute device which also operates, or connected to a device which operates, an adaptive ad campaign manager 110, which is a specialized software operating on a compute device such as a personal computer or workstation computer, which may execute software, taking user inputs, and utilizing a network adapter. The operating system of such a computing device may be one of many options available to consumers and businesses. Networks that an adaptive ad campaign manager 110 may connect to may include at least one TV network 115 for the purpose of being able to serve televised advertisements to customer TV devices 135, a Cellular Network 122 for the purpose of receiving phone calls and sending and receiving SMS messages from a user mobile device 130 and from third-party SMS servers 140, and the Internet 125 so as to serve advertisements on social media platforms on a social media server 145 and serve advertisements via email, websites or individual web pages, or through applications, to customer user mobile device 130 and customer user computing devices 150. A user mobile device 130 may be a cellular phone or may be another type of mobile device, such as a tablet, a smartphone or non-smartphone cellular phone, a personal digital assistant, or even a personal computer 150 if the computer possesses a phone number and is capable of receiving phone calls, the user mobile device 130 and computer 150 may then be the same device instead of separate devices as shown. The manner of the advertisements and data sent from the adaptive ad campaign manager 110 to the networks may include audio data, visual data such as video or images, textual data, recipient data, regional specifications, and other common data for advertisements in applications, online, over TV, and over email. Advertisements may be sent to, and reached by, a mobile device 130 or other computing device 150 through the Internet via email, social networks, or internet browsing, or sent to a TV 135 by a TV network 115. The functionality of a TV 135 may be utilized by a mobile device 130 or other computing device 150, or both, and all functionalities—TV viewership, phone call placement, internet browsing, email viewing, and social network access—may be accomplished by a single device over the Internet, or with a combination of Internet, cellular network or Public Switched Telephone Network (“PSTN”).

In an aspect, an ad campaign manager 110 may also be part of a redirection server, or operate a redirection service while operating as a server for redirecting phone calls from users, capable of responding to phone calls from a specified phone number with a stored SMS response.

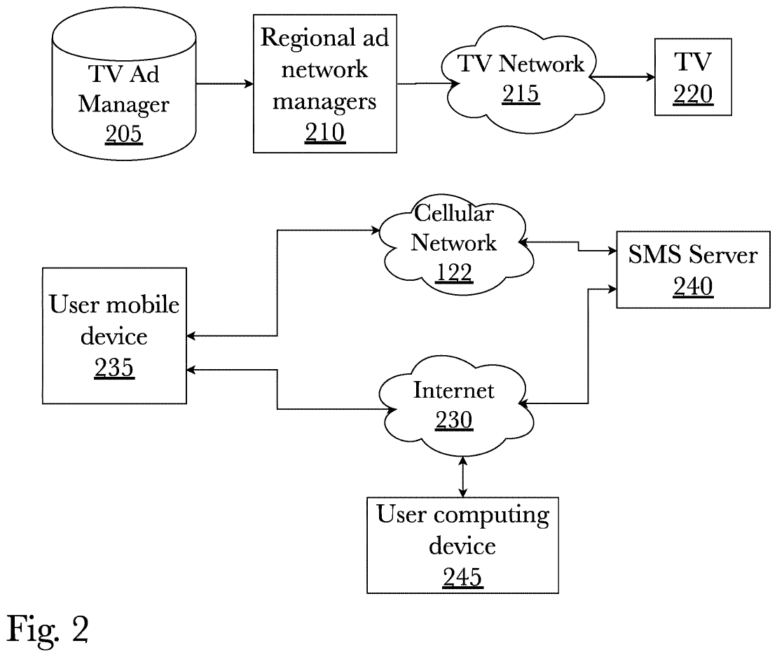

FIG. 2 is a system diagram of a standard TV ad campaign system managed regionally without using an adaptive ad campaign manager. A TV ad manager 205 may be a computing device with software for the creation and management of TV ads, or this may in some cases be done manually, as television ads have been created since long before the modern Internet or personal computing became widespread and therefore in some implementations this process may be done manually with rolls of film or other video data given to a TV network organization. However, in either case, the advertisement data or content may be sent to at least one regional ad network manager 210, for instance a slightly altered advertisement or version of an advertisement might be run in two different areas of the United States on national television, at which points the ads are run on the TV networks 215 and viewed on user TV's 220. The user may interact with this advertisement on a TV 220 by viewing it, and with their cellular phone 235 or even in some cases a land-line telephone place a phone call over a PSTN 225, or send a text message from a user mobile device 235 over a network such as the Internet 230 or the Cellular Network 122 to an SMS server 240 which handles the data in an SMS message to forward it to the appropriate recipient, in this case being a number seen on a TV advertisement. The recipient may be anything specified by the advertisement, such as a call center or phone line for a call-in TV show, or something else entirely, and moreover the advertisement on the TV 220 may have an email address or website address for a user to navigate to either with a user mobile device 235 or with a computing device 245, to complete a transaction, sign up for a service, partake in a poll, or something else as desired by the advertisement. When a plurality of regional advertisement network managers 210 receive advertisements, it is possible for them to differ, for instance different phone numbers may be displayed in otherwise similar advertisements, for regional call centers or regional shipping to be more easily accommodated, or for some other purpose that might be helped by region-specific advertising. In some cases a user may have a mobile device 235 which is capable of viewing televised broadcasts over the internet 230 rather than over a traditional TV network 215, without the use of a TV 220, in which case the advertisement would be broadcast over the internet, if the network managers 210 choose to broadcast the advertisement on the internet 230 as a video and audio stream.

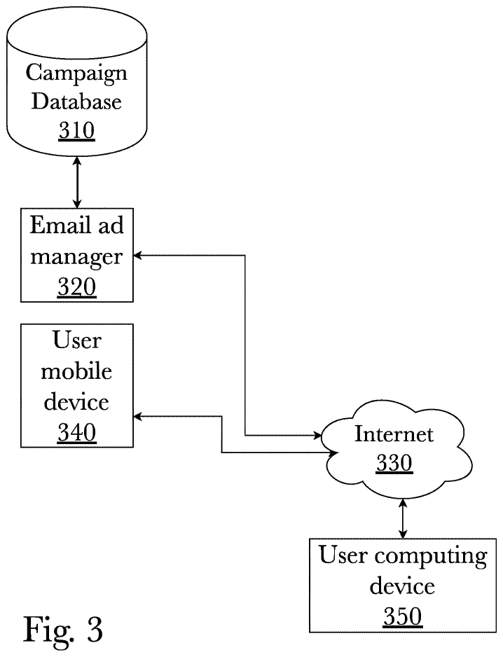

FIG. 3 is a system diagram of an email ad campaign system without using an adaptive ad campaign manager. A campaign database 310 exists which may take the form of a managed or unmanaged database, document-oriented database system, or a SQL database. Examples of types of database software that may operate include MYSQL™, ORACLE DATABASE™, MONGODB™, and others. It may exist as a distinct physical device or be operating on another computing device that may perform other functions aside from operating, hosting and serving the campaign database 310. If it is a distinct physical device, the database may be connected over a LAN or WAN, the Internet, a direct physical connection to another device, or some other network connection. An email ad manager 320 may communicate with a campaign database 310, the connection being either due to being on the same distinct device or due to a network connection such as a LAN, WAN, an Internet connection, or some other network connection. These communications comprise at least read and write communications from the ad manager 320 to a campaign database 310. An email advertisement may be specified by a user in an ad manager 320 either as a brand-new advertisement or by editing an already-stored advertisement, in either case these advertisements comprising at least an email body, email recipients, and sender address. The body of an email advertisement may include any combination of any of textual, video, image, and audio data, may be sent to multiple addresses at once, and may have dynamic data that changes based on user preferences, status of a user within a subscriber list, user location or IP address, or some other attribute that may be useful for an advertiser to target or alter an ad based on. Email advertisements are sent to an email address or a plurality of email addresses over the Internet 330, whereby an email address recipient may read the email advertisement often with the use of either or both of a mobile device 340 or a computing device 350 such as a personal computer. It is not required that a recipient actually read the email, rather than deleting or ignoring an advertisement, nor is it required that an advertisement in this embodiment avoid being marked as “spam” by filters in an email service, nor is it required that a specific email address recipient be a valid email address. It is not required in this embodiment that the status of an email as being read or not be able to be tracked by an ad campaign manager 320. However, it is possible for the opening of an email to be tracked, for instance through the use of a single-pixel image hosted by a server which tracks both the opening and the IP address of the opener, as is done in some email campaigns.

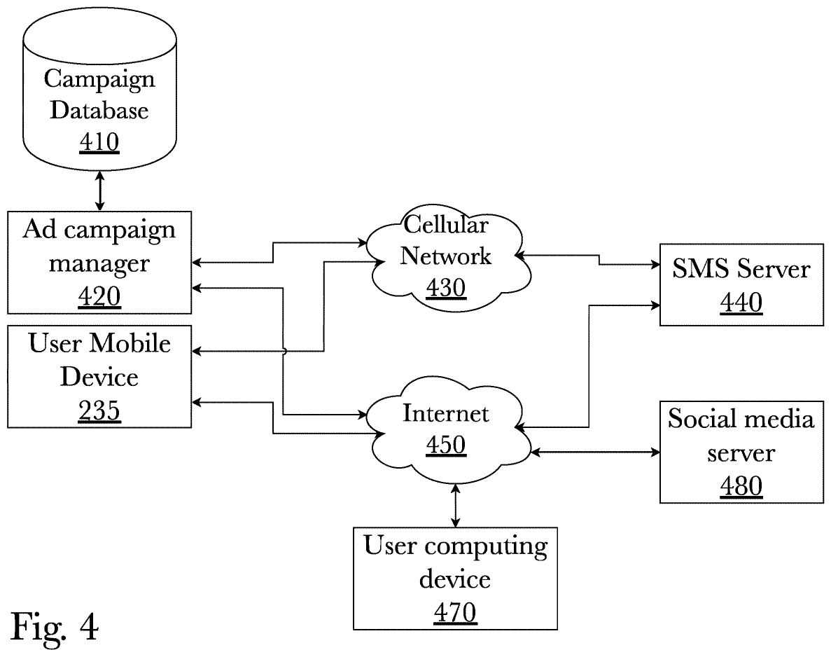

FIG. 4 is a system diagram of a social media ad campaign system without using an adaptive ad campaign manager. A campaign database 410 exists which may take the form of a managed or unmanaged database, document-oriented database system, or a SQL database. Examples of types of database software that may operate include MYSQL™, ORACLE DATABASE™, MONGODB™, and others. It may exist as a distinct physical device or be operating on another computing device that may perform other functions aside from operating, hosting and serving the campaign database 410. If it is a distinct physical device, the database may be connected over a LAN or WAN, the Internet, a direct physical connection to another device, or some other network connection. An ad campaign manager 420 connects to the campaign database 410, either on the same device or over a connection to a separate device, to perform at least read and write operations on the database, for the purposes of reading stored campaign data, and writing new campaign data, including both editing a campaign or creating an entirely new ad campaign. Social media advertisement campaigns may be generated and utilized through a combination of, or only one of, a Cellular Network 430 and the Internet 450, to deliver advertisements to users via social media platforms such as but not limited to FACEBOOK™, TWITTER™, YOUTUBE™, and others. Such advertisements may appear on web pages on social media platforms, or in videos, or even sent to users via SMS through the use of an SMS server 440. Another use for an SMS server is for user responses to advertisements, as certain advertisements on social media platforms, and certain functionality of social media platforms, utilize SMS messaging either for user verification, or for user options to be set, or for purchases, feedback, and other communication with an advertising campaign manager 420. A customer may view these advertisements through the use of either or both of a user mobile device 460 or a computing device 470 such as a tablet, PC, or hand-held computing device. A social media server 480 is the server which operates the social network that advertisements may operate on, and may be any server operated by any social network, so long as it provides a method for advertisements to be uploaded and displayed to the social media platform, for instance FACEBOOK™ allows businesses and individuals to take out advertisements, and in such an embodiment the ad campaign manager 420 may be a third-party device or software, or it may be the interface offered by FACEBOOK™ to create, edit, and track advertisement campaigns on their platform. A plurality of different social networks may be utilized for this form of advertisement, including FACEBOOK™, YOUTUBE™, TWITCH TV™, MYSPACE™, TWITTER™, and others, and such advertisements may further take place in video streams rather than solely on social media feeds. Social media advertisements often take the form of pre-recorded video and audio recordings played before or during a broadcast, as commonly seen on YOUTUBE™ and TWITCH TV™ platforms, but not only limited to those platforms.

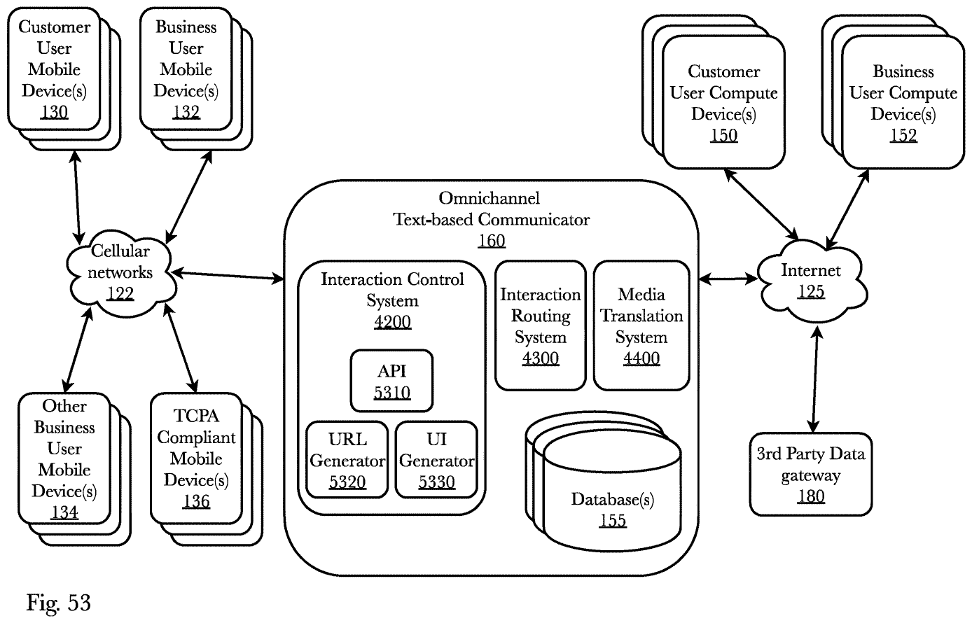

FIG. 53 is a system diagram of an omni-channel text-based communicator platform 160 comprising an API 5310 and URL/UI generator 5320/5330. This embodiment of an omni-channel text-based communicator platform 160 adds an application programming interface (API) 5310 that is used by third-party ad campaign management platforms such as GOOGLE ADS™, FACEBOOK ADS™, and others like them. It allows third-party ad campaign management platforms to integrate the communication initiator and functions thereof into an ad campaign setup process. For example, businesses using GOOGLE ADS™ and FACEBOOK ADS™ for advertising campaigns are instructed to use each platform's step-by-step process to set up an advertisement. The business fills out a series of fields and options for each product or service during the process. During one step of the process, a business is instructed to type a URL leading to the product's or service's webpage hosted on the business's domain, i.e., the link for which the ad is targeted. The business's domain may, however, be hosted by GOOGLE MY BUSINESS™ and others like it. The aforementioned step is now appended by a function call of the API 5310, whereby a URL generator 5320 takes the input URL and produces a new URL that redirects an ad click through an omni-channel text-based communicator platform 160, essentially intercepting the ad click before forwarding the user to the original input URL. The purpose of the intercepted ad click is to provide a means for implementing routing and conversion of omni-channel communications.

In more detail, the API backend 5310 receives a request via the Internet 125 from a user 150/152. This user can be person who has chosen to use the API 5310 and correctly implements the function calls. The request includes the user's original URL that points to the specific product or service the request is for. The URL generator 5320 generates a new and unique redirect URL and associates both the original and redirect URLs together and stores them in memory, i.e., a database 155. In the case where domain-level restrictions are enforced, boiler-plate HTML code with a script pointing the redirect URL is generated; the HTML code allows for the domain-restricted user to redirect to an authorized domain before the user is automatically forwarded by the script to the redirect URL. The API 5310 then returns the redirect URL, or HTML code to the user. Users may then integrate the redirect URL or HTML code as desired and wait for a customer to interact with the URL link. Upon initiation triggered by a customer, i.e., clicking or pressing on the redirect URL link or HTML coded webpage, the desired method of communication between the customer (the one who clicked or pressed on the link) and the user (the one who created the advertisement with the requested redirect URL) is facilitated by the interaction routing system 4300 and media translation system 4400.

In other words, the advertisement would allow a user on the frontend to have the option to text, webchat, or email a business or sales representative directly from the advertisement itself. On the backend, businesses using third-party ad campaign management platforms would now be presented with an option during advertisement set up to allow this omni-channel communication on each advertisement. In particular, each individual product and service may comprise a distinct URL redirect that specifically allows or limits one or more types of communication or the conversion thereof, directs to a specific salesperson, or other feature of the omni-channel text-based communicator platform 160 as laid out in other present figures as disclosed herein.

Another aspect of the embodiment allows for specific communicator initiator buttons inside product or service pages hosted on third-party websites, not necessarily a third-party ad campaign. For example, AMAZON™ is a third-party seller of thousands of products, all of which could have a unique redirect URL allowing customers to inquiry about a product on the website with either an AMAZON™ representative or the manufacture of the product without ever leaving amazon. com. While amazon. com is arguably the most visited North American e-commerce website, any e-commerce website, or any website for that matter, may use the API 5310 to host call-to-action buttons (i.e., communicator initiators).

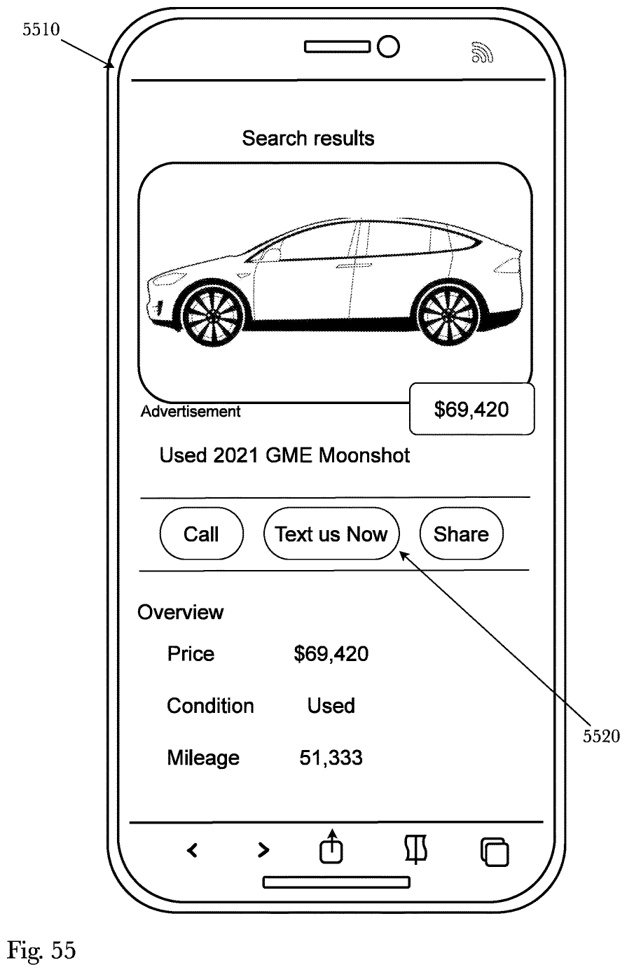

One generic use case is the auto sales industry. Each vehicle may have a unique advertisement with a unique redirect URL containing information about the specific ad, that when a customer clicks to communicate with the business, the business receives that information and is ever-more prepared to close the sale. A specific use case within the auto sales industry is a customer interested in a specific used vehicle. During an Internet search on his or her mobile device 5510 for that vehicle, an advertisement for the vehicle is displayed, the advertisement comprising a “text us now” button 5520, i.e., link, as shown in FIG. 55. The customer clicks the “text us now” button and his or her default mobile messaging application opens with (or without according to one aspect) a default message prepopulated. The default message may be along the lines of “Hi, I'm interested in specific vehicle.” Wherein the “specific vehicle” is the vehicle from the advertisement. Now, depending on how the business set up the omni-channel text-based communicator platform 160, the incoming text message may go into a round-robin process looking for an available salesperson, or may be converted into an email or webchat, or any combination of communication technologies. The customer never had to leave the advertisement to communicate about the product or service advertised.

One optional aspect of various embodiment comprises a UI generator 5330. This aspect allows a business to stipulate the desired dimensions, colors, text, and other features of the communication initiator, i.e., call-to-action button, during the third-party ad campaign management platforms advertisement set up procedure. This is made possible by another API 5310 function call and a UI generator 5330.

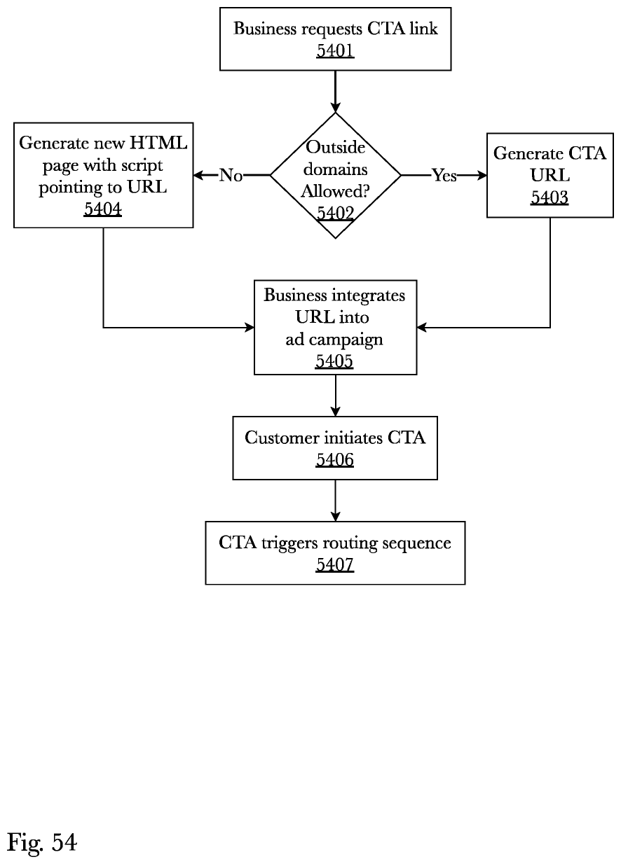

FIG. 54 is a method diagram illustrating omni-channel text-based communicator platform integration with third-party ad campaigns. In the first step 5401, an omni-channel text-based communicator platform receives a request for a call-to-action (CTA) link, and optionally, a corresponding UI graphic from a third-party ad campaign management platform or other entity. Then a check is performed if links to outside domains are allowed by the third-party ad campaign platform 5402. If the request comes from an entity that enforces domain-level restrictions, i.e., links may not point outside specified domains, then the omni-channel text-based communicator platform will generate HTML code complete with a script pointing to the generated redirect URL 5404. Otherwise, no HTML code or script is necessary, and a CTA redirect URL is generated 5403. Both steps lead to the generated content being returned to the origination of the request via the API, whereby the content is inserted, integrated, or otherwise implemented into the requesting party's advertisement 5405. The entity requesting the redirect URL may automate the importing of the redirect URL into the advertisement or it may be done manually. Subsequently, after the advertisement comprising the CTA link is live, meaning Internet users may see and interact with the advertisement, and an Internet user then interacts with the advertisement 5406, the omni-channel text-based communicator platform will trigger the appropriate communication conversions and routing 5407.

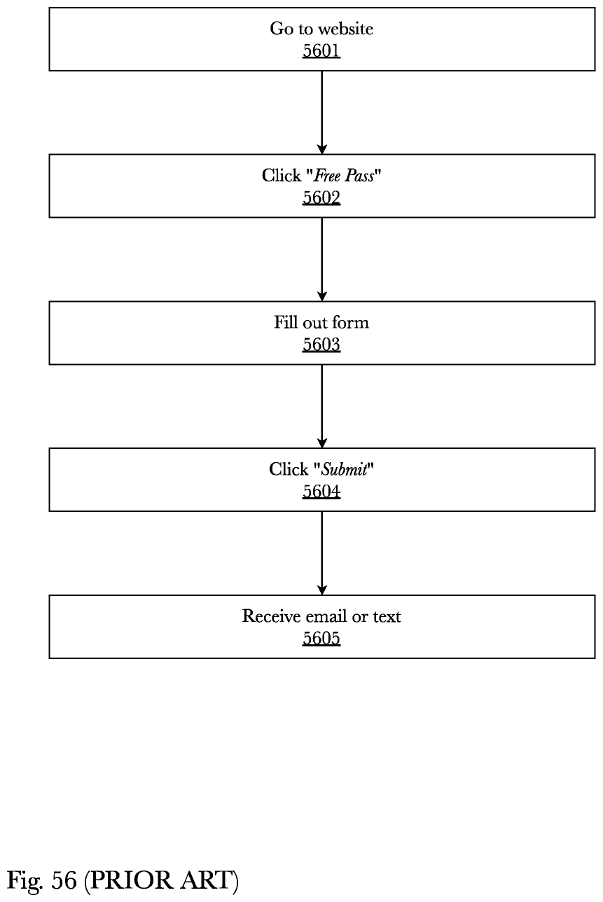

FIG. 56 (PRIOR ART) is a flow diagram of current methods used to receive a digital coupon from a business using a website. This diagram is an example of current methods in the art to give coupons, free trials, and vouchers to customer's via email or text. A customer visits a business's website 5601, and sees a button, advertisement, or link for a coupon, free trial, or vouchers. The customer must click on such a link, an example may be a “free pass” link 5602. Typically the customer is then taken to a webpage to fill out a lengthy form to include fields such as first name, last name, address, zip code, email, phone number, among other fields 5603. The customer must then click submit 5604 and wait for an email or text 5605.

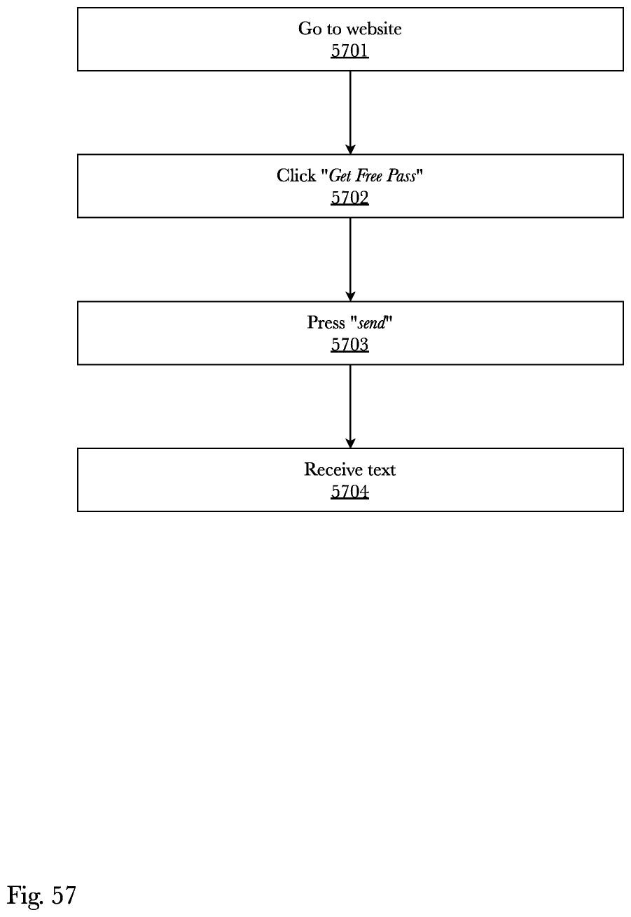

FIG. 57 is a flow diagram of an exemplary method used to receive a digital coupon from a business using a tap-to-text button on a website. According to one embodiment, a customer visits a business's website 5701 and sees a call-to-action button, e.g., tap-to-text button, for a coupon, free trial, or voucher. The tap-to-text button may be replaced with other words or graphics such as “Get free pass” button or link 5702. The link automatically opens the customer's mobile text messaging application with a prepopulated text message to the business, whereby the customer must simply press “send” 5703. The sent text message triggers a return text message 5704 generated by the system comprising some form of the coupon, free trial, or voucher. The form may be a graphic sent over multimedia messaging service (MMS), a uniform resource locator (URL) link, a QR code, an alphanumeric code, text, or any other type of media possible to send over a messaging service.

The system by which this method takes place uses the system as laid out in FIG. 1A and other figures. The coupon, free trial, or voucher text message may be stored in a database 155 and be sent out via the omnichannel text-based communicator 160 upon receipt of the text message sent by the customer's mobile device 130/150. Additionally, once the text message from the customer is received by the omnichannel text-based communicator 160, follow up text messages may be automatically sent to the customer asking for additional information such as zip code, name, and email address. Links to open the map application or a website with a map embedded may be sent to the customer as well in order to show locations of interest related to the coupon, free trial, or voucher. Reminders to use the coupon, free trial, or voucher may also be automatically sent to the customer's mobile device as desired by setting configuration files within the omnichannel text-based communicator 160. The call-to-action button on the business's website may be implemented manually by adding programming code, or by using the system and method disclosed in FIGS. 53-55, utilizing the API and a redirect URL.

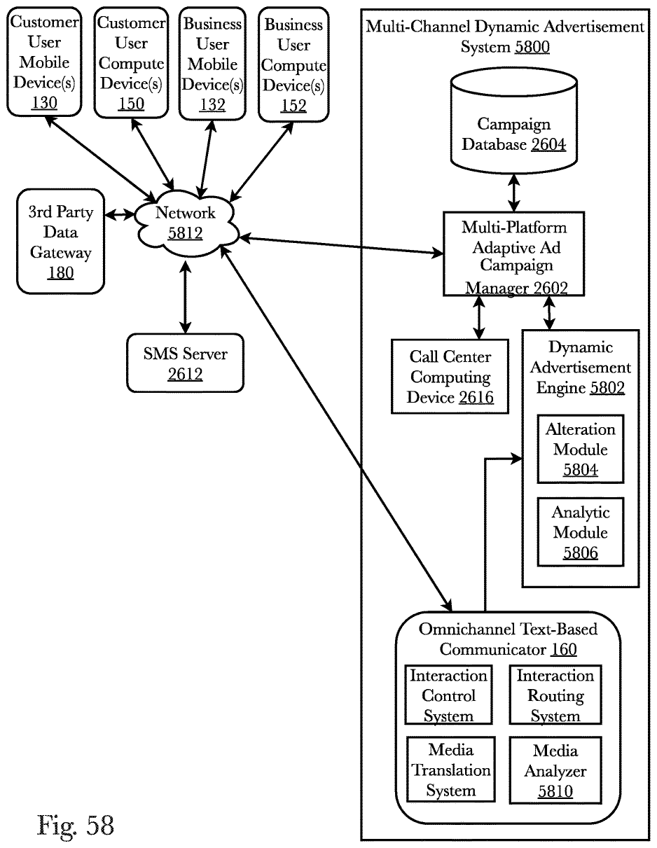

FIG. 58 is a block diagram of an exemplary system architecture for a multi-channel dynamic advertisement system 5800, according to an embodiment. According to some embodiments, system 5800 may comprise an omnichannel text-based communicator 160, a multi-platform adaptive ad campaign manager 2602, a dynamic advertisement engine 5802, an analytics module 5806, an alteration module 5804, and a campaign database 2604. In some embodiments, a call center computing device 2616 may also be present as part of the system, or separate from the system but configured for bi-directional data exchange over a network connection with system components. The multi-channel dynamic advertisement system 5800 may interface with a network 5812 which allows for the system 5800 and/or its components to be communicatively coupled with an SMS server 2612, a plurality of mobile devices 130, 132 (e.g., smart phone, tablet, smart wearable) and compute devices 150, 152 (e.g., personal computers, servers, tablets, laptops, databases, etc.) associated with customers, businesses, and third-party 180 enterprises.

The campaign database 2604 may take the form of a managed or unmanaged database, document-oriented database system, or a SQL database. Examples of types of database software that may operate include MYSQL™, ORACLE DATABASE™, MONGODB™, and others. The campaign database 2604 may exist as a distinct physical device or be operating on another computing device that may perform other functions aside from operating, hosting and serving the campaign database 2604. If the campaign database 2604 is a distinct physical device, the database may be connected over a LAN or WAN, the Internet, a direct physical connection to another device, or some other network connection. The campaign database 2604 may be a centralized database system. The campaign database 2604 may be a distributed database system.

The campaign database 2604 may be configured to store a plurality of ad campaigns including the associated ad campaign data for each ad campaign in the ad campaign database 2604. In some embodiments, the ad campaign data specifies the different media platforms that will be used to broadcast the ad campaign. In some embodiments, ad campaign data may include one or more variants of an advertisement. In some embodiments, an advertisement variant may be an advertisement where at least one element of the advertisement has been altered in some form. Non-limiting examples of advertisement elements include: headlines and copywriting; call to actions (CTAs); images, audio, and video; subject lines (e.g., email ads); content depth (i.e., how much information to include in ad); product descriptions (e.g., length, placement, etc.); social proof (e.g., customer/purchaser reviews of product); media mentions; and landing pages. In some embodiments, elements may further include font, colors, ad placement, time and location (e.g., when and where is ad displayed), and audience.

Ad variants may be developed and included in the ad campaign data by business personnel during ad campaign initialization with the multi-platform adaptive ad manager 2602. In other embodiments, ad variants may be generated by dynamic advertisement engine 5802. In some embodiments, ad variants may be generated semi-autonomously with input from business personnel. For example, dynamic advertisement engine 5802 may receive data associated with an ad campaign and analyze it, and based on the analytic data it may suggest an element of an advertisement to be altered, which can then be reviewed and implemented by business personnel, such as a business marketing manager. In some embodiments, ad variants may be generated autonomously. For example, dynamic advertisement engine 5802 may receive analytic data associated with an ad campaign and based on the received data it may suggest an element of an advertisement to be altered, which can be automatically applied to the ad via the ad campaign data stored in campaign database 2604.

The purpose of utilizing ad variants is to gather useful data about the efficacy, efficiency, and profitability of a given advertisement and/or an ad campaign. Implementing two similar ads with the only difference between the two being a single element alteration can allow businesses to understand how elemental choices for an advertisement affect customer interaction. For example, an email ad campaign for a hiking boot is developed with a baseline email subject header of “Reach New Heights With These Boots”, and a variant ad is also developed with the email subject header of “Tough On The Mountain, Gentle On Your Feet”, wherein the only difference between both emails is the subject header. Both the baseline ad and the variant ad can then be deployed and customer engagement data with both the baseline and variant can be monitored and analyzed to determine which of the baseline or the variant led to better outcomes for the business running the ads and/or ad campaign. In some embodiments, ad campaign data may include a test plan for configuring the deployment of two variant advertisements. For example, a test plan may describe what element is to be tested and subsequently altered, the goals of the test plan (e.g., improving conversion rates), initial state of advertisement (i.e., baseline metric that describes current state of advertisement), the order of element alterations to be made, test design (e.g., how long to test the variants, which devices to test on, etc.) and the like. In some embodiments, test plans may be received, retrieved, or otherwise obtained from campaign database 2604 by dynamic advertisement engine 5802 as an input into suggesting element alterations. Additionally, test plans may be utilized by multi-platform adaptive ad campaign manager 2602 when configuring and deploying an ad campaign.

The multi-channel dynamic advertisement system 5800 may be well suited for ad comparison and performance analysis because multi-platform adaptive ad campaign manager 2602 is configured to receive customer interactions with an ad and then supply the customer with a text which can link the customer to an appropriate endpoint for the product, such as a contact center agent, a sales associate, a landing page for a product, etc. In this way, system 5800 is able to track the engagement/interaction (e.g., clicks, taps, etc.) an advertisement generates. Furthermore, omnichannel text-based communicator 160 may facilitate communications between a customer and an endpoint (e.g., business user) by establishing interaction control legs and mediating a media stream between both the customer and the endpoint, such as by masking user and endpoint device data and formatting the messages to facilitate cross-channel communication (e.g., text-to-email). Because each message is received by omnichannel text-based communicator 160 in order to format as necessary, the contents of each message received can be analyzed by media analyzer 5810. In some embodiments, media analyzer 5810 may include a natural language processing system capable understanding the nature and content of the messages. Media analyzer 5810 may analyze the media stream in order to determine: if a product sale was made; if the customer signed up for an account with the business; the customer's sentiment toward the product, the advertisement, and/or the endpoint (e.g., sales representative, etc.); and the reason(s) why the customer engaged with the advertisement. In this way, system 5800 is able to monitor and analyze the media stream data between a customer and an endpoint in order to produce data indicative of the level of success a particular advertisement has on customer loyalty, customer retention, product sales, and business traffic (e.g., product landing page views, etc.). In some embodiments, surveys may be used after a completed transaction (e.g., product sale, business account sign-up, etc.) to collect customer data regarding their engagement with the advertisement. In an embodiment, the survey may ask the customer to provide a reason for interacting with the advertisement and/or to rate (e.g., on a scale of 1-5) the advertisement.

According to some embodiments, an analytic module 5806 may receive, retrieve, or otherwise obtain a plurality of data such as, but not limited to, interaction details data, media stream data, ad campaign data, survey data, and business data and process the plurality of data in order to determine the efficacy of a given advertisement and/or ad campaign. In some embodiments, analytic module 5806 may receive data pertaining to at least two advertisements comprising a baseline advertisement and a variant advertisement, and determine which of the two advertisements produced better results based upon analysis of the received data.

According to some embodiments, analytical data such as, for example, a determination of a better advertisement between at least two advertisements, may be received, retrieved, or otherwise obtained by dynamic advertisement engine 5802. Dynamic advertisement engine 5802 and/or alteration module 5804 may process the analytical data together with ad campaign data (e.g., test plan information) in order to suggest at least one advertisement element to alter in order to form a new variant of an advertisement. For example, data analytics suggest that a first variant of a baseline advertisement was better at leading to product sales than the baseline version of the advertisement, and responsive to this analysis alteration module 5804 can suggest an element alteration to the first variant to form a second variant. The first and second advertisement variants may then be deployed to various platforms via multi-platform adaptive ad campaign manager 2602 and the process of collecting data related to advertisement engagement/interaction can begin again using the first and second variant, wherein after statistically relevant data is collected, analytic module 5806 may make a determination of whether the first variant or the second variant was better. The determination of a “better” advertisement can be based on statistically significant metrics such as, for example, ad clicks and conversion rates. In the case that there is statistically insignificant differences between two advertisements, dynamic advertisement engine 5802 may suggest no alterations to an element. In some embodiments, the element to be altered is the same type of element (e.g., email header element is altered between two advertisements).

In some embodiments, dynamic advertisement engine 5802 may receive, retrieve, or otherwise obtain third-party data 180 to be used as an input when making element alteration suggestions. Because marketing is such a vital component of any business within any industry, there is a lot of market research data available regarding advertisement content and configuration which may be used by dynamic advertisement engine 5802 to determine appropriate and effective element alterations. For example, it has been shown that an advertisement with a red call-to-action button outperforms a green call-to-action button by about 21%. The large difference in click rate between such a minor change shows the importance of testing different variants of a given advertisement in order to maximize customer engagement and improve conversion rates.

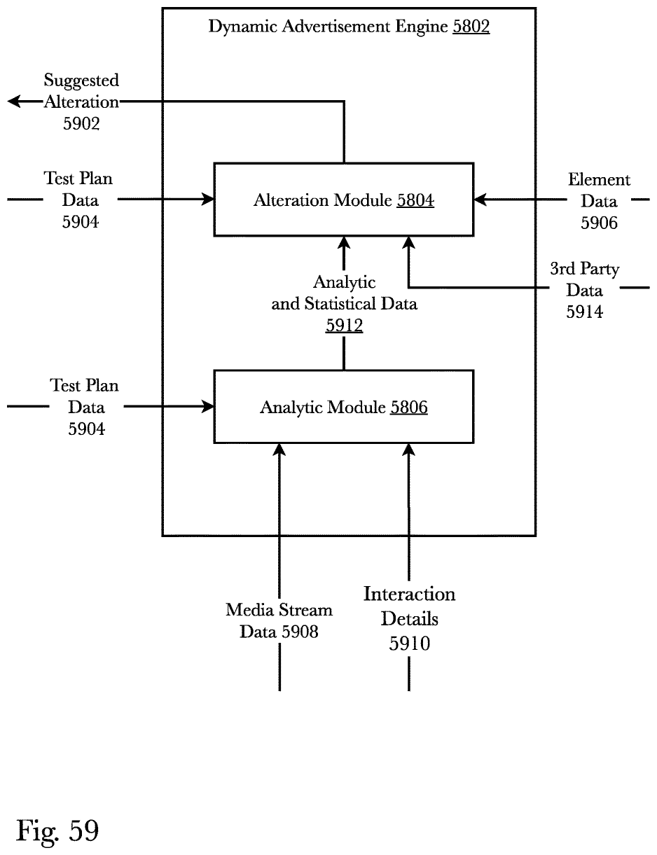

FIG. 59 is a block diagram illustrating an exemplary aspect of the multi-channel dynamic advertisement system 5800, the dynamic advertisement engine 5802. According to some embodiments, analytic module 5806 may receive a plurality of data from various sources and perform at least a statistical analysis of the received data in order to determine the effect that an advertisement element alteration had on the success or failure of a give advertisement or ad campaign. Success may be determined based on metrics such as click rate of an advertisement, conversion rates (e.g., product purchase conversion, business account sign up by customer, etc.), customer sentiment, customer engagement, customer referrals, and the like. Some of the data that analytic module 5806 may receive, retrieve, or otherwise obtain and then process and analyze may include, but is not limited to, test plan data 5904, media stream data 5908, and interaction details 5910. Test plan data 5904 may be stored and retrieved from campaign database 2604 and may be used by analytic module 5806 for a variety of purposes. For example, analytic module 5806 may use test plan data 5904 to determine the goals of the and the completion of an ad variant test, such as recognizing the goal of the variant test was to improve conversion rates and then performing analysis to determine the conversion rates of the two variants. Media stream data 5908 may include information about a customer's message thread with a business as facilitated by omnichannel text-based communicator 160. The type of information may include information about the nature, sentiment, and content of a customer's messages regarding an advertised product or service. Interaction details 5910 can include information about customer interactions with a business or business representative such as, for example, whether a customer decided to purchase the advertised product. Analytic module 5806 may process and analyze these and other types of data in order to produce statistical data that is useful for determining the effectiveness of an advertisement variant.

According to some embodiments, the produced analytic and statistical data 5812 may be sent to alteration module 5804 where it can be used with other types of data to suggest an advertisement element alteration. In addition to the statistical data 5912, alteration module 5804 may also receive test plan data 5904, element data 5906, and third-party data 5914. Test plan data 5904 and element data 5906 may be stored in and retrieved from campaign database 2604. Test plan data 5904 may include, but is not limited to, information about the advertisement element that was tested, variant test goals, and an order in which to apply element alterations (e.g., first test a small call-to-action button then test a medium sized call-to-action button, and then test a large sized call-to-action button). Element data 5906 may include, but is not limited to, a list of element types that may be altered and element variants created by business personnel. In some embodiments, third-party data 5914 may include, but is not limited to, existing market research associated with advertisements and a plurality of advertisement elements, social media data (e.g., customer liked product pages, posts about products or experiences with a product or business, etc.). Alteration module 5804 may use the received statistical data 5912 to identify which of the two advertisement variants should be used as the baseline in the next round of variant testing, and then leverage the test plan data 5904, element data 5906, and third-party data 5914 to suggest an advertisement element alteration 5902 to be implemented in the next round of variant testing. In some embodiments, alteration module 5804 may suggest using the next ordered element variant that was included in the test plan data 5904. In some embodiments, alteration module 5804 may suggest an element alteration which can be reviewed by a business personnel prior to being implemented.

### Detailed Description of Exemplary Aspects

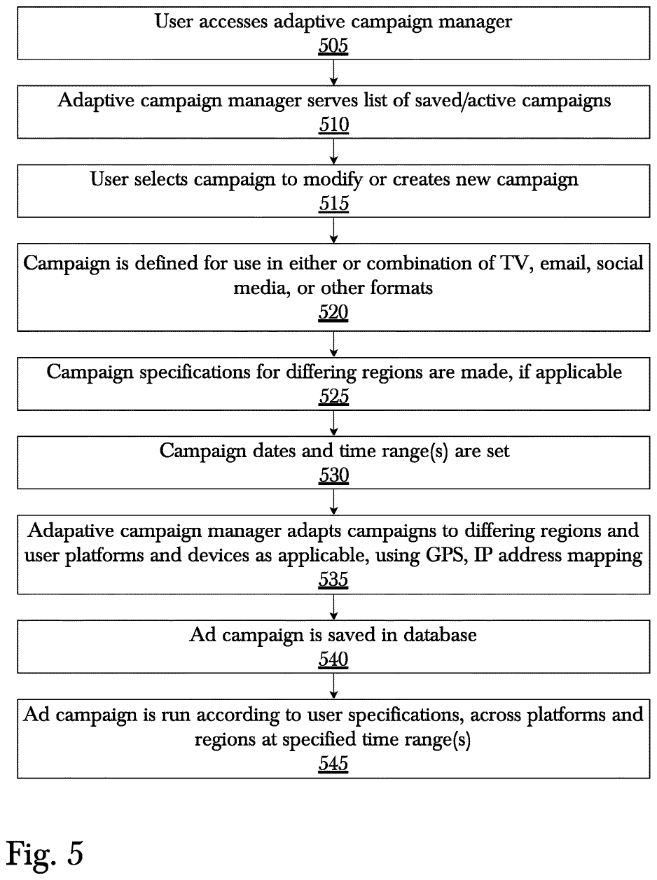

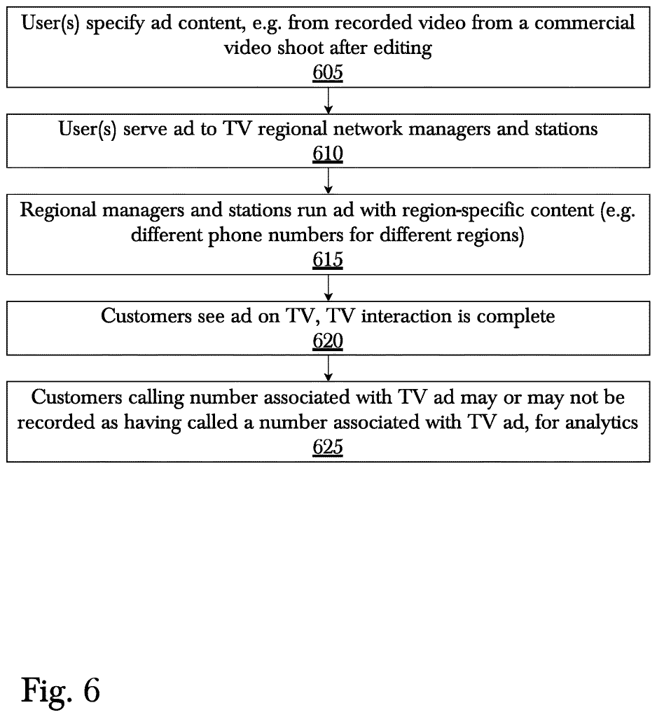

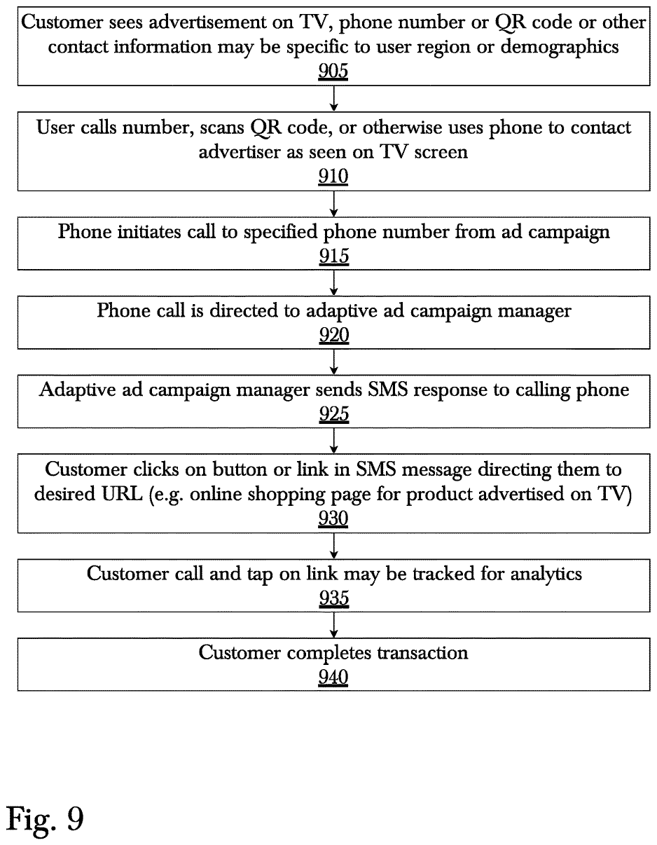

FIG. 5 is a method diagram illustrating steps for defining, altering, and executing ad campaigns on multiple platforms and mediums using an adaptive ad campaign manager. First, a user accesses an adaptive campaign manager 505, which is a software on a computational device that is connected to a PSTN, the Internet, and has an interface to at least one TV network in order to manage approved TV advertisements on a given television channel. With the use of an ad campaign database or datastore, which may be one of many database types including MONGODB™, SQL™, ORACLEDB™, or others, the adaptive campaign manager serves the user a list of saved/active campaigns 510, if any. If any are available to the user, the user may select a campaign or campaigns to modify or may create a new campaign 515. Creation of a new campaign, or editing of a previous campaign, requires that an adaptative ad campaign manager have read and write permissions to an advertisement database, and requires that the user have access to these functionalities. Through either editing of a campaign or creation of a new campaign by a user, a campaign is defined for use in any of or a combination of TV, email, social media, or other formats 520, with campaign specifications allowing for alterations or dynamic portions of an advertisement based on region, if applicable 525. In this way, for instance, an advertisement may be made for different regions based on IP address, or user account name on a social media platform, or email address name, or region of their TV network, to provide for differing images, text, video, or audio, or some combination thereof. An example may be region-specific phone numbers for more local contact centers, warehouses, or stores, in a TV advertisement. After region settings, if any, are specified by a user, the campaign dates and time range(s) are set 530, for instance an advertisement on social media platforms that coincides with a certain political election season but turns off outside of the election season, or an advertisement for a new TV show that stops airing on TV networks after a certain date when the show is released. The adaptive campaign manager may adapt campaigns to differing regions and user platforms and devices as applicable, using GPS, IP address mapping 535, as mentioned, and store these alterations along with the rest of the campaign data, saving the ad campaign in the database 540. Finally, the ad campaign may then be run according to user specifications, across the specified platforms and regions at the specified times and time range(s) 545.
FIG. 6 is a method diagram illustrating steps for specifying a TV ad campaign using an adaptive ad campaign manager, according to a preferred aspect. First a user or multiple users specify ad content, e.g. from recorded video from a commercial video shoot after editing 605, but the advertisement content may be from other sources as well, for instance it may be designed in video creation software, photo editing software, text editing software, some combination of these, or some other source entirely, as the format of the advertisement is always able to at worst be recorded manually if it is in an otherwise unsupported format by a TV network's standards. Either the finished formatted advertisement, or the unformatted raw advertisement data, or both, may be specified by the user. The user or users may then serve the ad to a single or plurality of TV networks or regional network managers and stations 610, either for distribution to an entire network or for altered or dynamic advertisements to be distributed to different regions or locales for advertising, such as a phone number that is different for specific regions where the advertisement appears. Television networks, regional managers and stations, or both, run the specified ad or ads with region-specific content (e.g. different phone numbers for different regions) 615 at the specified times or time ranges, as necessary, and when the customers see the ad on TV, the base interaction with the TV advertisement is complete 620. Further interaction such as calling a phone number, visiting a website, downloading an app, going to a physical location such as a retail outlet, or more, may be possible, but is not required or standardized across television advertisements as far as specifying the advertisement itself is concerned. However, according to an embodiment, customers may call a number associated with a TV ad made and utilized in this way, which may or may not be a region-specific phone number or advertisement as previously specified, and may be recorded as having called a number associated with TV ad, for analytics 625. As shown in FIG. 9, the phone number is utilized to simplify user interaction and provide more complete analytics on users influenced or taking action due to an advertisement, according to a preferred embodiment. It is possible for television to be viewed on a mobile device or other computing device, and as such a television in this embodiment may be understood as any device capable of viewing television broadcasts or television broadcasts viewed over the internet or any other network on a computing device.

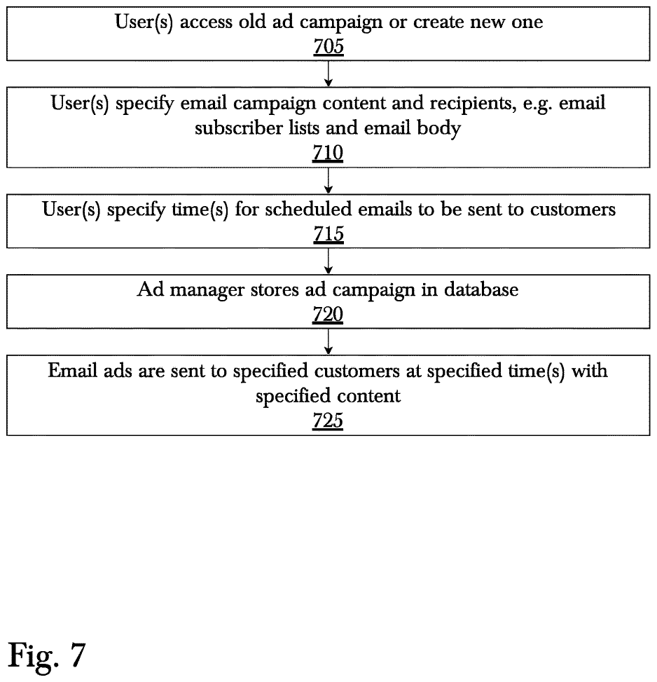

FIG. 7 is a method diagram illustrating steps for specifying an email ad campaign using an adaptive ad campaign manager, according to a preferred aspect. First a user may access an already-created advertisement campaign in an advertisement campaign database, or create a brand new advertising campaign 705. Examples of types of database software that may operate include MYSQL™, ORACLE DATABASE™, MONGODB™, and others. It may exist as a distinct physical device or be operating on another computing device that may perform other specified functions aside from operating, hosting and serving the campaign database. If it is a distinct physical device, the database may be connected over a LAN or WAN, the Internet, a direct physical connection to another device, or some other network connection. Once an ad campaign is read from the database and prepared for editing, or a new campaign is created and ready for editing, the user or users may specify email campaign content and recipients, e.g. email subscriber lists and email body 710, such that the content will comprise at least an email header and subject, body, any relevant attachments, recipients either in a “to:” field, a “CC:” field, or “BCC:” field, or some other label for a recipient field. Not only are email recipients and content specified, but further, a user or users may then specify a time or times for scheduled emails to be sent to customers 715, which may further be specified in reaction to some API call or other action. For instance, email advertisements made in this way may be specified to run at particular dates and times, or may be specified to run if an email is sent to a connect email address, or even a third-party process such as a web-crawler may search a website or websites for content, and if content matching a given set of parameters is found, the ad campaign is sent out as specified. Regardless of whether a campaign is executed immediately or for some future date, or specified for execution in response to a certain set of conditions, the ad campaign manager stores the ad campaign in an advertisement campaign database 720 or databases, as applicable in a given implementation. Eventually or immediately, the specified email ads are sent to specified customers at specified times or in response to the specified conditions, with the specified content 725.

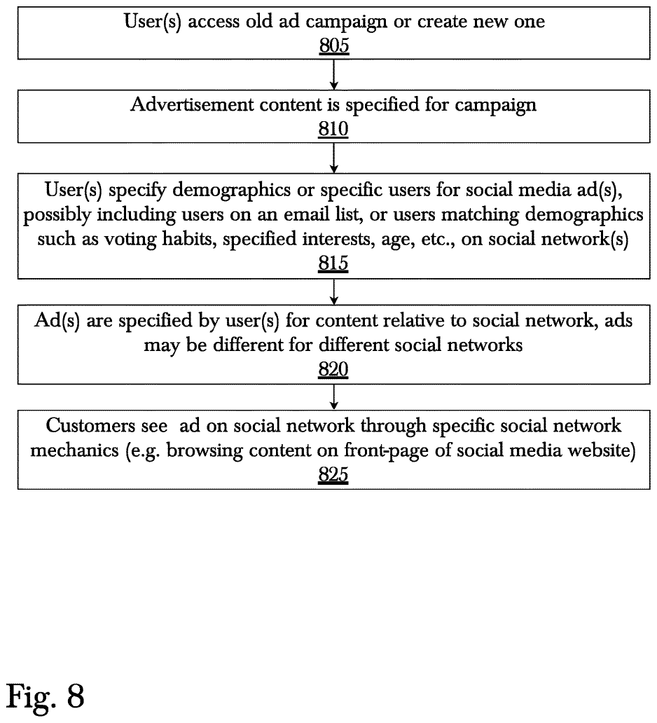

FIG. 8 is a method diagram illustrating steps for specifying a social media ad campaign using an adaptive ad campaign manager, according to a preferred aspect. First a user may access an already-created advertisement campaign in an advertisement campaign database, or create a brand new advertising campaign 805. Examples of types of database software that may operate include MYSQL™, ORACLE DATABASE™, MONGODB™, and others. It may exist as a distinct physical device or be operating on another computing device that may perform other specified functions aside from operating, hosting and serving the campaign database. If it is a distinct physical device, the database may be connected over a LAN or WAN, the Internet, a direct physical connection to another device, or some other network connection. Once an ad campaign is read from the database and prepared for editing, or a new campaign is created and ready for editing, the user or users may specify ad content and demographics or target audience, e.g. email subscriber lists or user nationalities being possible choices, and specifying the actual content of the advertisement 810, 815. Advertisements on social media may be specified to be posted not only for specific demographics and customer audience groups, but also for specific time and date ranges, or in response to certain conditions being met. Regardless of whether a campaign is executed immediately or for some future date, or specified for execution in response to a certain set of conditions, the advertisements may be dynamic or specifically designed to be different for differing audiences based on region, demographics, or other factors that may be possible to assess of a customer, much like a TV advertisement may look different or have a different listed phone number in some regions using this system 820. Eventually or immediately, the specified advertisements are visible to customers on the specified social media platform or platforms at specified times or in response to the specified conditions, with the specified content, whether dynamically altered or static for all users 825. A plurality of different social networks may be utilized for this form of advertisement, including FACEBOOK™, YOUTUBE™, TWITCH TV™, MYSPACE™, TWITTER™, and others, and such advertisements may further take place in video streams rather than solely on social media feeds. Social media advertisements often take the form of pre-recorded video and audio recordings played before or during a broadcast, as commonly seen on YOUTUBE™ and TWITCH TV™ platforms, but not only limited to those platforms.

FIG. 9 is a method diagram illustrating users interacting with TV ads using an adaptive ad campaign manager, according to a preferred aspect. After a television advertisement is specified and executed, a customer may see the advertisement on TV, which contains one or multiple of a phone number or QR code or other contact information which may be specific to user region or demographics 905, allowing a user to call the number, scan the QR code, or otherwise use their phone to contact the advertiser as seen on the TV screen 910. For instance, an advertisement may appear to customers in New York state and Washington State, for some store that operates only in these two states, but in these states has a moderate presence and wishes to grow. An advertisement that is mostly the same may air over several television channels in both states, but with different phone numbers for users to call if they are interested in the store and their products. After this step, a user initiates a phone call to specified phone number from ad campaign 915, either from the number on the screen, from the code scanned, or some other method of transmitting a phone number to a user. After a user initiates a phone call from the number on-screen or resulting from a scanned QR code or some other method (such as a URL on the TV showing them the phone number), the phone call is directed to the adaptive ad campaign manager 920 which uses an SMS server to respond to the user's phone call 925 with a link, or button, allowing them to complete a transaction, view a website or web page, or perform some other CTA 930. Alternatively, a call may be redirected to a redirect server, which handles the phone redirection and SMS response containing the CTA, rather than the call being directed to the adaptive campaign manager. Further, it is possible to have the adaptive campaign manager operate as part of such a redirect server in yet another implementation. The customer may then call or tap on the link, button, or other CTA, which is tracked for analytics 935 due to the fact that it is a CTA served directly by the ad campaign and which knows the phone number and accompanying data of the user, and allows the customer to complete the transaction as designed 940. This interaction may be monitored for the purposes of analytics, allowing the user's initial interaction with the advertisement, their call to the campaign manager or redirect server, and their completion of a purchase or service-use or other CTA fulfillment, may all be monitored for analytics purposes, allowing for a more complete analytics report on the use of these advertisements. The phone number displayed to a user may be dependent on the region of the broadcast, and as such further offers analytics tracking for users based on region and specific broadcasts. It is possible for television to be viewed on a mobile device or other computing device, and as such a television in this embodiment may be understood as any device capable of viewing television broadcasts or television broadcasts viewed over the internet or any other network on a computing device.

An example of a dynamic and tracked TV advertisement which interacts with a user in this way is provided. A television advertisement campaign may be specified for a product that is only legal in certain states of the United States of America, and which requires separate shipping options for customers in different states in the United States of America. Using the enclosed method, an otherwise typical TV advertisement may display different phone numbers to users in the different states, if desired. When a user calls the displayed number, their call is automatically captured by the advertisement campaign manager and an SMS text message is sent to the customer's phone, containing a link to an AMAZON™ or other web-portal for purchase fulfillment. The phone call the user initially placed, the SMS response, and their tap on the link or button from the SMS message, as well as whether or not they finish the transaction, are all able to be tracked, unlike with traditional TV advertising where it is not guaranteed how many individuals see the advertisement and are swayed to use a product or visit a store or restaurant or similar. The user, after being directed to a web-portal for purchase such as AMAZON™, may then finish the transaction, the entire string of events from the customer's perspective being to watch an advertisement, call a phone number, then click on a link from a text message and purchase the item from the online shopping portal, requiring no navigation of a phone system, website, travel to a brick and mortar store, and the entire interaction being trackable for analytics purposes.

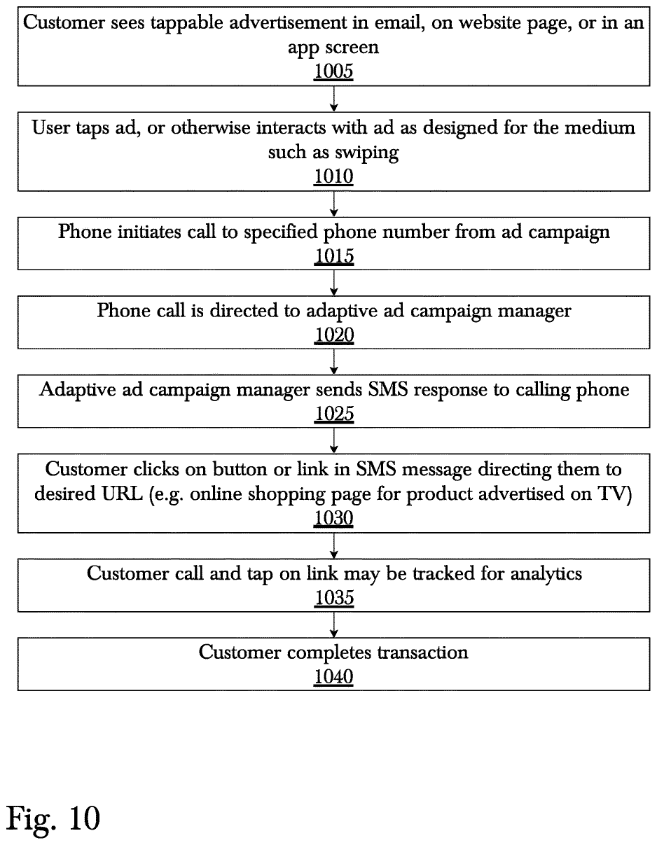

FIG. 10 is a method diagram illustrating users interacting with email ads using an adaptive ad campaign manager, according to a preferred aspect. After an email advertisement campaign is specified and executed, a customer or customers may see the advertisements through their email providers, which contain one or multiple of a phone number, QR code, tappable link or button or image, or other contact information or interactive design which may be specific to the customer's region or demographics 1005, allowing a user to call the number, scan the QR code, tap the link or image or button, or otherwise use their phone to contact the advertiser as seen in the email screen 1010. For instance, an advertisement may appear to customers who signed up for an email subscriber list and listed their locations in New York state and Washington State, for some store that operates only in these two states, but in these states has a moderate presence and wishes to grow. An advertisement that is mostly the same may be sent over email to users in both states, but with tappable image links that go to different URL's for users in the different states if they are interested in the store and their products. After this step, the interaction initiates a phone call to a specified phone number from the ad campaign 1015, either from the number on the screen, from the code scanned, from the tapped image or link or button, or some other method of transmitting a phone number to a user. After a user initiates a phone call from the number on-screen or resulting from a scanned QR code or some other method, the phone call is directed to the adaptive ad campaign manager 1020 which uses an SMS server to respond to the user's phone call 1025 with a link, or button, allowing them to complete a transaction, view a website or web page, or perform some other CTA 1030. Alternatively, a call may be redirected to a redirect server, which handles the phone redirection and SMS response containing the CTA, rather than the call being directed to the adaptive campaign manager. Further, it is possible to have the adaptive campaign manager operate as part of such a redirect server in yet another implementation. The customer may then call or tap on the link, button, or other CTA, which is tracked for analytics 1035 due to the fact that it is a CTA served directly by the ad campaign and which knows the phone number and accompanying data of the user, and allows the customer to complete the transaction as designed 1040.

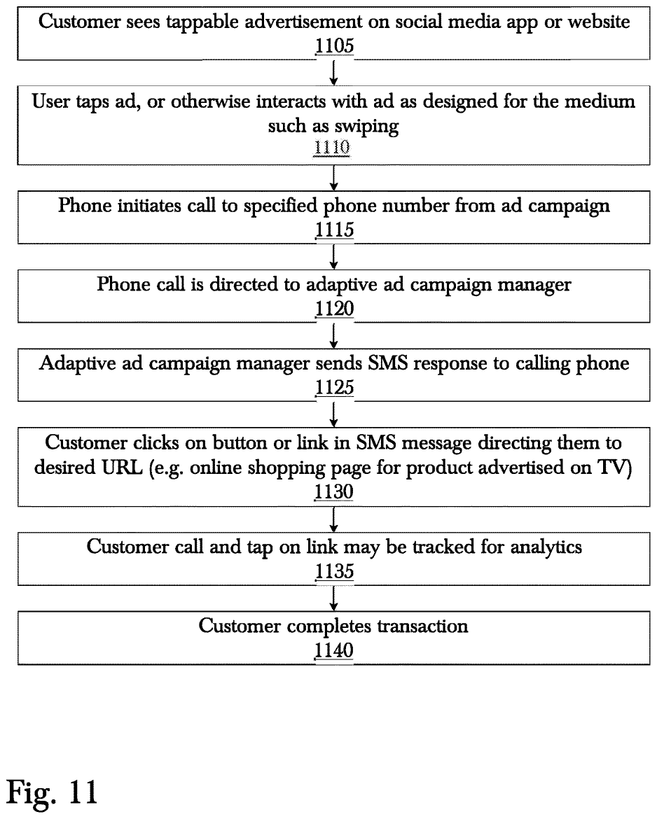

FIG. 11 is a method diagram illustrating users interacting with social media ads using an adaptive ad campaign manager, according to a preferred aspect. After a social media advertisement campaign is specified and executed, a customer or customers may see the advertisements with their social media accounts, the advertisements containing one or multiple of a phone number, QR code, tappable link or button or image, or other contact information or interactive design which may be specific to the customer's region or demographics 1105, allowing a user to call the number, scan the QR code, tap the link or image or button, or otherwise use their phone to contact the advertiser as seen on the social media platform 1110. For instance, an advertisement may appear to customers who “follow” a business'page on a social media platform, allowing them to receive updates and ads from them, and listed their locations in New York State and Washington State, if the store operates only in these two states. An advertisement that is mostly the same may be visible to users in both states, but with tappable image links that go to different URL's for users in the different states if they are interested in the store and their products, if this is supported by the social media platform, otherwise the advertisements will be uniform. After this step, the interaction initiates a phone call to a specified phone number from the ad campaign 1115, either from the number on the screen, from the code scanned, from the tapped image or link or button, or some other method of transmitting a phone number to a user. After a user initiates a phone call from the number on-screen or resulting from a scanned QR code or some other method, the phone call is directed to the adaptive ad campaign manager 1120 which uses an SMS server to respond to the user's phone call 1125 with a link, or button, allowing them to complete a transaction, view a website or web page, or perform some other CTA 1130. Alternatively, a call may be redirected to a redirect server, which handles the phone redirection and SMS response containing the CTA, rather than the call being directed to the adaptive campaign manager. Further, it is possible to have the adaptive campaign manager operate as part of such a redirect server in yet another implementation. The customer may then call or tap on the link, button, or other CTA, which is tracked for analytics 1135 due to the fact that it is a CTA served directly by the ad campaign and which knows the phone number and accompanying data of the user, and allows the customer to complete the transaction as designed 1140.

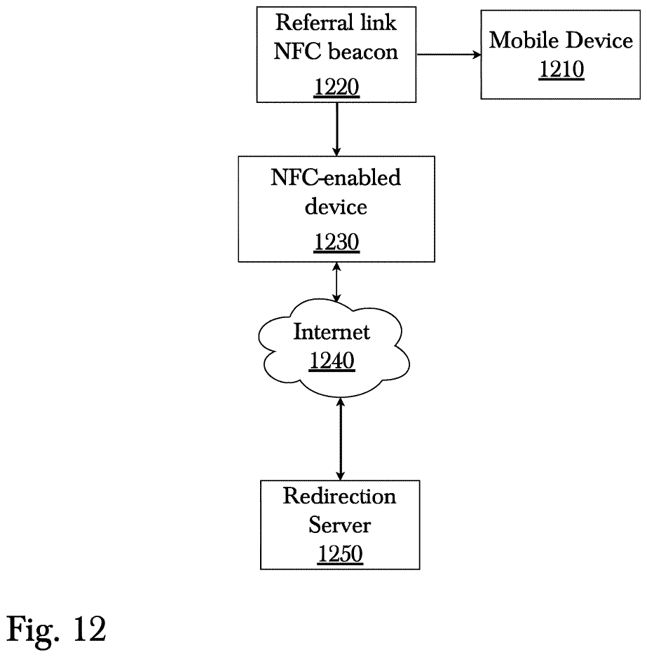

FIG. 12 is a system diagram illustrating an NFC device broadcasting a referral link programmed into it, according to an aspect. A mobile device 1210 such as a smartphone, operates an operating system (OS) such as ANDROID™ or IOS™, although other OSs are possible. A mobile device may be a tablet or other device aside from a smartphone as well. Mobile devices of these sorts may run software applications, commonly referred to as an “app” (short for “application”), for a variety of purposes, and a mobile device 1210 may or may not contain communications other than or instead of cellular communications, including wireless internet capabilities, BLUETOOTH™ communications, and NFC capabilities. With a mobile device 1210 possessing such NFC capabilities, a referral link NFC beacon 1220 may communicate with such a mobile device 1210, the beacon 1220 being operated as part of an NFC-enabled device 1230. Such a device may be any number of possible objects including a home appliance such as a toaster, refrigerator, blender, oven, television, laptop computer, or something else such as a coffee mug, piece of furniture such as a table or bed, or any number of other objects that may have NFC technology on or inside of them. A referral link that may be broadcast by such a beacon 1220 would refer over the internet 1240 to a redirection server 1250, for the purpose of forwarding a customer a page to buy a similar product, the same product, view a manufacturer's website, or any number of other possible CTA's that may be desired.

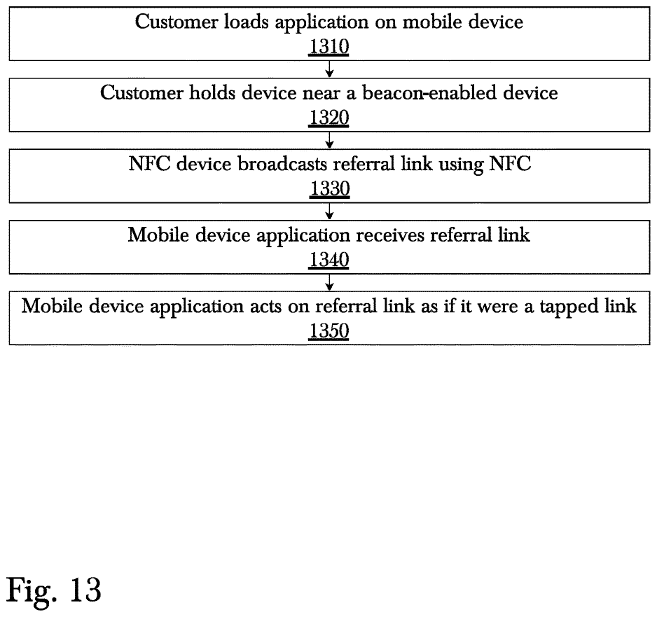

FIG. 13 is a method diagram illustrating methods for a NFC device to broadcast a referral link programmed into it and a mobile device act on the received link, according to an aspect. First a customer may load an appropriate application on their mobile device 1310, the application or “app” being one which specifically communicates over NFC beacons to find referral links to initiate a call from a user's mobile device, at which point the call is redirected appropriately to send an SMS message to a user to complete a CTA. After initiating the application on a mobile device 1310, a customer may hold the mobile device near a beacon-enabled device 1320, the NFC beacon-enabled device broadcasting a referral link using NFC 1330 which may be received by a mobile device application 1340. Upon reception in the mobile device application, the mobile device application acts on the referral link as if it were a tapped link 1350 as shown in other embodiments, whereby the tapped link results in a phone call being initiated by a mobile device, the phone call being captured and redirected and responded to with an SMS message containing the CTA for a user to complete. A CTA may be a link to an online retail portal, a referral to a producer's website or directions to a store, or something else of use to the hosting business.

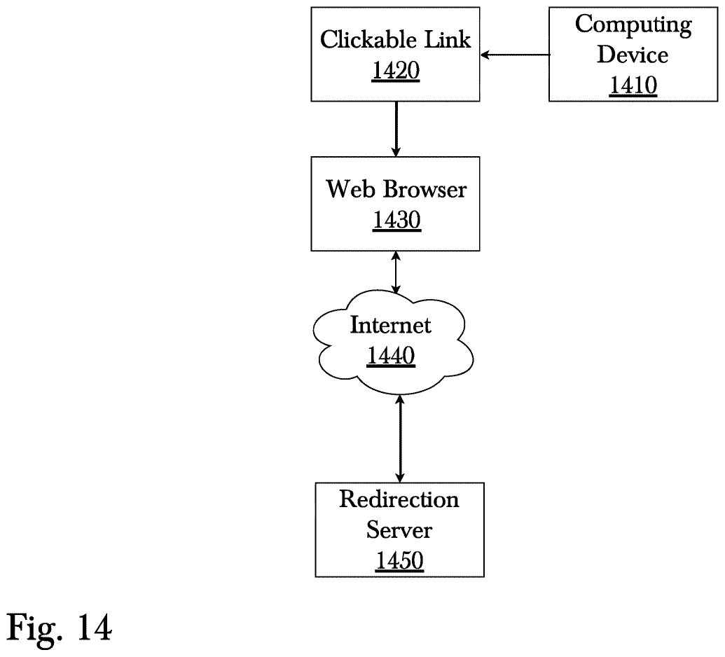

FIG. 14 is a system diagram illustrating a computer device such as a laptop, desktop, or mobile phone, utilizing a referral link, for the purposes of a mobile device detection system to differentiate between mobile phones and non-mobile devices, such as personal computers, according to a preferred aspect. A computing device 1410 such as a smartphone, personal computer, tablet, or other computing device, operates an operating system (OS) such as ANDROID™, IOS™, WINDOWS™, MAC OS™, or some other operating system. Computing devices of these sorts may run software applications, commonly referred to as an “app” (short for “application”), for a variety of purposes, and a computing device 1410 may or may not contain communications capabilities including cellular communications, wired and wireless internet capabilities, BLUETOOTH™ communications, and NFC capabilities. With a computing device 1410, a customer may access a clickable link 1420 through a web browser 1430. Such a browser may be any number of possible applications including INTERNET EXPLORER™, MICROSOFT EDGE™, GOOGLE CHROME™, SAFARI™, or other web browsers, including mobile web browsers for mobile devices or devices operating mobile operating systems such as ANDROID™. A referral link 1420 that may be tapped or clicked with such a browser 1430 would refer over the internet 1440 to a redirection server 1450, for the purpose of forwarding a customer a page to buy a similar product, the same product, view a manufacturer's website, or any number of other possible CTA's that may be desired. The purpose of such a system is for a redirection server 1450 to determine, based on the type of browser request sent when the link 1420 is clicked, whether a customer device is a mobile device such as a smartphone or tablet, or if it is a non-mobile device such as a laptop or desktop computer.

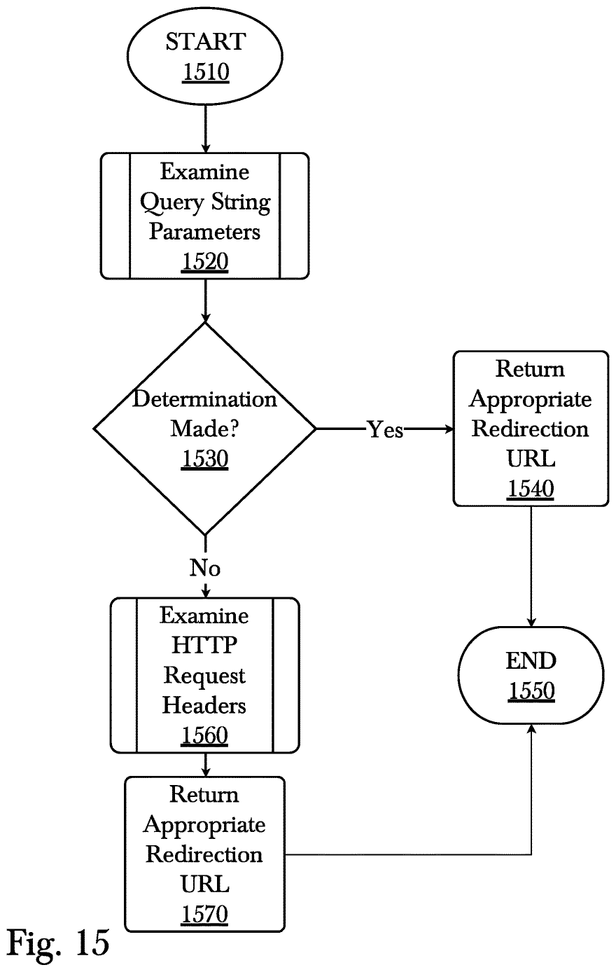

FIG. 15 is a flowchart illustrating steps for a computer device such as a laptop, desktop, or mobile phone, utilizing a referral link, being categorized so that an appropriate referral link is sent to the requesting device, according to a preferred aspect. The flowchart enters 1510 when a user clicks on a referral link, from any device, on a web browser, causing a redirection server to examine query string parameters 1520. A determination may be made 1530, as to what manner of device—a mobile device or something else, such as a personal computer—has sent the request. If a determination has already been made, the appropriate redirection URL is returned 1540, and the flowchart ends 1550. If a determination has not been made however, the HTTP headers are examined 1560 to determine the user-agent or similar field of an HTTP request from a customer's device. A user-agent field is frequently present in an HTTP request header indicating the product and version, and platform, used to make the request, and based on the result, the appropriate redirection URL is returned 1570, before the flowchart ends 1550.

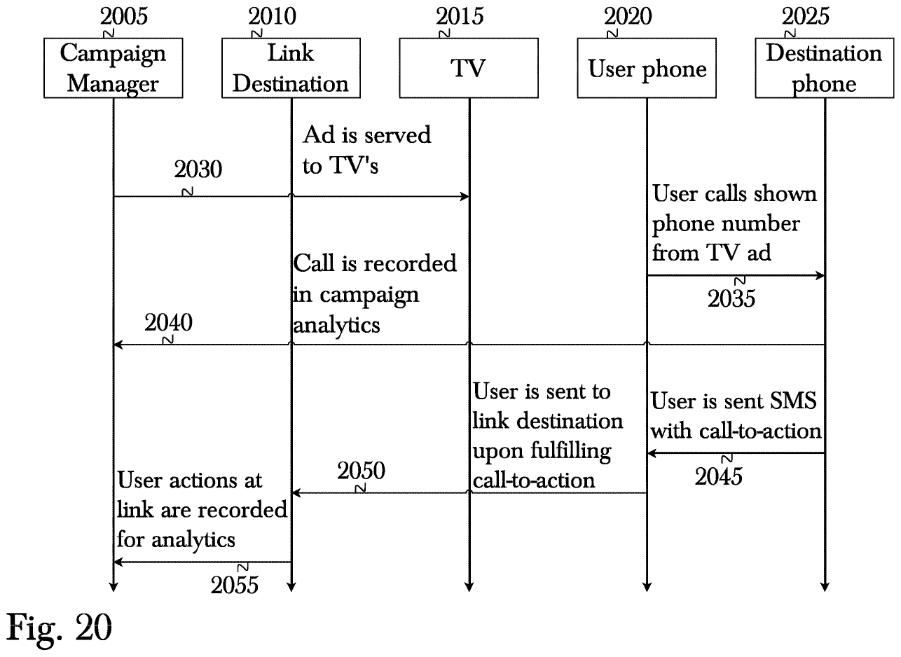

FIG. 20 is a message flow diagram illustrating the flow of messages and operations from a campaign manager specifying and serving a television advertisement, to a user completing all interactions with that advertisement and all intermediate steps, according to an embodiment. A campaign manager 2005, which may be an adaptive campaign manager or a specialized campaign manager for television advertisements depending on the implementation, communicates over a network which may be the Internet, a PSTN, television networks, or some other network capable of transmitting to a television set 2015, to serve an advertisement 2030. The advertisement may be instead served to a television network manager or provider, which then may serve the advertisement to individual television sets 2030. A user who sees the television 2015 advertisement may use a mobile phone 2020 to call a number shown on the screen, for instance a phone number shown for ordering a specific computer part that a user may want. A user may call this number 2035 and be sent to a destination phone number 2025, whereupon the call is recorded in campaign analytics that are sent to the campaign manager 2040, 2005 over either the Internet or some other appropriate network for delivering data across devices. An alternative embodiment of this process may be to have the campaign manager be the destination phone number itself, effectively behaving as a redirect server by recording the received call on its own datastore and then cancelling or otherwise handling the incoming call, and responding with an SMS instead, redirecting the user. After a user calls a destination phone number 2035 and the analytics are recorded 2040, a response is provided to a user in the form of an SMS message 2045, which may communicate with the user's phone or with an application provided on their phone to provide a CTA. Such a CTA may be a tappable or clickable link, button, referral, or other similar CTA fulfillment method for phones, should other or newer methods arise. The CTA is such an implementation that the user, upon completion of the CTA, is directed to a link destination 2010 over a network such as the Internet 2050, for example to complete purchase of a product or take a survey. A combination of the user's access of the destination link 2010 and their actions upon reaching the link (such as completion of a purchase, or not) may be recorded in analytics 2055. For example, using this method, a user may see an advertisement on a TV screen, call the phone number, have the call be canceled and responded to with an SMS that contains a tappable or clickable or otherwise actionable link to a product landing page, and may then purchase the product on their mobile device right away depending on the user interface of the destination link, while having their initial call and their action with the CTA contained in the SMS, as well as possibly their action on the destination such as a landing page itself, all recorded in analytics. In this way, a more complete customer analytics profile may be formed.

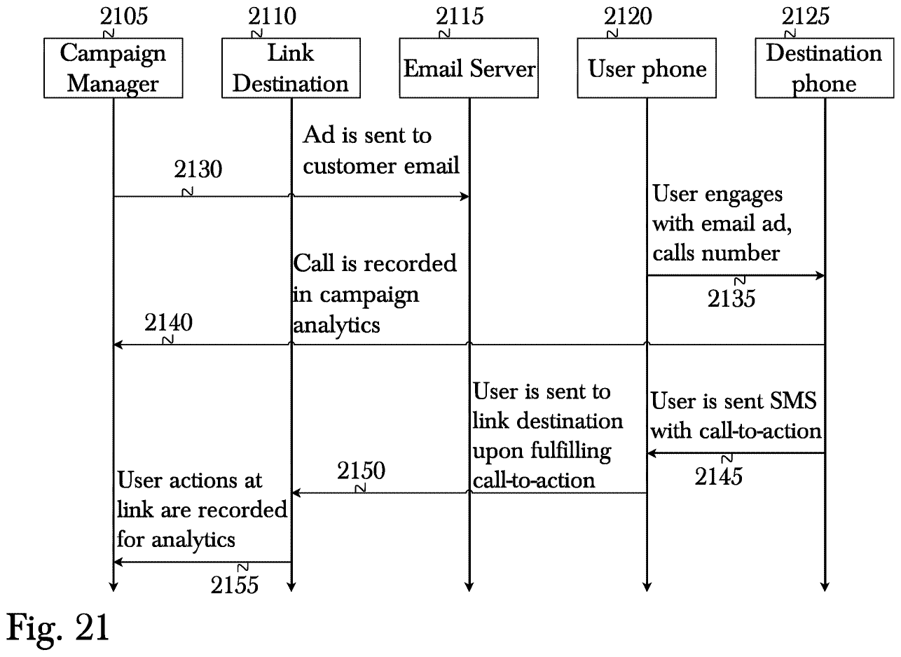

FIG. 21 is a message flow diagram illustrating the flow of messages and operations from a campaign manager specifying and serving an email-based advertisement, to a user completing all interactions with that advertisement and all intermediate steps, according to an embodiment. A campaign manager 2105, which may be an adaptive campaign manager or a specialized campaign manager for the purposes of sending emails and email advertisements depending on the implementation, communicates over a network which may be the Internet, a PSTN, or some other network capable of sending emails to customer emails hosted by any common email service providers such as GOOGLE™ or YAHOO™ 2115, to serve an advertisement 2130. This advertisement may be in the form of a subscription newsletter, may be solicited or unsolicited as allowed by law, or any other sort of email-based advertisement. The advertisement may be instead served to a service or network which manages and executes such emails which may be mass-sent rather than individually sent, and which then may serve the advertisement to a customer's email address 2130. A user who sees the email advertisement may use a mobile phone 2120 to call a number shown on the screen or tap an image or button that uses the phone to call a phone number, for instance a phone number shown for ordering a specific computer part that a user may want, or a specific service in their area. A user may call this number 2135 and be sent to a destination phone number 2125, whereupon the call is recorded in campaign analytics that are sent to the campaign manager 2140, 2105 over either the Internet or some other appropriate network for delivering data across devices. An alternative embodiment of this process may be to have the campaign manager be the destination phone number itself, effectively behaving as a redirect server by recording the received call on its own datastore and then cancelling or otherwise handling the incoming call, and responding with an SMS instead, redirecting the user. After a user calls a destination phone number 2135 and the analytics are recorded 2140, a response is provided to a user in the form of an SMS message 2145, which may communicate with the user's phone or with an application provided on their phone to provide a CTA. Such a CTA may be a tappable or clickable link, button, referral, or other similar CTA fulfillment method for phones, should other or newer methods arise. The CTA is such an implementation that the user, upon completion of the CTA, is directed to a link destination 2110 over a network such as the Internet 2150, for example to complete purchase of a product or take a survey. A combination of the user's access of the destination link 2110 and their actions upon reaching the link (such as completion of a purchase, or not) may be recorded in analytics 2155. For example, using this method, a user may register with a newsletter or subscribe to an organization's promotional advertisements via email, and see an advertisement on a received email for a car part on sale, call the phone number, have the call be canceled and responded to with an automated SMS that contains a tappable or clickable or otherwise actionable link to a product landing page, and may then purchase the product on their mobile device right away depending on the user interface of the destination link, while having their initial call and their action with the CTA contained in the SMS, as well as possibly their action on the destination such as a landing page itself, all recorded in analytics. In this way, a more complete customer analytics profile may be formed.

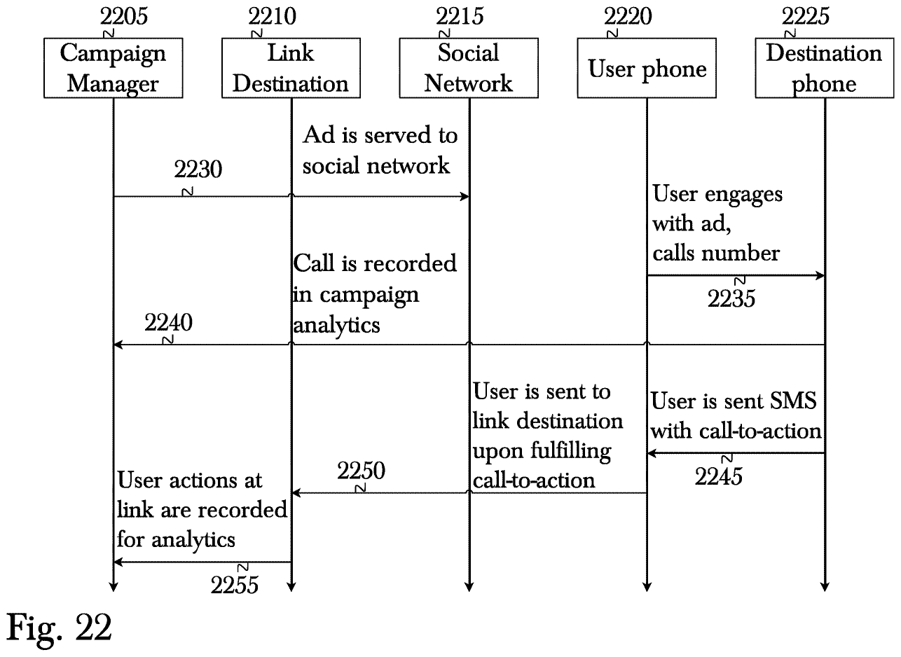

FIG. 22 is a message flow diagram illustrating the flow of messages and operations from a campaign manager specifying and serving a social media advertisement, to a user completing all interactions with that advertisement and all intermediate steps, according to an embodiment. A campaign manager 2205, which may be an adaptive campaign manager or a specialized campaign manager for the purposes of specifying and purchasing social media advertisement space and time depending on the implementation, communicates over a network which may be the Internet, a PSTN, or some other network capable of communicating with social networks such as FACEBOOK™ or MYSPACE™ but which may be another social network that allows any advertisements to be procured on the platform 2215, to serve an advertisement 2230. This advertisement may be in the form of a video embedded in a user's social network feed, may be solicited or unsolicited as allowed by law, may be utilized with user data such as purchase history or any other available data if applicable, or any other sort of social media advertisement as may be or become common in the art. A user who sees the advertisement may use a mobile phone 2220 to tap or click the advertisement which may use the phone's functionality to call a phone number, or manually call a number shown on the screen, for instance a phone number shown for ordering a specific piece of furniture that a user may want, or a specific service provided in their area. A user may call this number 2235 and be sent to a destination phone number 2225, whereupon the call is recorded in campaign analytics that are sent to the campaign manager 2240, 2205 over either the Internet or some other appropriate network for delivering data across devices. An alternative embodiment of this process may be to have the campaign manager be the destination phone number itself, effectively behaving as a redirect server by recording the received call on its own datastore and then cancelling or otherwise handling the incoming call, and responding with an SMS instead, redirecting the user. After a user calls a destination phone number 2235 and the analytics are recorded 2240, a response is provided to a user in the form of an SMS message 2245, which may communicate with the user's phone or with an application provided on their phone to provide a CTA. Such a CTA may be a tappable or clickable link, button, referral, or other similar CTA fulfillment method for phones, should other or newer methods arise. The CTA is such an implementation that the user, upon completion of the CTA, is directed to a link destination 2210 over a network such as the Internet 2250, for example to complete purchase of a product or take a survey. A combination of the user's access of the destination link 2210 and their actions upon reaching the link (such as completion of a purchase, or not) may be recorded in analytics 2255. For example, using this method, a user may perform online shopping such as with (but not limited to) AMAZON™, whereby information regarding their shopping habits is recorded, and a social media advertisement is specified to target users with similar shopping history, such as those who have purchased coffee tables recently. A user may see the advertisement on their preferred social network, call the phone number, have the call be canceled and responded to with an automated SMS that contains a tappable or clickable or otherwise actionable link to a product landing page, and may then purchase the product on their mobile device right away depending on the user interface of the destination link, while having their initial call and their action with the CTA contained in the SMS, as well as possibly their action on the destination such as a landing page itself, all recorded in analytics. In this way, a more complete customer analytics profile may be formed.

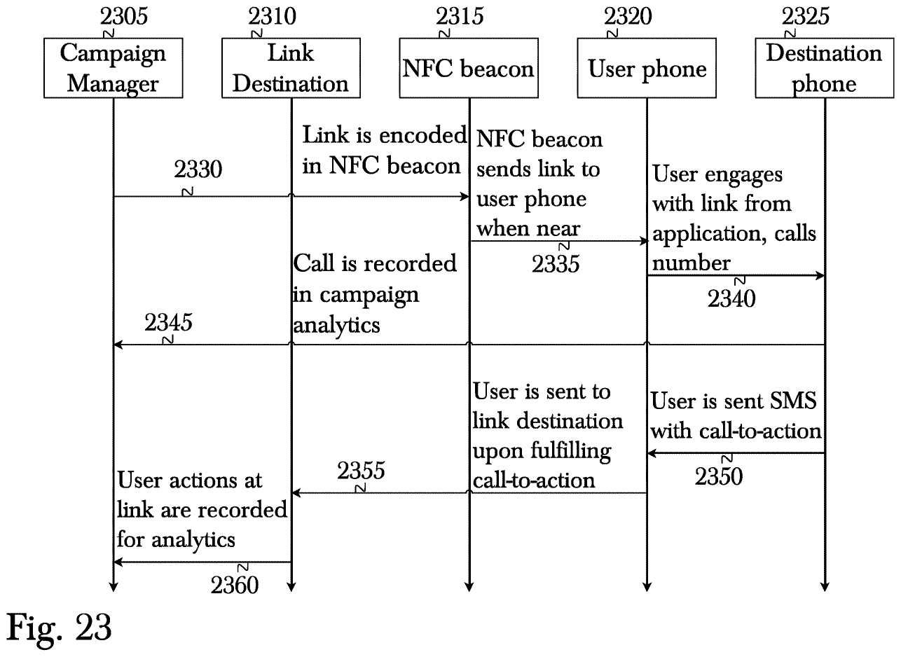

FIG. 23 is a message flow diagram illustrating the flow of messages and operations from a campaign manager specifying and embedding a referral link in an NFC beacon, to a user completing all interactions with that link and all intermediate steps, according to an embodiment. A campaign manager 2305, which may be an adaptive campaign manager or a specialized campaign manager for the purposes of specifying a link destination 2310 to direct users to, and embedding this link in an NFC beacon 2315 such as a sticker or small device on or inside of, or operating as part of, a product 2330, which may be utilized by a customer to receive the programmed link destination 2310 for a variety of possible purposes. A user who is delivered the link or advertisement by an NFC beacon 2315 may use a mobile phone 2320 to tap or click the advertisement which may use the phone's functionality to call a phone number, or manually call a number shown on the screen, for instance a phone number shown for ordering a specific piece of furniture that a user may want, or a specific service provided in their area. An NFC beacon 2315 may deliver the notification 2335, link, or similar, via a specialized application residing on and operating on the user's phone 2320, according to some embodiments. A user may call a shown number or utilize a shown button or call link 2340 and be sent to a destination phone number 2325, whereupon the call is recorded in campaign analytics that are sent to the campaign manager 2345, 2305 over either the Internet or some other appropriate network for delivering data across devices. An alternative embodiment of this process may be to have the campaign manager be the destination phone number itself, effectively behaving as a redirect server by recording the received call on its own datastore and then cancelling or otherwise handling the incoming call, and responding with an SMS instead, redirecting the user. After a user calls a destination phone number 2340 and the analytics are recorded 2345, a response is provided to a user in the form of an SMS message 2350, which may communicate with the user's phone or with an application provided on their phone to provide a CTA. Such a CTA may be a tappable or clickable link, button, referral, or other similar CTA fulfillment method for phones, should other or newer methods arise. The CTA is such an implementation that the user, upon completion of the CTA, is directed to a link destination 2310 over a network such as the Internet 2355, for example to complete purchase of a product or take a survey. A combination of the user's access of the destination link 2310 and their actions upon reaching the link (such as completion of a purchase, or not) may be recorded in analytics 2360. For example, using this method, a user may have a product in their home built with this method, that has an NFC beacon on or inside of it, and the user wishes to know more about the product, or purchase another or a similar product, or view the manufacturer's website, or anything similar. The user may simply start an application for this purpose if necessary, and regardless of whether a specialized application is utilized, move the phone close to the NFC beacon location, receiving data from the NFC beacon which could be the form of a link or a phone number to call. A user may see a phone number on the shown website, or perhaps be delivered a phone number to call directly from the NFC beacon, call the phone number, have the call be canceled and be responded to with an automated SMS that contains a tappable or clickable or otherwise actionable link to a product landing page, and may then purchase the product on their mobile device right away depending on the user interface of the destination link, while having their initial call and their action with the CTA contained in the SMS, as well as possibly their action on the destination such as a landing page itself, all recorded in analytics. In this way, a more complete customer analytics profile may be formed.

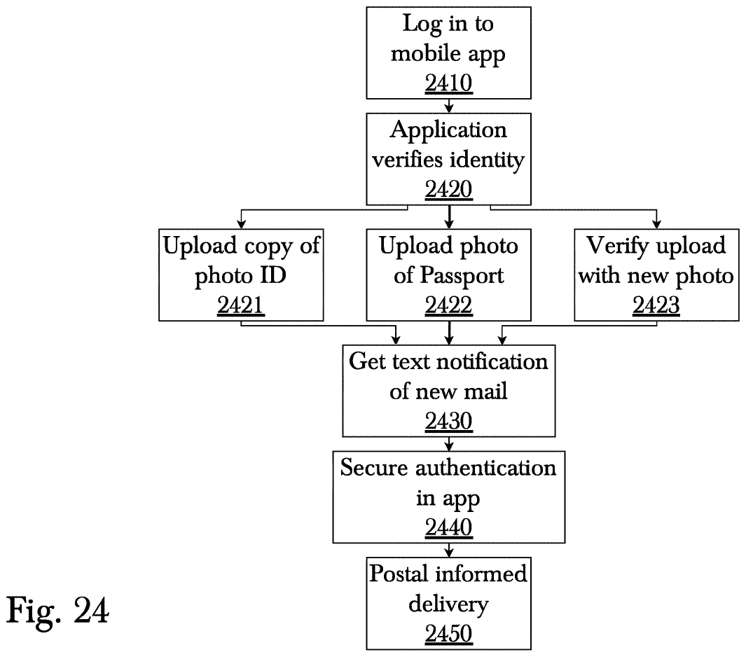

FIG. 24 is a method diagram illustrating the function of an application capable of providing enhanced identity verification, according to an embodiment. A user may utilize on a mobile device, such as a mobile phone, an application or “app” that enables enhanced identity verification for purposes including detailed shipping updates such as for products purchased, allowing a user to sign up and log in to the mobile app 2410, over the Internet or another network suitable for such. User login information may be stored off-site or on-site depending on the application implementation, whereby information may be stored using a datastore including SQL, NoSQL such as MONGODB™, or other forms of data storage. Logging into an application is an understood procedure by which a user provides a recognized username and password, whether the username is user-defined or some identifier such as their email address, to confirm user identity. The application then verifies the identity 2420 of a user, through a process utilizing an uploaded copy of photo ID 2421 which may be their driver's license or state-issued photo identification, a photocopy of their passport 2422 including their photo in their passport, and an of a new facial photo (sometimes referred to as a “selfie”) 2423. Using machine learning and image parsing, the authentication can make use of the information on the driver's license or state ID, as well as look for signs of the photo being doctored, in addition to checking for signs of the passport image being doctored, determine if the passport template matches the official template of the country of origin, check version numbers against the standards available, ensure letters and numbers all align and do not appear doctored, check font size and type, validate the attributes on the document along with the state ID or driver's license, and compare the images along with the “selfie” or new self-photograph of the face, to attempt to ensure the identity of the user. When the user has new mail arriving, they may get a text notification of new mail 2430 through the application, and if their identity is securely identified through the app 2440 they may view further information about their package through the USPS™ INFORMED DELIVERY™ system 2450, or a similar system by which citizens may receive advance notice and data about mail coming to them before it actually arrives, for denizens of other countries.

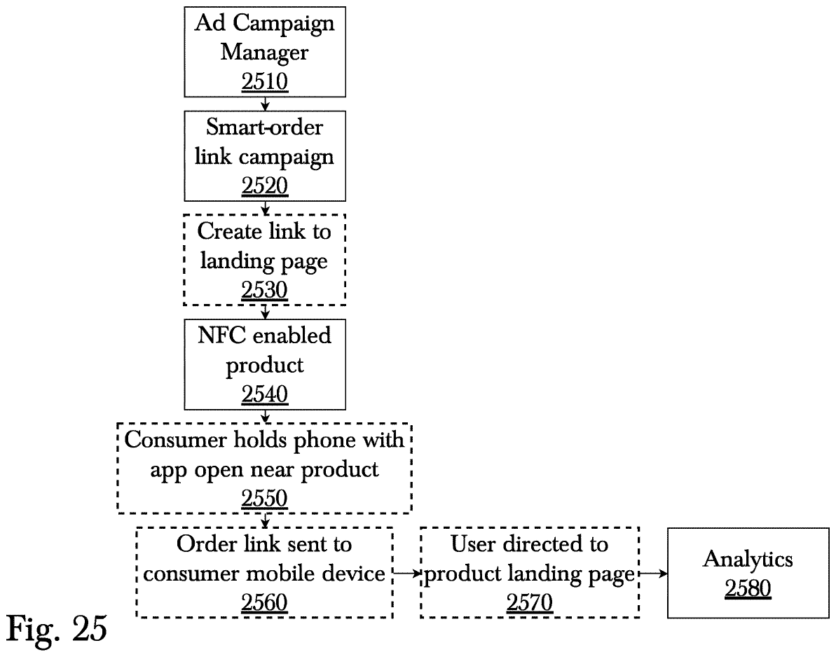

FIG. 25 is a diagram illustrating the function of an NFC beacon smart order link, according to an embodiment. An ad campaign manager 2510 is present as either a computer system or service operating on a computer system, and which may be a multiplatform adaptive ad campaign manager or which may be a more specialized service or computing system, capable of allowing a user to specify and create a smart-order link campaign 2520. A smart-order link campaign is an advertisement campaign wherein a smart-order link is generated for a product ordering page or landing page 2530, for instance a link to an online retailer's page for a product or a class of products or similar, and which may be a dynamic link which is capable of changing based on specified parameters from the campaign administrator. For example, URL's that refer to different pages, or which pass different data to the page such as through URL parameters, depending on parameters such as customer region, region of the product, or other possible selections. Whether or not the smart-order link is dynamic or not, the link is sent to an NFC-enabled product 2540, or embedded in a sticker or other attachable device for the product, so that the product can broadcast the NFC data and smart-order link to NFC receivers. This may be an adhesive sticker, an embedded chip or component in a product, or any other implementation that may successfully allow an NFC signal to be broadcast from the product effectively. When this is completed, and the product is shipped, a consumer may hold their phone or other mobile device with a receiver app operating, near the product 2550, so that the smart-order link is sent to the consumer mobile device 2560. Upon receiving the smart-order link, a customer may then be directed to product landing page 2570, where they may purchase or learn more about a product, or alternatively they may be directed to another URL for information or services depending on the implementation of the system. The smart-order link destination may be monitored for user access to provide basic analytics 2580 capabilities to the system operator as well, including data about the specific product that broadcast the link over NFC, the customer device or identity if available, and any available location data if available, though other possibilities for analytics with this system exist and may be extended in some implementations.

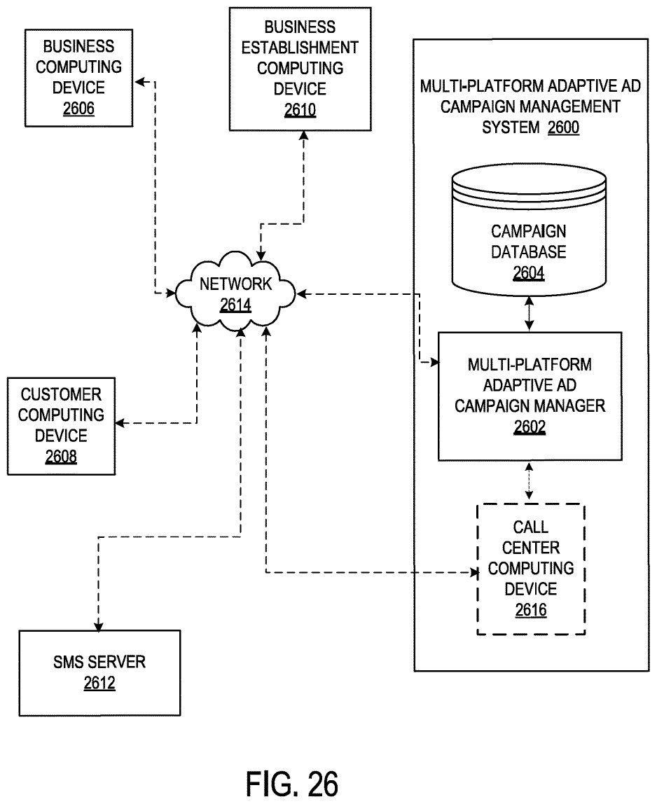

Referring to FIG. 26, an example of an environment for use with an embodiment of an adaptive ad campaign management system 2600 is shown. The adaptive ad campaign management system 2600 includes an adaptive ad campaign manager 2602 and a campaign database 2604. The adaptive ad campaign management system 2600 is configured to be communicatively coupled to at least one business computing device 2606, at least one customer computing device 2608, at least one business establishment computing device 2610, and an SMS server 2612 via a network 2614. In an embodiment, the adaptive ad campaign management system 2600 includes at least one call center computing device 2616.

In an embodiment, the adaptive ad campaign manager 2602, includes software operating on a computing device. Examples of computing devices include, but are not limited to, a personal computer and a workstation computer. The adaptive ad campaign manager 2602 is configured to execute the software, receive user inputs, and utilize a network adapter. The operating system of the computing device may be one of many options available to consumers and businesses.

The campaign database 2604 may take the form of a managed or unmanaged database, document-oriented database system, or a SQL database. Examples of types of database software that may operate include MYSQL™, ORACLE DATABASE™, MONGODB™, and others. The campaign database 2604 may exist as a distinct physical device or be operating on another computing device that may perform other functions aside from operating, hosting and serving the campaign database 2604. If the campaign database 2604 is a distinct physical device, the database may be connected over a LAN or WAN, the Internet, a direct physical connection to another device, or some other network connection. The campaign database 2604 may be a centralized database system. The campaign database 2604 may be a distributed database system.

Examples of customer computing devices 2608 include, but are not limited to, a mobile computing device, a personal computer, a cellular phone, a tablet, a smartphone, a non-smartphone cellular phone, a laptop, and a personal digital assistant. The customer computing devices 2608 are configured to be communicatively coupled to the adaptive ad campaign manager 2602 via the network 2614. In an embodiment, the customer computing devices 2608 are configured to transmit/receive text messages. In an embodiment, the customer computing devices 2608 are configured to transmit/receive phone calls. In an embodiment, the customer computing devices 2608 are configured to both transmit/receive text messages and transmit/receive phone calls.

Examples of business computing devices 2606 include, but are not limited to, a mobile computing device, a workstation, and a personal computer. The business computing devices 2606 are configured to be communicatively coupled to the adaptive ad campaign management system 2600. Examples of business establishment computing devices 2610 include, but are not limited to, a mobile computing device, a workstation, and a personal computer. The business establishment computing devices 2610 are configured to be communicatively coupled to the adaptive ad campaign management system 2600. Examples of call center computing devices 2616 include, but are not limited to, a mobile computing device, a workstation, and a personal computer. The call center computing devices 2616 are configured to be communicatively coupled to the adaptive ad campaign manager 2602. The call center computing devices 2616 are configured to receive phone calls and text messages.

In an embodiment, SMS texts are stored at the SMS server 2612. The adaptive ad campaign manager 2602 retrieves SMS texts from the SMS server 2612 to generate responses for transmission to customer computing devices 2608 in a manner that is described in further detail below. In an embodiment, the SMS server 2612 is a third-party server. In an embodiment the SMS server 2612 is a component of the adaptive ad campaign management system 2600.

The network 2614 may include one or more of the following types of networks. The adaptive ad campaign management system 2600 may be configured to be communicatively coupled to at least one TV network for the purpose of being able to serve televised advertisements to customer computing devices 2608, a PSTN for the purpose of receiving phone calls and sending and receiving SMS messages from customer computing devices 2608 and from third-party SMS servers 2612, and the Internet so as to serve advertisements on social media platforms on a social media server and serve advertisements via email, websites or individual web pages, or through applications, to the customer computing devices 2608.

The manner of the advertisements and data sent from the adaptive ad campaign manager 2604 to the network 2614 may include audio data, visual data such as video or images, textual data, recipient data, regional specifications, and other common data for advertisements in applications, online, over TV, and over email. Advertisements may be sent to, and reached by, the customer computing devices 2608 through the Internet via email, social networks, or internet browsing. The functionality of a TV may be utilized by the customer computing devices 2608 and all functionalities—TV viewership, phone call placement, internet browsing, email viewing, and social network access—may be accomplished by the customer computing devices 2608 over the Internet, or with the Internet and PSTN.

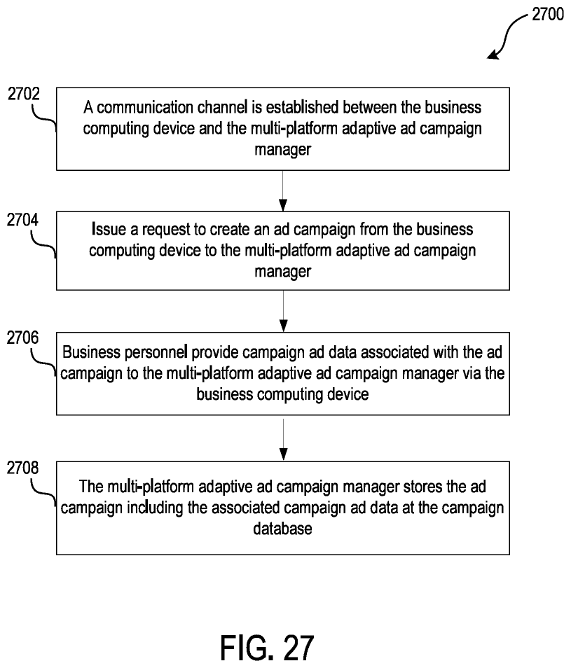

Referring to FIG. 27, a flow chart representation of a method 2700 of using an embodiment of an adaptive ad campaign management system 2600 to create an ad campaign is shown. At 2702 business personnel at a business use the business computing device 2606 to establish a communication channel with the adaptive ad campaign manager 2602. In an embodiment, the business is in the automotive industry. In alternative embodiments, the business may be associated with different industries.

At 2704, the business personnel issues a request to the adaptive ad campaign manager 2602 to create an ad campaign via the business computing device 2606. In an embodiment, the ad campaign is an automotive ad campaign. In alternative embodiments, the ad campaign may be associated with different industries.

The business personnel provide campaign ad data associated with the ad campaign to the adaptive ad campaign manager 2602 via the business computing device 2606 at 2706. The business may have one or more business establishments. The business establishments maintain inventories of the products offered for sale by the business. For example, the automotive industry business may have multiple automobile dealerships.

In an embodiment, the ad campaign data includes one or more of ad campaign details, business establishment specific product inventories, and business establishment specific data. Examples of ad campaign details include, but are not limited to, an ad campaign start date, an ad campaign end date, and ad campaign configuration details. An example of business establishment specific product inventory includes, but is not limited to, identification data associated with specific products available in the product inventory at the business establishment.

In an embodiment, the business establishment is an automobile dealership and the business establishment specific product inventory includes automobile dealership specific product inventory. The automobile dealership specific automobile inventory includes vehicle details pages (VDP) identification data associated with automobiles available for sale at the automobile dealership, vehicle identification data associated with specific automobiles available for sale at the automobile dealership, and VDPs directed to specific types of automobiles available for sale at the automobile dealership. The VDP is an electronic ad for automobiles that includes one or more of the brand of the automobile, advertising slogan(s) associated with the brand of the automobile, sales offers, financing offers, an image of the automobile, and a communication initiator. The function of the communication initiator will be described in greater detail below.

Examples of the business establishment specific data include, but are not limited to, a toll-free number and an email address for the business establishment. In an embodiment, the business establishment is an automobile dealership and the business establishment specific data is automobile dealership specific data. The automobile dealership specific data includes one or more of a toll-free number for the automobile dealership, the email address for the automobile dealership, and the BDC number for the automobile dealership.

At 2708, the adaptive ad campaign manager 2602 stores the ad campaign including the associated ad campaign data at the ad campaign database 2604. In an embodiment, the adaptive ad campaign manager 2602 stores the automotive ad campaign including the associated the automobile ad campaign data at the campaign database 2604.

The adaptive ad campaign manager 2602 manages the ad campaign in accordance with the ad campaign data provided by the business. In an embodiment, the ad campaign data specifies the different media platforms that will be used to broadcast the ad campaign. The adaptive ad campaign manager 2602 is configured to broadcast the ad campaign via a number of different media platforms. Examples of the different media platforms include, but are not limited to, a social media platform, an email platform, televised advertisement platform, and other types of Internet based platforms.

As mentioned above, the ad campaign data for an ad campaign includes a product description page for the advertised product. The adaptive ad campaign manager 2602 is configured to transmit the product description page via one or more of a number of different media platforms for display on one or more customer computing devices 2608. In an embodiment, the ad campaign is an automotive ad campaign and the product description page is a VDP. The product description page includes a communication initiator. A customer is provided with the option of expressing an interest in the product advertised in the product description page by seeking to contact a business establishment that sells the advertised product via the adaptive ad campaign management system 2600 by activating the communication initiator. Upon the activation of the communication initiator by the customer at the customer computing device 2608, the adaptive ad campaign management system 2600 coordinates the engagement between the customer and a business establishment. In an embodiment, the adaptive ad campaign management system 2600 tracks and coordinates the collection of analytics based on interactions between the customer and the business establishment.

In an embodiment, the communication initiator is a call initiator. Upon activation of the call initiator by the customer via the customer computing device 2608, the customer computing device 2608 places a call associated with the product description page to the adaptive ad campaign management system 2600. In an embodiment, the communication initiator is a text message initiator. Upon activation of the text message initiator by the customer via the customer computing device 2608, the customer computing device 2608 sends a text message associated with the product description page to the adaptive ad campaign management system 2600.

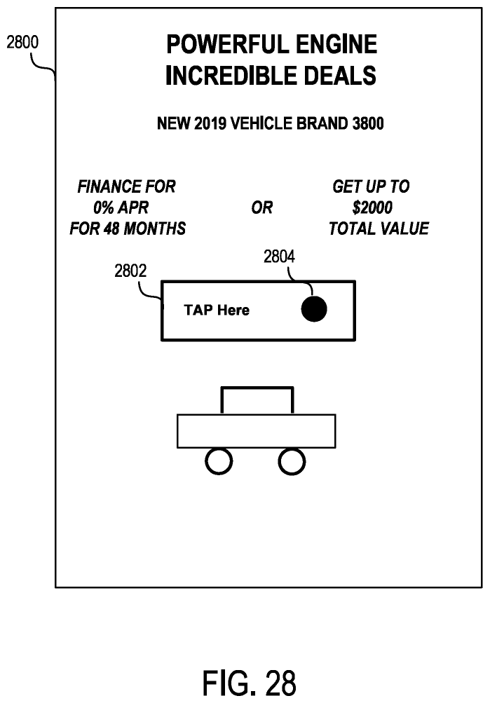

Referring to FIG. 28, an illustration of an example of a VDP 2800 generated by the adaptive ad campaign manager 2602 for display on a customer computing device 2608 including an example of a communication initiator 2802 is shown. The example communication initiator 2802 includes a generic tap button 2804. When the VDP 2800 is displayed on the customer computing device 2608, the customer is provided with the option engaging with a business establishment where the advertised product is available for sale. The customer initiates the process by activating the communication initiator 2802. In the illustrated example, the customer initiates the process by “tapping” on the generic tap button 2804. In an embodiment, upon the activation of the communication initiator 2802, the customer computing device 2608 initiates the process by placing a call to the adaptive ad campaign management system 2600. In an embodiment, upon the activation of the communication initiator 2802, the customer computing device 2608 initiates the process by sending a text message to the adaptive ad campaign management system 2600.

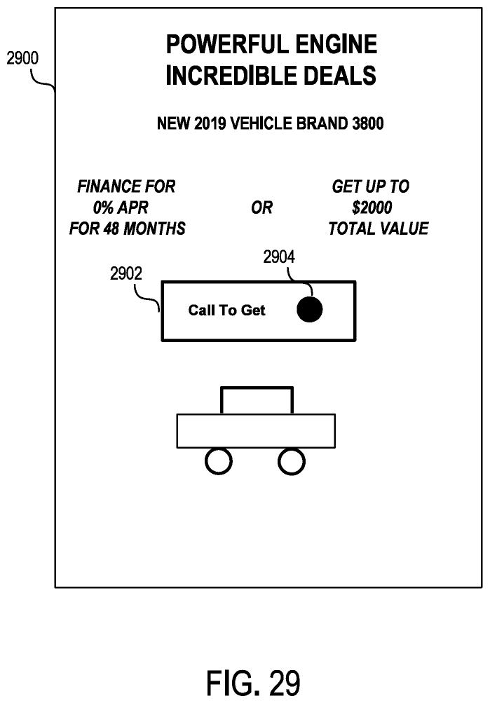

Referring to FIG. 29, an illustration of an example of a VDP 2900 generated by the adaptive ad campaign manager 2602 for display on a customer computing device 2608 including an example of a communication initiator 2902 is shown. In an embodiment, the communication initiator 2902 is a call initiator. The example communication initiator 2902 includes a call tap button 2904. When the VDP 2900 is displayed on the customer computing device 2608, the customer is provided with the option engaging with a business establishment where the advertised product is available for sale. The customer initiates the process by activating the communication initiator 2902. In the illustrated example, the customer initiates the process by “tapping” on the call tap button 2904. Upon the activation of the communication initiator 2902, the customer computing device 2608 initiates the process by placing a call to the adaptive ad campaign management system 2600.

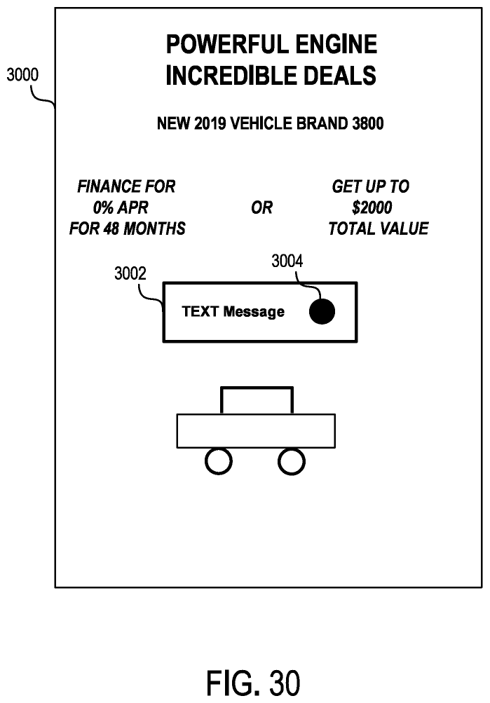

Referring to FIG. 30, an illustration of an example of a VDP 3000 generated by the adaptive ad campaign manager 2602 for display on a customer computing device 2608 including an example of a communication initiator 3002 is shown. In an embodiment, the communication initiator 3002 is a text message initiator. The example communication initiator 3002 includes a text message tap button 3004. When the VDP 3000 is displayed on the customer computing device 2608, the customer is provided with the option engaging with a business establishment where the advertised product is available for sale. The customer initiates the process by activating the communication initiator 3002. In the illustrated example, the customer initiates the process by “tapping” on the text message tap button 3004. Upon the activation of the communication initiator 3002, the customer computing device 2608 initiates the process by sending a text message to the adaptive ad campaign management system 2600.

In an embodiment, the product description page includes a communication initiator that through cycles through a generic tap button 2802, a call tap button 2902, and a text message tap button 3003. In this embodiment, the display of the generic tap button 2802 identifies the existence of a tap button. When the call tap button 2904 is displayed, “tapping” on the call tap button 2904 causes the customer computing device 2608 to place a call to the adaptive ad campaign management system 2600. When the text message tap button is displayed, “tapping” on the text message tap button 2904 causes the customer computing device 2608 to transmit a text message to the adaptive ad campaign management system 2600. In an embodiment, the generic tap button 2804, the call tap button 2904, and the text message tap button 3004 are sequentially displayed for a pre-defined period of time.

In an embodiment, the product description page included a communication initiator that through cycles through a call tap button 2902, and a text message tap button 3003. When the call tap button 2904 is displayed, the “tapping” on the call tap button 2904 causes the customer computing device 2608 to place a call to the adaptive ad campaign management system 2600. When the text message tap button is displayed, the “tapping” on the text message tap button 2904 causes the customer computing device 2608 to transmit a text message to the adaptive ad campaign management system 2600. In an embodiment, the call tap button 2904, and the text message tap button 3004 are each displayed for a pre-defined period of time.

In an embodiment, the call tap button 2904, and the text message tap button 3004 are simultaneously displayed in different areas of a product description page. While the generic tap button 2804, the call tap call button 2904, and the text message tap button 3002 have been illustrated as spherical buttons, one or more of the generic tap button 2804, the call tap button 2904, and the text message tap button 3002 may have a different shape.

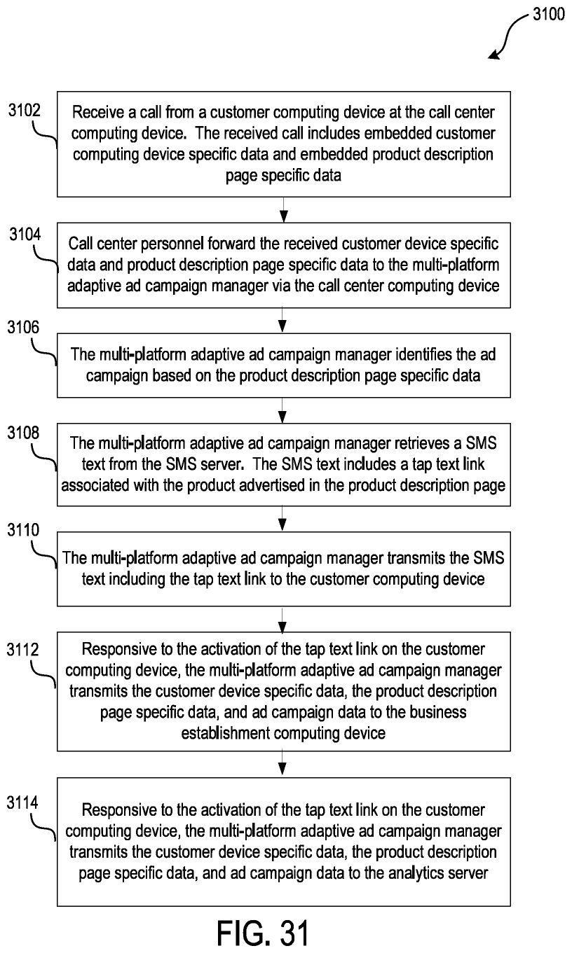

FIG. 31 is a flow chart representation of an example of a method 3100 of responding to an activation of a call initiator on a product description page at a customer computing device 2608 using an embodiment of an adaptive ad campaign management system 2600. The adaptive ad campaign management system 2600 transmits the product description page for display on one or more customer computing devices 2608 via one of the platforms designated by the business. In an embodiment, the product description page includes a call initiator. If the customer wishes to obtain additional information regarding a product advertised on the product description page displayed on the customer computing device 2608, the customer activates the call initiator. In an embodiment, the call initiator is a call tap button 2902 and the customer taps the call tap button to activate the call initiator. In an embodiment, the product description page is a VDP for an automobile.

The customer computing device 2608 responds to the activation of the call initiator by placing a call from the customer computing device 2608 to the adaptive ad campaign management system 2600. In an embodiment, the call is received at a call center computing device 2616 at a call center. In an embodiment, the call center computing device 2616 is a component of the adaptive ad campaign management system 2600. In an embodiment, the call center computing device 2616 is external to the adaptive ad campaign management system 2600.

At 3102, the call placed by the customer computing device 2608 is received at the call center computing device 2616. The received call includes embedded customer computing device specific data and product description page specific data. An example of the customer computing device specific data is a customer computing device phone number. Examples of the product description specific data include, but are not limited to, a product description page identifier identifying the product description page displayed on the customer computing device 2608 and a product description page link associated with the displayed product description page.

In an embodiment, the product description page specific data is VDP specific data associated with a VDP displayed on the customer computing device 2608. Examples of the VDP specific data include, but are not limited to, a VDP identifier identifying the VDP displayed on the customer computing device 2608 and a VDP link associated with the displayed VDP.

At 3104, call center personnel forward the received customer computing device specific data and product description page specific data to the adaptive ad campaign manager 2602 via the call center computing device 2616. In an embodiment, call center personnel forward the received customer computing device specific data and the VDP specific data to the adaptive ad campaign manager 2602 via the call center computing device 2616.

At 3106, the adaptive ad campaign manager 2602 identifies the ad campaign based on the received product description page specific data. In an embodiment, the adaptive ad campaign manager 2602 identifies the automotive campaign ad based on the received VDP specific data.

At 3108, the adaptive ad campaign manager 2602 retrieves a SMS text from the SMS server 2612. In an embodiment, a tap text link associated with the product advertised in the product description page is included in the SMS text. In an embodiment, the adaptive ad campaign manager 2602 adds the tap text link to the retrieved SMS text. At 3110, the adaptive ad campaign manager 2602 transmits the SMS text including the tap text link to the customer computing device 2608.

The SMS text message including the tap text link is received at the customer computing device 2608. Clicking on the tap text link enables a customer to complete a CTA associated with the product advertised on the product description page. Examples of CTA include, but are not limited to, engage in a transaction associated with the product advertised on the product description page and view a website associated with the product advertised on the product description page. In an embodiment, by clicking on the tap text link, the customer consents to allow the adaptive ad campaign management system 2600 to track and collect customer action data associated with the advertised product for analytics. In an embodiment, the customer is provided with an option to disable the tracking feature.

At 3112, responsive to the activation of the tap text link, the adaptive ad campaign manager 2602 transmits the customer computing device specific data, the product description page specific data, and ad campaign data to a business establishment computing device 2610 associated with a business establishment that is suited to enable the customer to purchase the advertised product. In an embodiment, the adaptive ad campaign manager 2602 identifies one or more of the city, state, and zip code associated with the customer based on the customer computing device specific data and transmits the identified one or more of the city, state, and zip code associated with the customer to the business establishment computing device 2610. The business establishment may use the received customer computing device specific data to contact the customer to discuss a potential sale of the advertised product with the customer. In an embodiment, the advertised product is an automobile and the business establishment is an automobile dealership.

At 3114, responsive to the activation of the tap text link, the adaptive ad campaign manager 2602 transmits the customer computing device specific data, product description page specific data, the ad campaign data, and all tracked customer actions to the analytics server thereby enabling the collection and analysis of ad campaign specific data.

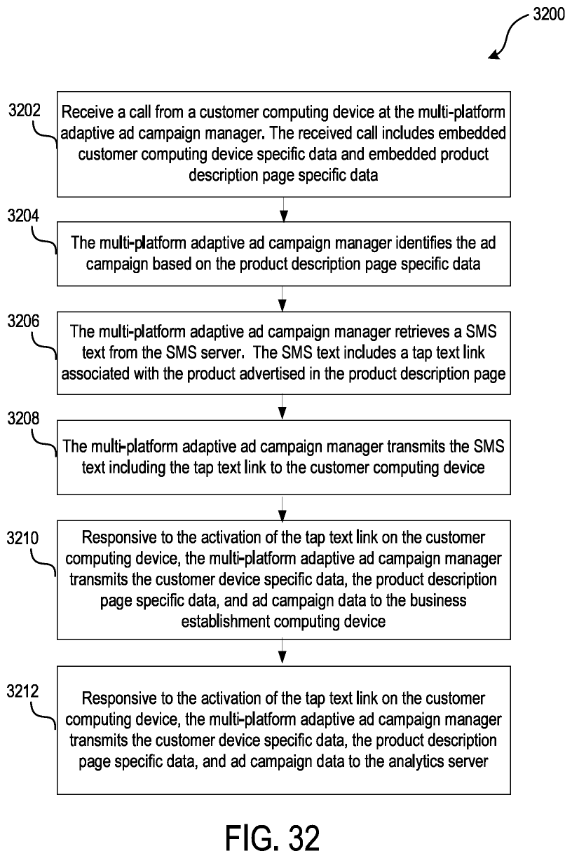

Referring to FIG. 32, a flow chart representation of an example of a method 3200 of responding to an activation of a call initiator on product description page displayed on a customer computing device 2608 using an embodiment of an adaptive ad campaign management system 2600 is shown. The adaptive ad campaign management system 2600 transmits the product description page for display on one or more customer computing devices 2608 via one of the platforms designated by the business. In an embodiment, the product description page includes a call initiator. If the customer wishes to obtain additional information regarding a product advertised on the product description page displayed on the customer computing device 2608, the customer activates the call initiator. In an embodiment, the call initiator is a call tap button 2902 and the customer taps the call tap button to activate the call initiator. In an embodiment, the product description page is a VDP for an automobile.

The customer computing device 2608 responds to the activation of the call initiator by placing a call from the customer computing device 2608 to the adaptive ad campaign management system 2600. At 3202, the call placed by the customer computing device 2608 is received by adaptive ad campaign manager 2602. The received call includes embedded customer computing device specific data and product description page specific data. An example of the customer computing device specific data is a customer computing device phone number. Examples of the product description specific data include, but are not limited to, a product description page identifier identifying the product description page displayed on the customer computing device 2608 and a product description page link associated with the displayed product description page.

In an embodiment, the product description page specific data is VDP specific data associated with a VDP displayed on the customer computing device 2608. Examples of the VDP specific data include, but are not limited to, a VDP identifier identifying the VDP displayed on the customer computing device 2608 and a VDP link associated with the displayed VDP.

At 3204, the adaptive ad campaign manager 2602 identifies the ad campaign based on the received product description page specific data. In an embodiment, the adaptive ad campaign manager 2602 identifies the automotive campaign ad based on the received VDP specific data.

At 3206, the adaptive ad campaign manager 2602 retrieves a SMS text from the SMS server 2612. In an embodiment, a tap text link associated with the product advertised in the product description page is included the SMS text. In an embodiment, the adaptive ad campaign manager 2602 adds the tap text link to the retrieved SMS text. At 3208, the adaptive ad campaign manager 2602 transmits the SMS text including the tap text link to the customer computing device 2608.

The SMS text message including the tap text link is received at the customer computing device 2608. Clicking on the tap text link enables a customer to complete a CTA associated with the product advertised on the product description page. Examples of CTA include, but are not limited to, engage in a transaction associated with the product advertised on the product description page and view a website associated with the product advertised on the product description page. In an embodiment, by clicking on the tap text link, the customer consents to allow the adaptive ad campaign management system 2600 to track and collect customer action data associated with the advertised product for analytics. In an embodiment, the customer is provided with an option to disable the tracking feature.

At 3210, responsive to the activation of the tap text link, the adaptive ad campaign manager 2602 transmits the customer computing device specific data, the product description page specific data, and ad campaign data to a business establishment computing device 2610 associated with a business establishment that is suited to enable the customer to purchase the advertised product. In an embodiment, the adaptive ad campaign manager 2602 identifies one or more of the city, state, and zip code associated with the customer based on the customer computing device specific data and transmits the identified one or more of the city, state, and zip code associated with the customer to the business establishment computing device 2610. The business establishment may use the received customer computing device specific data to contact the customer to discuss a potential sale of the advertised product with the customer. In an embodiment, the advertised product is an automobile and the business establishment is an automobile dealership.

At 3212, responsive to the activation of the tap text link, the adaptive ad campaign manager 2602 transmits the customer computing device specific data, product description page specific data, the ad campaign data, and all tracked customer actions to the analytics server thereby enabling the collection and analysis of ad campaign specific data.

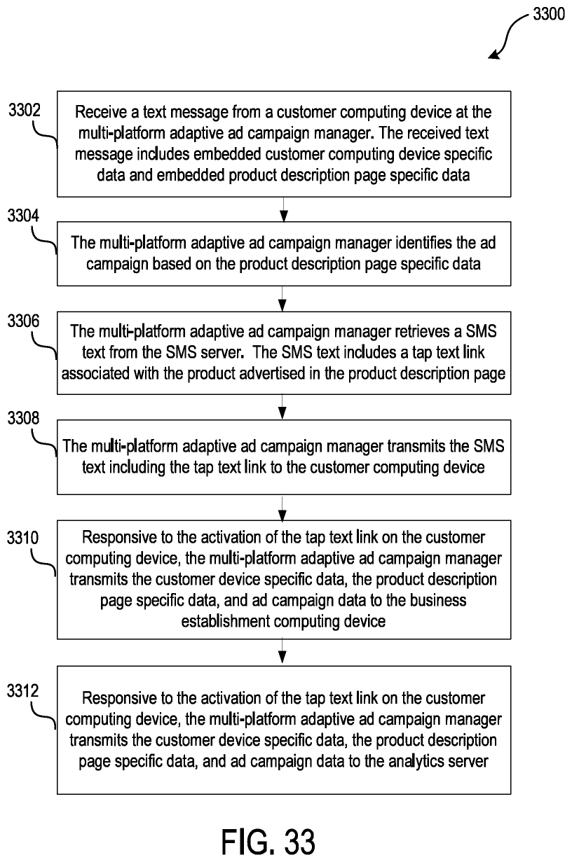

Referring to FIG. 33 is a flow chart representation of an example of a method 3300 of responding to an activation of a text message initiator 3002 on a product description page displayed on a customer computing device 2608 using an embodiment of an adaptive ad campaign management system 2600 is shown. The adaptive ad campaign management system 2600 transmits the product description page for display on one or more customer computing devices 2608 via one of the platforms designated by the business. In an embodiment, the product description page includes a text message initiator 3002. If the customer wishes to obtain additional information regarding a product advertised on the product description page displayed on the customer computing device 2608, the customer activates the text message initiator 3002. In an embodiment, the text message initiator 3002 is a text message tap button 3004 and the customer taps the text message tap button 3004 to activate the text message initiator 3002. In an embodiment, the product description page is a VDP for an automobile.

The customer computing device 2608 responds to the activation of the text message initiator by transmitting a text message from the customer computing device 2608 to the adaptive ad campaign management system 2600. At 3302, the text message transmitted by the customer computing device 2608 is received by adaptive ad campaign manager 2602. The received text message includes embedded customer computing device specific data and product description page specific data. An example of the customer computing device specific data is a customer computing device phone number. Examples of the product description specific data include, but are not limited to, a product description page identifier identifying the product description page displayed on the customer computing device 2608 and a product description page link associated with the displayed product description page.

In an embodiment, the product description page specific data is VDP specific data associated with a VDP displayed on the customer computing device 2608. Examples of the VDP specific data include, but are not limited to, a VDP identifier identifying the VDP displayed on the customer computing device 2608 and a VDP link associated with the displayed VDP.

At 3304, the adaptive ad campaign manager 2602 identifies the ad campaign based on the received product description page specific data. In an embodiment, the adaptive ad campaign manager 2602 identifies the automotive campaign ad based on the received VDP specific data.

At 3306, the adaptive ad campaign manager 2602 retrieves a SMS text from the SMS server 2612. In an embodiment, a tap text link associated with the product advertised in the product description page is included the SMS text. In an embodiment, the adaptive ad campaign manager 2602 adds the tap text link to the retrieved SMS text. At 3308, the adaptive ad campaign manager 2602 transmits the SMS text including the tap text link to the customer computing device 2608.

The SMS text message including the tap text link is received at the customer computing device 2608. Clicking on the tap text link enables a customer to complete a CTA associated with the product advertised on the product description page. Examples of CTA include, but are not limited to, engage in a transaction associated with the product advertised on the product description page and view a website associated with the product advertised on the product description page. In an embodiment, by clicking on the tap text link, the customer consents to allow the adaptive ad campaign management system 2600 to track and collect customer action data associated with the advertised product for analytics. In an embodiment, the customer is provided with an option to disable the tracking feature.

At 3310, responsive to the activation of the tap text link, the adaptive ad campaign manager 2602 transmits the customer computing device specific data, the product description page specific data, and ad campaign data to a business establishment computing device 2610 associated with a business establishment that is suited to enable the customer to purchase the advertised product. In an embodiment, the adaptive ad campaign manager 2602 identifies one or more of the city, state, and zip code associated with the customer based on the customer computing device specific data and transmits the identified one or more of the city, state, and zip code associated with the customer to the business establishment computing device 2610. The business establishment may use the received customer computing device specific data to contact the customer to discuss a potential sale of the advertised product with the customer. In an embodiment, the advertised product is an automobile and the business establishment is an automobile dealership.

At 3312, responsive to the activation of the tap text link, the adaptive ad campaign manager 2602 transmits the customer computing device specific data, product description page specific data, the ad campaign data, and all tracked customer actions to the analytics server thereby enabling the collection and analysis of ad campaign specific data.

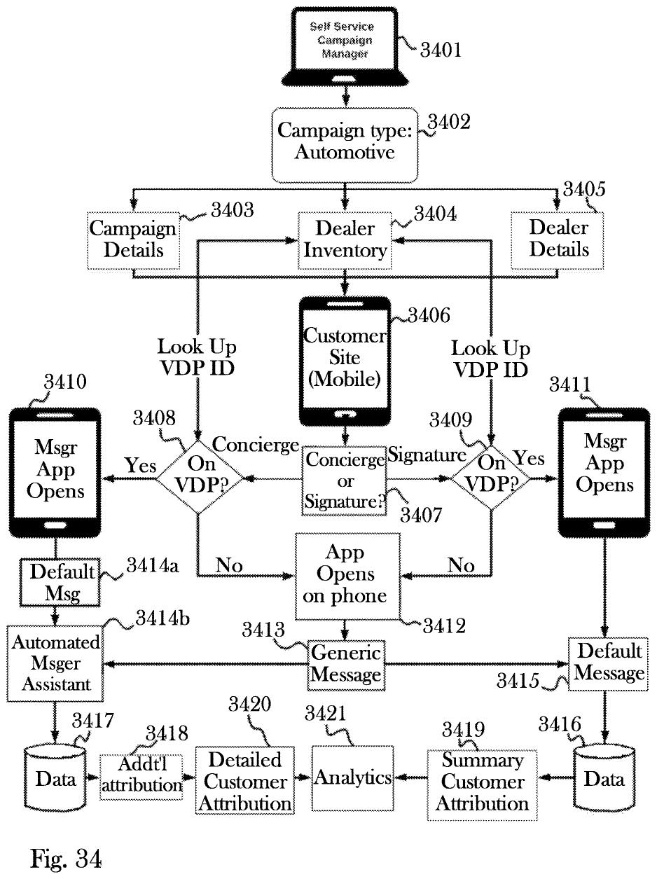

FIG. 34 is a flow chart illustrating the use of an automotive ad campaign being utilized for both generic and highly tailored, user-specific interactions, while generating deep analytics of ad interactivity, according to an embodiment.

A campaign manager 3401 as shown is an ad campaign manager as described in various embodiments, where the campaign manager is capable of receiving user input and communicating with at least one network to distribute created ad campaigns to websites or other platforms, and interact with users across networks. In this embodiment, an ad campaign type is specified, in this embodiment as an automotive campaign 3402, which may specify to the system what manner of ads, analytics, and usage it will have, which may be of varying importance depending on system configuration. An ad campaign type does not necessarily have to be specified for the system to operate properly, and may only be utilized in some cases for labelling a campaign for other human users, such as administrators, to understand the analytics and underlying ads being generated. The campaign details 3403 may be specified as well from a campaign manager 3401, along with dealer inventory 3404, and dealer details 3405, for a specific dealer of an automotive product such as a car or truck. These details may be manually input into the system from a campaign manager 3401, or dynamically set, for instance from a call to a database. A customer's mobile website may then be viewed 3406, the operation of which in a specified ad campaign may be different depending on whether it is a “concierge” website or a “signature” website 3407, referring to a website that provides for a messenger assistant 3414b for “concierge” websites, or a “signature” website which merely provides for basic information filled from a datastore but does not provide a customized experience with a messenger assistant 3414b. In either case, a determination is made as to whether or not a user is on a Vehicle Details Page (“VDP”) 3408, 3409, and if a user is not on such a page to view a product's description, a text messenger app is opened on the user's phone 3412, to display a generic message to the user 3413, while if the user is indeed on a VDP, their messenger app opens 3410, 3411 and they are given a more specific message 3414a, 3415 regarding the vehicle details, based in part on a lookup of the vehicle's ID in the dealer inventory 3404. It is useful to note that the text messaging applications may be opened due to receiving an internet-initiated SMS text message directed at the user, for instance through the open standard Internet Engineering Task Force (“IETF”) RFC 5724, “URI Scheme for Global System for Mobile Communications (GSM) Short Message Service (SMS).” As such, the interaction between a user and the advertisement campaign as shown, may take them form of them merely seeing an advertisement on the mobile website, tapping or clicking it, and the SMS being sent to them, initiating interactions. A user who was not initially on the VDP and was given a generic message 3413 rather than a default informational message 3414a, 3415, may be given a more specific message 3415 or may be referred to a messenger assistant 3414b for further customization and use with a chatbot or similar system. In either case, the default message 3415 or messenger assistant 3414b then may store data 3416, 3417 including customer interactions, any messenger assistant interactions, customer purchases or referrals, location or phone number data, or other relevant data, in datastores, before allowing either a summary customer attribution 3419 in the case of a non-concierge or limited website use, or additional third-party attributions 3418 as well as a more detailed customer attribution if available 3420, to be used for compiling the completed analytics 3421 of the advertisement interactions. Third-party attributions 3418 may include attribution of interactions and results regarding the messenger assistant, or any related or referred products or links, during the course of advertisement interaction. Customer attributions may include identifying information about the customer and their selections, as much as permitted by law and desired in the configuration of the system. By contrast, a summary customer attribution 3419 may be a similar attribution but with less or an equivalent amount of interaction and identifying data, without third-party attribution data, due to a smaller amount of interaction.

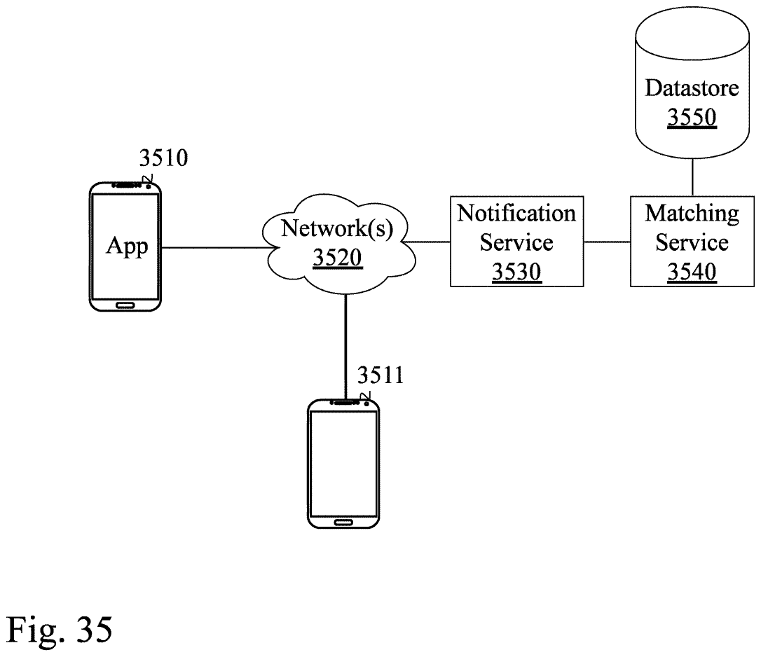

FIG. 35 is a diagram of a system for adaptive advertisement within a mobile application, according to an embodiment. A user mobile device with a communications and advertising application 3510 exists which may be used by a consumer while connected to a network or multiple networks 3520, such as but not limited to the Internet or a Cellular Network, and which may be a smartphone or other manner of mobile device such as a tablet, or personal computing device. The operating system of such a device may range from such software as ANDROID™, IOS™, WINDOWS™, LINUX™, or others, and a second mobile device 3511 may also operate on at least one of the same networks 3520 as the first mobile device 3510, and may be communicated with over that network or networks 3520 by the first mobile device and application 3510. The application running on a first mobile device 3510 may communicate over the network or networks 3520, such as with the TCP/IP protocol, with a notification service 3530 that manages both incoming and outgoing data to the application, for the purpose of sending notifications such as PUSH notifications to the user, while also allowing a user to input and edit their own data for a matching service 3540, the data being stored in a datastore 3550. The services 3530, 3540 and datastore 3550 may be stored on the same server device, or on some combination of separate or interconnected devices, the specific configuration of which is not limiting to the invention. A matching service 3540 may be used to match a user's inserted preferences and data with stored 3550 data from companies that wish to advertise to such users, for instance it may match a user who has very open preferences for any companies offering advertised deals within a 20 mile radius, in which case the user may get notifications of such offers within his specified distance, from the matching service 3540. If a match is made, the notification service 3530 is used to notify the user and allow them to perform an action based on the notification, within the application.

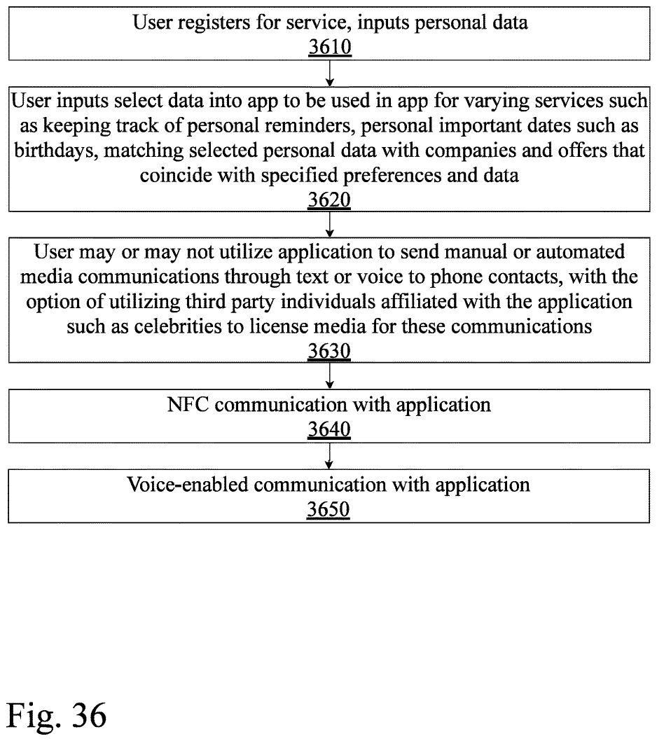

FIG. 36 is a method diagram for a system of adaptive advertisement within a mobile application, according to an embodiment. First a user may register with a communications and advertisement application for service, and input their personal data 3610. Personal data may include fields such as date of birth, name, location, gender or sex, sexual orientation, income, or any other data as needed by the communications and advertisement integration application. After a user registers and enters their selected data, a user may input further select data into the application to be used for varying services such as keeping track of personal reminders, keeping track of important dates such as birthdays of loved ones, and matching select personal data with companies and offers that coincide with specified preferences and data 3620, for instance through a variety of menu options, text fields, and more. A user may or may not then utilize the application to send manual or automated media communications through text or voice to phone contacts, with the option of utilizing third-party individuals affiliated with the application such as celebrities to license media for these communications 3630. For instance, after a user has registered and entered relevant personal data into the application, they may specify that automated “happy birthday” messages should be sent to their relatives as specified in the application, and may even include an option for third parties such as celebrities or noteworthy figures to send pre-recorded birthday messages, as part of the message sent to the user's relatives. Such third-party individuals may require payment, may be part of a subscription package in the application, and may even be other relatives or a self-recorded audio file, rather than a third-party individual. NFC communications mentioned earlier may integrate with the application 3640 for the purposes of allowing NFC-enabled products or tags to trigger an offer from an advertiser or seller to appear on a customer's application. Voice-enabled communications with the application 3650 may also be enabled by a user so that they may replace traditional user interface interactivity with voice commands, such as instructing the application, “send happy birthday message to my Aunt Patrice,” or some other voice command. Communications sent from a mobile device operating such an application may be received by a recipient device without such an application, and may be received as emails, text SMS messages, phone calls or messages, or other communications methods, techniques and services that may be or may become common in mobile device communications.

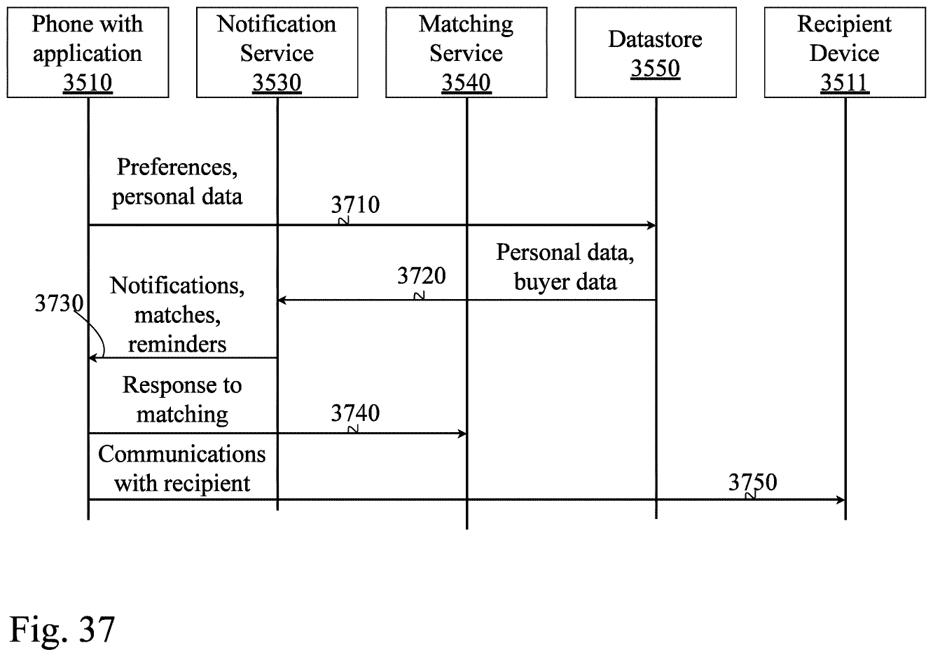

FIG. 37 is a message flow diagram for a system of adaptive advertisement within a mobile application, according to an embodiment. The devices or services receiving or sending messages in the diagram are a phone with an integrated advertisement and communication application 3510, a notification service 3530, a matching service 3540, a datastore 3550, and a recipient device 3511. A user of a user mobile device running an integrated advertisement and communication application 3510 may send their preferences and personal data to a datastore 3550, 3710, allowing a notification service 3530 to poll this data and receive the customer's data as well as the data from companies that may wish to match with the consumer 3720. The notification service 3530 then informs the user via the application 3510 of any notifications, matches, or reminders that are scheduled 3730, at which point a user may interact with the notifications and respond to them 3740 which is sent to the matching service 3540, or the user may initiate communications with a second recipient mobile device 3511, 3750.

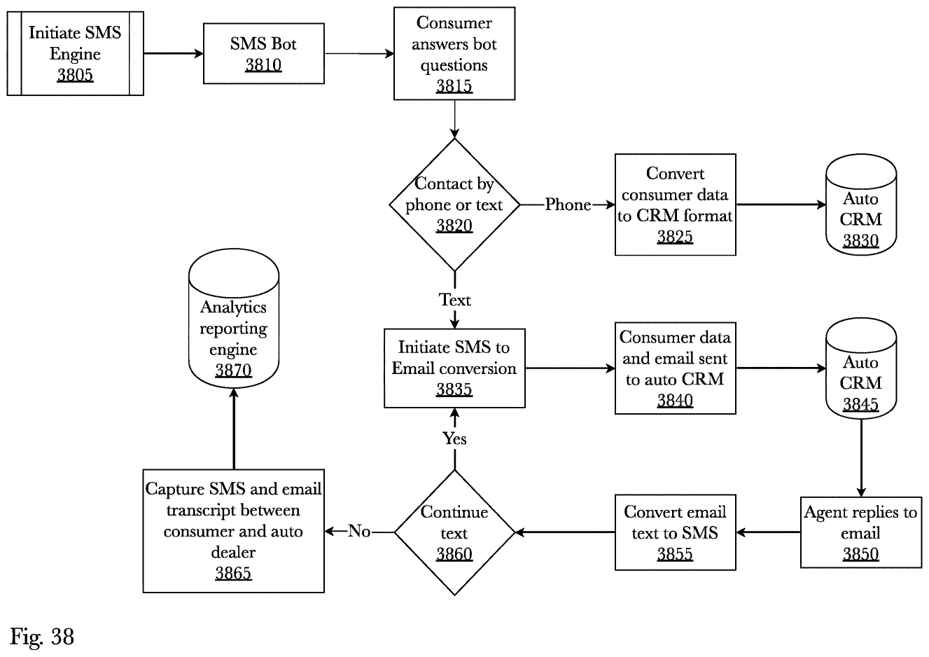

FIG. 38 is a flowchart showing an exemplary conversion of SMS, voice, and email data, for an exemplary automotive dealer interaction. First, an SMS engine from an advertisement integration application is initiated 3805 that may include an SMS bot 3810, which may pose consumer questions 3815. Query and response may include personal information questions, preferences, or settings for the application or for an instant communication. For example, if a merchant or advertiser wishes to contact a consumer; or if the consumer has indicated they wish to be contacted by a merchant. A consumer may answer whether they wish to be contacted by phone or text 3820, and if they answer “phone,” a phone call is initiated with an agent to gather and then convert their data to the proper CRM format 3825 and to handle the consumer's interaction as normal, such as converting the user data to MICROSOFT DYNAMICS 365™ format, and storing it in an auto dealer's CRM system 3830, for an exemplary auto dealer interaction. If the user instead answer “text” at step 3820, the application may initiate an SMS to email conversion 3835 by taking the text typed by the consumer and putting it in the appropriate fields of an email, or by putting the text entirely in the body of the email, depending on the implementation. The consumer data may then be emailed to the auto dealer CRM system 3840 for input into the system 3845, at which point an agent for the auto dealer may reply to the email sent by the consumer 3850 if applicable. The email sent by the auto dealer agent is then converted into SMS 3855, for instance the body of the email being put into the SMS, with the recipient being automatically matched with the email thread in the CRM. The consumer may be asked if they wish to continue texts with the agent, by the SMS bot 3860, at which point, if they specify “yes,” they will be redirected back into the SMS-to-email loop 3835. If they answer “no” however, indicating that the interactions are finished, then a transcript of the SMS and emails between the consumer and auto dealer agent is captured 3865 and all data is stored in an analytics data store for later use in analytics reporting 3870.

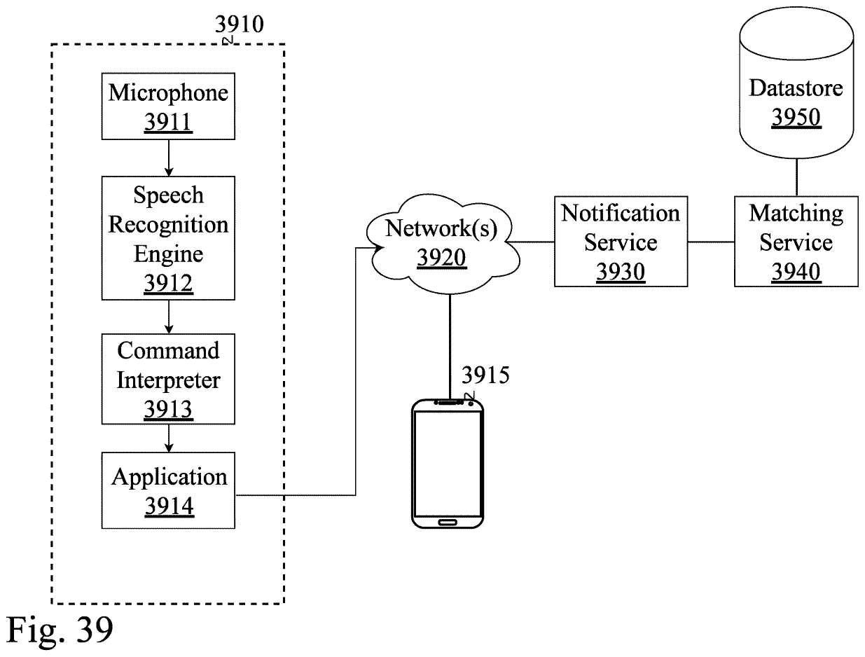

FIG. 39 is a diagram of a system for adaptive advertisement within a mobile application, according to an embodiment. A user mobile device with a communications and advertising application 3910 exists which may be used by a consumer while connected to a network or multiple networks 3920, such as but not limited to the Internet or a cellular network, and which may be a smartphone or other manner of mobile device such as a tablet, or personal computing device. The operating system of such a device may range from such software as ANDROID™, IOS™, WINDOWS™, LINUX™, or others, and a second mobile device 3915 may also operate on at least one of the same networks 3920 as the first mobile device 3910, and may be communicated with over that network or networks 3920 by the first mobile device and application 3910.

The first mobile device 3910 comprises at least a microphone 3911, a speech recognition engine 3912, a command interpreter 3913, and an application 3914. The command interpreter 3913 and speech recognition 3912 are software operating on hardware connected to or part of the interior of the mobile device 3910 and may be part of the software of the application 3914, rather than separate software. Independent software for speech recognition 3912 may be used, such as DRAGON NATURALLY SPEAKING™, SPHINX™, and others. Some operating systems such as ANDROID™ may have built-in speech recognition which may be utilized as well. A microphone 3911 may be a separately connected device, also known as an external microphone, or may be an integrated microphone that is part of the construction of the mobile device 3910, and is used to receive audio and deliver it to the speech recognition engine 3912, which interprets the audio data to form words, forwarding the translated data to the command interpreter 3913 software, which interprets strings of words as commands to the application 3914, such as “tap that link” or “send a birthday greeting to my Mother.”

The application running on a first mobile device 3910 may communicate over the network or networks 3920, such as with the TCP/IP protocol, with a notification service 3930 that manages both incoming and outgoing data to the application, for the purpose of sending notifications such as PUSH notifications to the user, while also allowing a user to input and edit their own data for a matching service 3940, the data being stored in a datastore 3950. The services 3930, 3940 and datastore 3950 may be stored on the same server device, or on some combination of separate or interconnected devices, the specific configuration of which is not limiting to the invention. A matching service 3940 may be used to match a user's inserted preferences and data with stored 3950 data from companies that wish to advertise to such users, for instance it may match a user who has very open preferences for any companies offering advertised deals within a 20 mile radius, in which case the user may get notifications of such offers within his specified distance, from the matching service 3940. If a match is made, the notification service 3930 is used to notify the user and allow them to perform an action based on the notification, within the application.

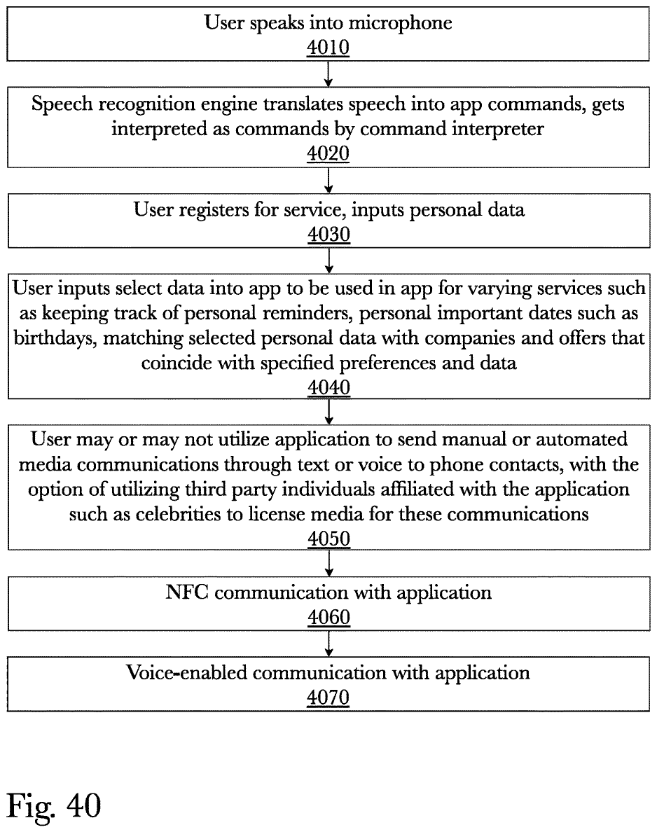

FIG. 40 is a method diagram for a system of adaptive advertisement within a mobile application, according to an embodiment. First a user speaks into microphone 4010, which may be either an integrated microphone or an external or separately attached microphone, and which may be connected through one of several possible methods, including a 3.5 mm jack using any of TS, TRS, TRRS, or TRRRS construction, or an XLR microphone either connected directly to the mobile device or connected through the use of an adapter, or connected over a network connection including wireless connections, or some other connection method. The audio data the user speaks is then translated into text with a speech recognition engine, which may be software operating as part of the mobile device or as part of a separately connected device, before giving the string of translated words in the supported language of the user to a command interpreter to be interpreted as application commands 4020. According to the embodiment, the application in this instance may be used for integration of adaptive advertisement and other communications, utilizing a user's voice to receive commands rather than buttons or a touchscreen interface, or in addition to them in some cases. Such commands may include “send a birthday greeting to my Mother,” “I don't want to get offers from automotive dealers,” “respond to that offer,” and others.

A user may register with a communications and advertisement application for service, and input their personal data 4030. Personal data may include fields such as date of birth, name, location, gender or sex, sexual orientation, income, or any other data as needed by the communications and advertisement integration application. After a user registers and enters their selected data, a user may input further select data into the application to be used for varying services such as keeping track of personal reminders, keeping track of important dates such as birthdays of loved ones, and matching select personal data with companies and offers that coincide with specified preferences and data 4040, for instance through a variety of menu options, text fields, and more. A user may or may not then utilize the application to send manual or automated media communications through text or voice to phone contacts, with the option of utilizing third-party individuals affiliated with the application such as celebrities to license media for these communications 4050. For instance, after a user has registered and entered relevant personal data into the application, they may specify that automated “happy birthday” messages should be sent to their relatives as specified in the application, and may even include an option for third parties such as celebrities or noteworthy figures to send pre-recorded birthday messages, as part of the message sent to the user's relatives. Such third-party individuals may require payment, may be part of a subscription package in the application, and may even be other relatives or a self-recorded audio file, rather than a third-party individual. NFC communications mentioned earlier may integrate with the application 4060 for the purposes of allowing NFC-enabled products or tags to trigger an offer from an advertiser or seller to appear on a customer's application. Voice-enabled communications with the application 4070 may also be enabled by a user so that they may replace traditional user interface interactivity with voice commands, such as instructing the application, “send happy birthday message to my Aunt Patrice,” or some other voice command. Communications sent from a mobile device operating such an application may be received by a recipient device without such an application, and may be received as emails, text SMS messages, phone calls or messages, or other communications methods, techniques and services that may be or may become common in mobile device communications.

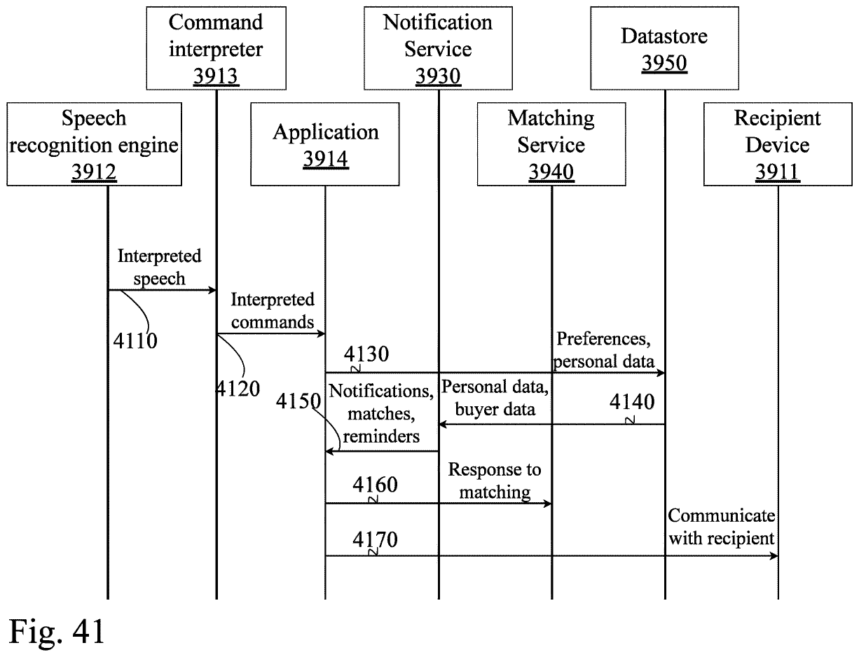

FIG. 41 is a message flow diagram for a system of adaptive advertisement within a mobile application, according to an embodiment. The devices or services receiving or sending messages in the diagram are a speech recognition engine 3912, a command interpreter 3913, a mobile application 3914, a notification service 3930, a matching service 3940, a datastore 3950, and a recipient device 3915. A mobile device user may speak into a connected microphone to have their speech interpreted by a speech recognition engine 3912, whereby the interpreted speech is sent from the speech recognition engine 3912 to the command interpreter 3913, 4110. Such a data transmission may be merely a software pipeline between two software operating on the same computer, or may be a network connection between software operating on network-connected devices. Such a speech recognition engine 3912 may be an operating system service such as one offered by ANDROID™ operating systems, or a proprietary or open source system such as DRAGON NATURALLY SPEAKING™ or SPHINX™, while a command interpreter 3913 may be an integrated software component of the application 3914, interpreting the string of text as a limited set of commands within the application 4120, such as “ignore that offer” or “close app.”

A user of a phone running an integrated advertisement and communication application 3910 may send their preferences and personal data to a datastore 3950, 4130, allowing a notification service 3930 to poll this data and receive the customer's data as well as the data from companies that may wish to match with the consumer 4140. The notification service 3930 then informs the user via the application 3910 of any notifications, matches, or reminders that are scheduled 4150, at which point a user may interact with the notifications and respond to them 4160 which is sent to the matching service 3940, or the user may initiate communications with a second recipient mobile device 3915, 4170.

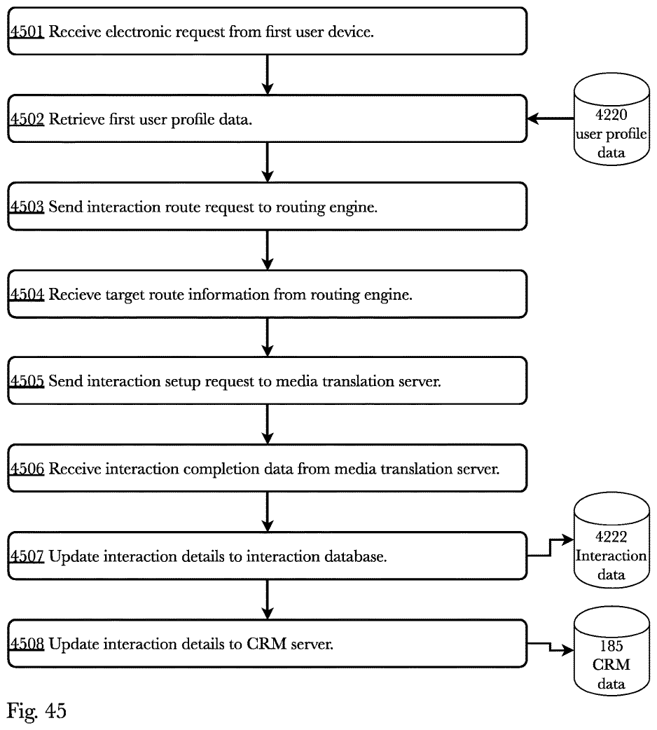

FIG. 45 is a flow diagram showing the steps of an exemplary method for interaction control. In a first step, 4501 receive an electronic request from a first user device, electronic request comprising user name or number identifying user, origination address, product or service of interest, associated advertising campaign, time and date of availability if not immediately; to establish a text-based connection, text-based (e.g. SMS or other communication protocol available to those skilled in the art); from a first user device whereas the first user device is associated with a customer (e.g. customer user mobile device 130) to a second user device whereas the second user device is associated with a business (e.g. business user mobile device 132). In a next step, 4502 retrieve a first user profile data from a user profile database that may be associated with a business'CRM system, user profile customer profile data comprising username, address, phone number, email, preferred contact method, historical purchase information, customer tiering level (e.g. bronze, silver, gold), personal information (e.g. marital status, number of dependents, net worth, interests/hobbies). In a next step, 4503 send an interaction routing request to a routing engine, interaction routing request comprising list of prior customer interactions with business, brand, product, or if available competitor business, brand or product, product or service purchased, amount of purchase, prior communications (e.g., text, chat, email, snail mail, voice call, call center interaction, in-person, telegram or other communications means) with business or business partner, attribution data associated with advertising campaigns customer experienced including media channel (e.g. TV, social media, near-field-communication, in-store offers, targeted email), dates and times of ad campaigns, aggerate sales data associated with each advertising campaign, customer-specific sales outcome (e.g. made purchased, deferred purchase, returned item). In a next step, 4504 receive target route information from a routing engine, target route information comprising target type (e.g. traditional phone-based agent, multi-media agents, AI-based or traditional interactive voice response (“IVR”) systems, AI-driven chat bots or speech bots, or non-traditional resources for example field sales), target resource name (e.g. Jim Johnson), title (e.g. car sales advocate), destination address (e.g. 360.867.5309). In a next step, 4505 send target route information to media translation server. In a next step, 4506 receive interaction completion data from a media translation server, interaction completion data comprising first user identifier, second user identifier, interaction type (e.g. text-to-text, email-to-text, chat-to-text), interaction date and time stamp, interaction duration, termination originator (e.g. first user device, second user device), interaction outcome (e.g. purchase made, problem resolved, follow up required). In a next step, 4507 update interaction details to interaction database, interaction details comprising first user identifier, second user identifier, interaction type (e.g. text-to-text, email-to-text, chat-to-text), interaction date and time stamp, interaction duration, termination originator (e.g. first user device, second user device), interaction outcome (e.g. purchase made, problem resolved, follow up required). In a next step, 4508 update interaction details to a CRM database 185, interaction details comprising first user identifier, second user identifier, interaction type (e.g. text-to-text, email-to-text, chat-to-text), interaction date and time stamp, interaction duration, termination originator (e.g. first user device, second user device), interaction outcome (e.g. purchase made, problem resolved, follow up required).

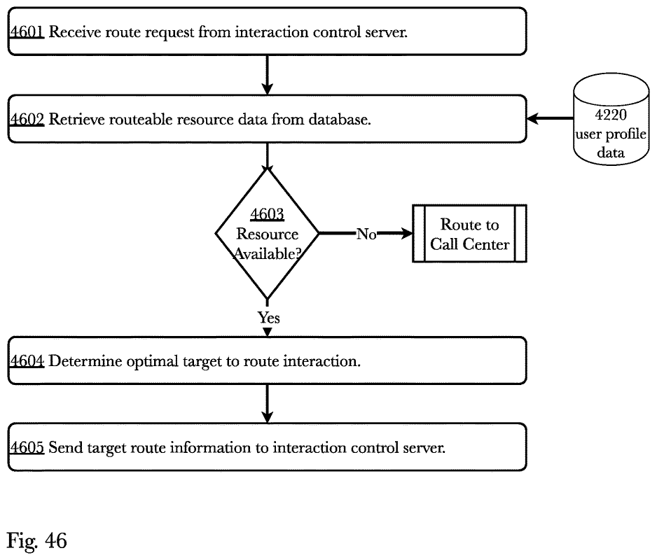

FIG. 46 is a flow diagram showing the steps of an exemplary method for interaction routing. In a first step, 4601 receive interaction routing request from interaction control server, interaction routing request comprising list of prior customer interactions with business, brand, product, or if available, competitor business, brand or product, product or service purchased, amount of purchase, prior communications(e.g. text, chat, email, snail mail, voice call, call center interaction, in-person, telegram or other communications means) with business or business partner, attribution data associated with advertising campaigns customer experienced including media channel (e.g. TV, social media, near-field-communication, in-store offers, targeted email), dates and times of ad campaigns, aggerate sales data associated with each advertising campaign, customer-specific sales outcome (e.g. made purchase, deferred purchase, returned item). In a next step, 4602 retrieve routable resource data from resource repository, routable resource data comprising target route information comprising target type (e.g. traditional phone-based agent, multi-media agents, AI-based or traditional interactive voice response (“IVR”) systems, AI-driven chat bots or speech bots, or non-traditional resources for example field sales), target resource name (e.g. Jim Johnson), title (e.g. car sales advocate), destination address (e.g. 360.867.5309). In a next step, 4603 identify target availability. In a next step, 4604 determine optimal resource to route the interaction, optimal resource determination is achieved through the use AI techniques known to those skilled in the art including deep learning algorithms and incorporate data comprised of time-of-day, day-of-week, store hours, resource availability, service level requirements, customer user profile data, previous customer interaction and transactions, customer tiering structure, and business CRM data. In a next step, 4605 send target route information (second user) to interaction control server, target route information comprising target type (e.g. traditional phone-based agent, multi-media agents, AI-based or traditional interactive voice response (“IVR”) systems, AI-driven chat bots or speech bots, or non-traditional resources for example field sales), target resource name (e.g. Jim Johnson), title (e.g. car sales advocate), destination address (e.g. 360.867.5309).

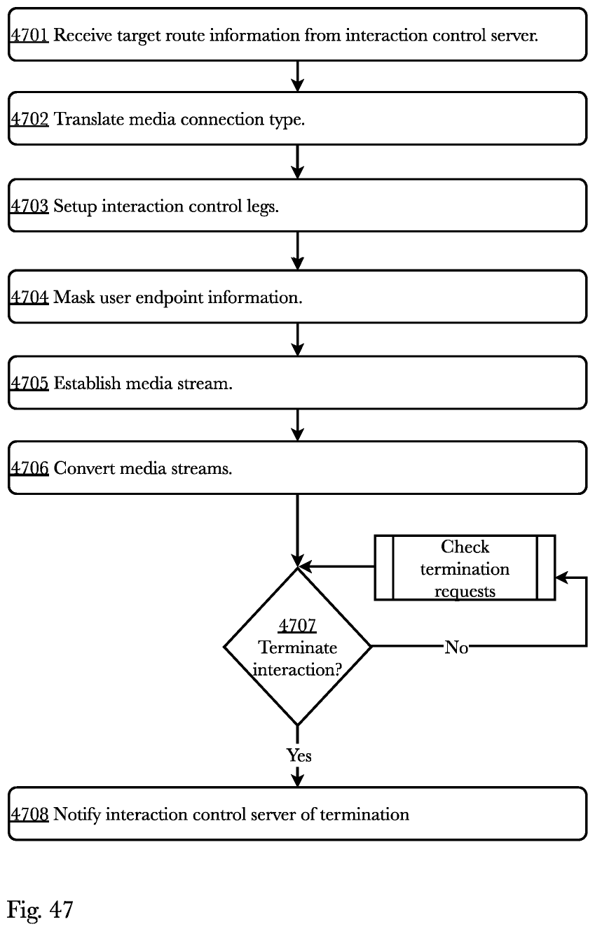

FIG. 47 is a flow diagram showing the steps of an exemplary method for media translation. In a first step, 4701 receive target route information from an interaction control server, target route information comprising target route information comprising target type (e.g. traditional phone-based agent, multi-media agents, AI-based or traditional interactive voice response (“IVR”) systems, AI-driven chat bots or speech bots, or non-traditional resources for example field sales), target resource name (e.g. Jim Johnson), title (e.g. car sales advocate), destination address (e.g. 360.867.5309). In a next step, 4702 translate media connection type, media connection type comprising text-to-text, email-to-text, or chat-to-text. In a next step, 4703 set up interaction control legs between a first user device (e.g. customer) and a second user device (e.g. business user), interaction control legs comprising communication network sockets (e.g. IP/TCP) that enable communication between user devices. In a next step, 4704 mask user device endpoint information from a first user to a second user, and from a second user to a first user. In a next step, 4705 establish media stream between a first user and a second user. In a next step, 4706 convert media stream as required, converted media stream include email-to-text, chat-to-text such that customer user device (text, chat, email) can communicate with business user device (text) without necessitating using a dedicated device or changing devices or downloading and logging into a dedicated application on either customer user device or business user device. In a next step, 4707 terminate connection, termination request may come from either customer user device or business user device. In a next step, 4708 notify interaction control server of terminated connection and provide interaction completion data, interaction completion data comprising first user identifier, second user identifier, interaction type (e.g. text-to-text, email-to-text, chat-to-text), interaction date and time stamp, interaction duration, termination originator (e.g. first user device, second user device), interaction outcome (e.g. purchase made, problem resolved, follow up required).

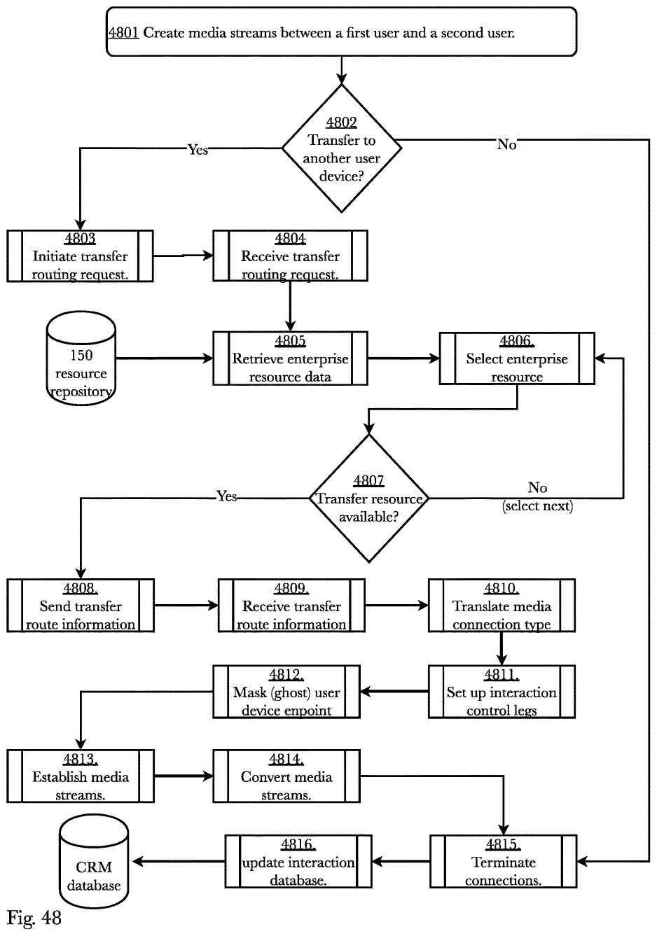

FIG. 48 is a flow diagram showing the steps of an exemplary method for interaction transfer from a first user and a second user, to a first user and a third user. In a first step, 4801 create interaction media streams between a first user and a second user as exemplified in flow diagrams FIG. 45, FIG. 46, and FIG. 47. In a next step, 4802 a second user device sends a request to an interaction control server to transfer the interaction to a third user device. In a next step, 4803 an interaction control server initiates a transfer routing request to an interaction routing engine. In a next step, 4804 an interaction routing engine receives transfer routing request from an interaction control server, transfer routing request comprising list of current and prior customer interactions with business, brand, product, or if available, competitor business, brand or product, product or service purchased, amount of purchase, prior communications(e.g. text, chat, email, snail mail, voice call, call center interaction, in-person, telegram or other communications means) with business or business partner, attribution data associated with advertising campaigns customer experienced including media channel (e.g. TV, social media, near-field-communication, in-store offers, targeted email), dates and times of ad campaigns, aggerate sales data associated with each advertising campaign, customer-specific sales outcome (e.g. made purchased, deferred purchase, returned item). In a next step, 4805 an interaction routing engine retrieves enterprise resource data from resource repository, enterprise resource data comprising target route information comprising target type (e.g. traditional phone-based agent, multi-media agents, AI-based or traditional interactive voice response (“IVR”) systems, AI-driven chat bots or speech bots, or non-traditional resources for example field sales), target resource name (e.g. Jim Johnson), title (e.g. car sales advocate), destination address (e.g. 360.867.5309). In a next step, 4806 select enterprise resource to transfer route the interaction, enterprise resource determination is achieved through use AI techniques known to those skilled in the art including deep learning algorithms and incorporate data comprised of time-of-day, day-of-week, store hours, resource availability, service level requirements, customer user profile data, previous customer interaction and transactions, customer tiering structure, and business CRM data. In a next step, 4807 identify transfer target availability based on calendar availability, if unavailable check next resource in target list. In a next step, 4808 send target transfer route information (third user) from an interaction routing engine to an interaction control server. In a next step, 4809 receive target transfer route information at an interaction control server. In a next step, 4810 translate media connection type, media connection type comprising text-to-text, email-to-text, or chat-to-text. In a next step, 4811 set up interaction control legs between a first user device (e.g. customer) and a second user device (e.g. business user), interaction control legs comprising communication network sockets (e.g. IP/TCP) that enable communication between user devices. In a next step, 4812 mask user device endpoint information from a first user to a third user, and from a third user to a first user. In a next step, 4813 establish media stream between a first user and a third user. In a next step, 4814 convert media stream as required, converted media stream include email-to-text, chat-to-text such that customer user device (text, chat, email) can communicate with business user device (text) without necessitating using a dedicated device or changing devices or downloading and logging into a dedicated application on either customer user device or business user device. In a next step, 4815 terminate connection, termination request may come from either customer user device or business user device. In a next step, 4816 update enterprise CRM database with interaction completion data, interaction completion data comprising first user identifier, second user identifier, third user identifier, interaction type (e.g. text-to-text, email-to-text, chat-to-text), interaction date and time stamp, interaction duration, termination originator (e.g. first user device, second user device), interaction outcome (e.g. purchase made, problem resolved, follow up required).

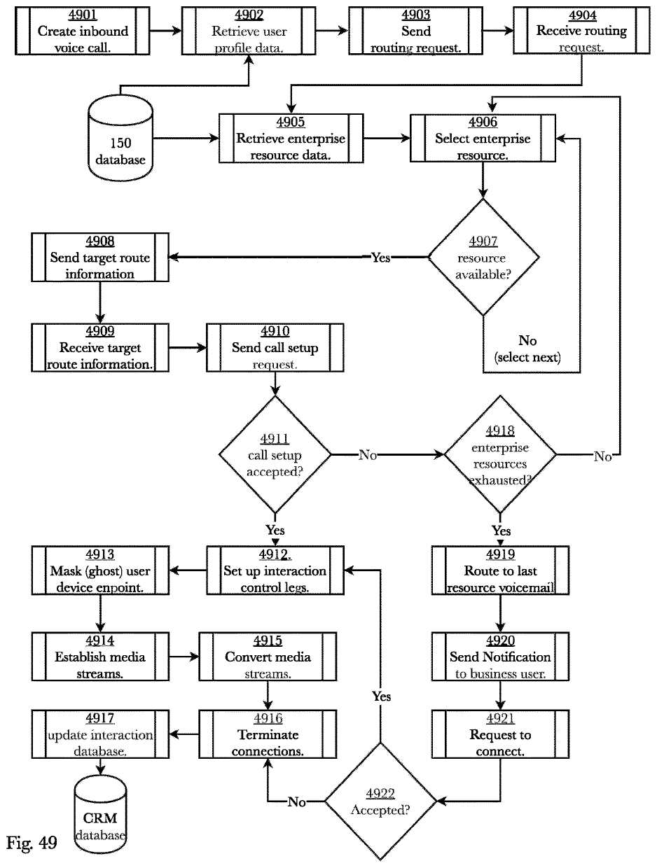

FIG. 49 is a flow diagram showing the steps of an exemplary method for voice interaction from a first user to a voicemail of a second user; and a subsequent text interaction from a second user to a first user as a result of the voice interaction. In a first step, 4901 create an inbound voice call from a first user device whereas the first user device is associated with a customer (e.g. customer user mobile device 130) to an interaction control server associated with an enterprise and business user devices (e.g. business user mobile device 132 or other business user mobile device 134); inbound voice call is initiated through first user interaction with first user device, by clicking on text link, or tapping on picture element; inbound voice call data comprising user name or number identifying user, origination address, product or service of interest, and associated advertising campaign. In a next step, 4902 retrieve a first user profile data from a user profile database that may be associated with a business'CRM system or other enterprise database, user profile customer profile data comprising username, address, phone number, email, preferred contact method, historical purchase information, customer tiering level (e.g. bronze, silver, gold), personal information (e.g. marital status, number of dependents, net worth, interests/hobbies). In a next step, 4903 send an interaction routing request from an interaction control server to a routing engine, interaction routing request comprising list of prior customer interactions with business, brand, product, or if available competitor business, brand or product, product or service purchased, amount of purchase, prior communications(e.g. text, chat, email, snail mail, voice call, call center interaction, in-person, telegram or other communications means) with business or business partner, attribution data associated with advertising campaigns customer experienced including media channel (e.g. TV, social media, near-field-communication, in-store offers, targeted email), dates and times of ad campaigns, aggerate sales data associated with each advertising campaign, customer-specific sales outcome (e.g. made purchased, deferred purchase, returned item). In a next step, 4904 an interaction routing engine receives routing request from an interaction control server, routing request comprising list of current and prior customer interactions with business, brand, product, or if available, competitor business, brand or product, product or service purchased, amount of purchase, prior communications(e.g. text, chat, email, snail mail, voice call, call center interaction, in-person, telegram or other communications means) with business or business partner, attribution data associated with advertising campaigns customer experienced including media channel (e.g. TV, social media, near-field-communication, in-store offers, targeted email), dates and times of ad campaigns, aggerate sales data associated with each advertising campaign, customer-specific sales outcome (e.g. made purchased, deferred purchase, returned item). In a next step, 4905 an interaction routing engine retrieves enterprise resource data from resource repository, enterprise resource data comprising target route information comprising target type (e.g. traditional phone-based agent, AI-based such as natural language processing or traditional interactive voice response (“IVR”) systems, or non-traditional resources for example field sales), target resource name (e.g. Jim Johnson), title (e.g. car sales advocate), destination address (e.g. 360.867.5309). In a next step, 4906 select enterprise resource to route the voice call, enterprise resource determination is achieved through use AI techniques known to those skilled in the art including deep learning algorithms and incorporate data comprised of time-of-day, day-of-week, store hours, resource availability, service level requirements, customer user profile data, previous customer interaction and transactions, customer tiering structure, and business CRM data. In a next step, 4907 identify target availability based on calendar availability, if enterprise resource unavailable, go back to step 4906 and select next resource in target list. If resource is available in a next step, 4908 send target route information from an interaction routing engine to an interaction control server. In a next step, 4909 receive target route information at an interaction control server. In a next step, 4910 send voice call set up request from an interaction control server to a business user mobile device. In a next step, 4911 voice call set up request is accepted or rejected. If the call setup request is accepted by the business user mobile device, then in a next step, 4912 set up interaction control legs between a first user device (e.g. customer) and a second user device (e.g. business user), interaction control legs comprising communication network sockets (e.g. IP/TCP) that enable communication between user devices. In a next step, 4913 mask (“ghost”) user device endpoint information from a first user to a second user, and from a second user to a first user. In a next step, 4914 establish interaction (e.g. voice, text) media stream from a first user to a second user, and from a second user to a first user. In a next step, 4915 convert media stream as required, converted media stream include email-to-text, chat-to-text such that customer user device (text, chat, email) can communicate with business user device (text) without necessitating using a dedicated device or changing devices or downloading and logging into a dedicated application on either customer user device or business user device. In a next step, 4916 terminate connection, termination request may come from either first user (customer) device or second user (business) device. In a next step, 4917 update enterprise CRM database with interaction completion data, interaction completion data comprising first user identifier, second user identifier, interaction type (e.g. voice-to-voicemail, voice-to-voice, text-to-text, email-to-text, chat-to-text), interaction date and time stamp, interaction duration, termination originator (e.g. first user device, second user device), interaction outcome (e.g. purchase made, problem resolved, follow up required). If the call setup request is not accepted 4911 by the business user mobile device, then in a next step, 4918 a determination is made enterprise resources have been selected from a routable target list. If enterprise resources are not exhausted, then process returns to step 4906. If enterprise resources are exhausted, then in a next step 4919, an interaction control server routes call to first targeted second (business) user voicemail. In a next step 4920, send notification (e.g. text message) to business user mobile device. In a next step, 4921 a second user (business) user mobile device sends an electronic message through an interaction control server to first user (customer) mobile device requesting to connect. In a next step, 4922 first user mobile device either accepts or rejects the request to connect. If the first user accepts the request, then process continues to step 4912. If the first user device does not accept, then process continues to step 4916.

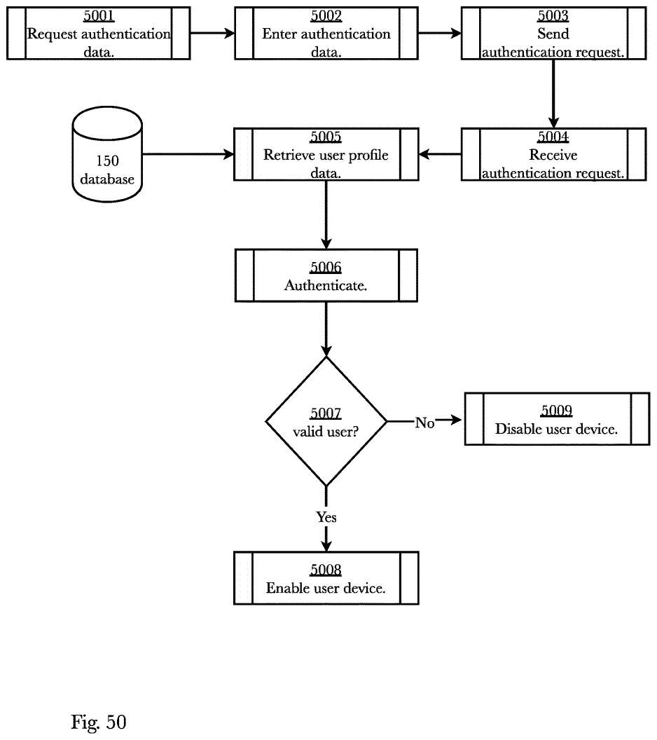

FIG. 50 is a flow diagram showing the steps of an exemplary method for authentication of the TCPA compliant mobile device. In a first step, 5001 the TCPA compliant mobile device 136 requests user to enter their authentication data that uniquely identifies them, the request may be in the form of a log in screen to receive typed user input, a voice prompt from an auditory device, a camera lens to receive visual data, or a fluid receptacle to receive identifying fluids from a user, or any other means to collect uniquely identifying user data. In a next step, 5002 the device user enters their authentication data (authentication factors) that uniquely identifies them, authentication data input may include what the user knowns (e.g. user name, user password, personal identification number, etc.), what the user has (e.g. mobile push authenticator, multi-factor authentication code generated from third-party device such as GEMALTO™, GOOGLE AUTHENTICATOR™, or other device), something the user is (e.g. biometric data from retinal scan, fingerprint, DNA sample and the like), or some other verification technique. In a next step, 5003 the secure mobile device sends authentication request along with authentication data to the interaction control server 4218. In a next step, 5004 interaction control server receives 4218 authentication request along with authentication data. In a next step, 5005 the interaction control server retrieves business user profile data 4220 from database 155 that may be associated with a business'CRM system or other enterprise database, business user profile data comprising username, address, phone number, job/position title, level of authorization available to business user, level of authorization may include systems (e.g. CRM, payroll, sales, human resources) or data (e.g. sales, customer, account) accessible by a business user. In a next step, 5006 the user is authenticated which may include comparing the authentication data, such as username, one-time-password, retinal scan data or the like, with corresponding data stored in user profile database or third-party credential service provider or similar technique to those skilled in the art. In a next step, 5007 if the user is a valid user, then the TCPA compliant mobile device 136 is enabled 5008 to send or receive electronic communications through the interaction control server 4218; if the user is determined invalid, the TCPA compliant mobile device is disabled 5009 to send or receive any electronic communication until a successful authentication occurs.

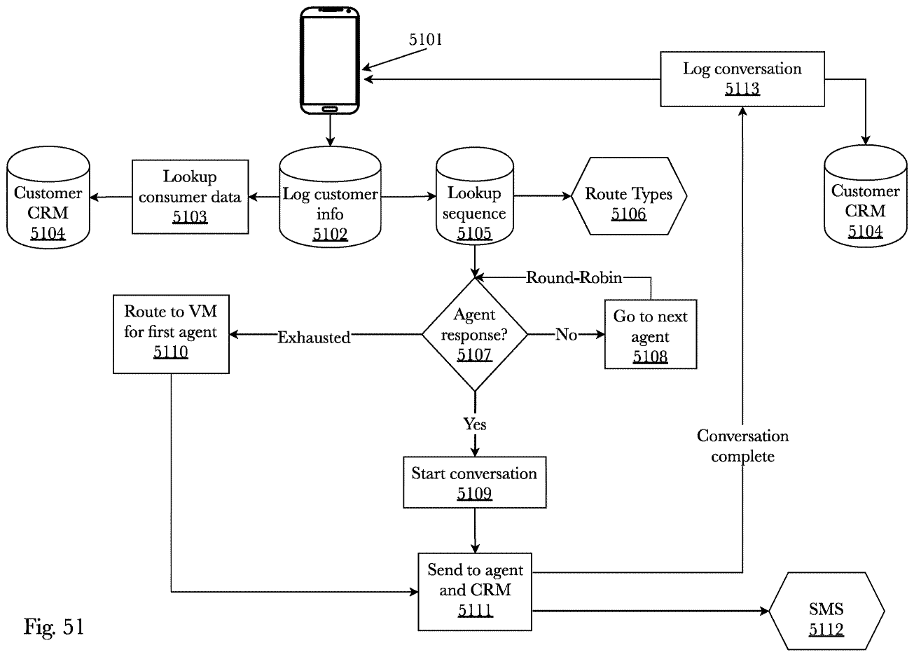

FIG. 51 is a method diagram illustrating routing of communications between a customer and one or more agents, according to an embodiment. A consumer mobile device running an integrated advertisement and communication application 5101 comprises a unique tracking ID. That unique tracking ID allows the advertisement and communication application to log customer information passively and actively 5102 and then is stored in a customer CRM database 5104 to a customer profile matching the unique tracking ID. During the use or various purposes involving the advertisement and communication application, such as a tap text link or interaction, a lookup of the user's data using the unique ID 5103 to better inform sales and business agents with data about the interaction and customer. For example, during the use of a tap text application, a lookup sequence is initiated 5105 whereby agent locations (users) and route types (sequential, round robin, percentage) 5106 are first identified. Agents may be contacted in a prioritized manner according to various parameters such as expertise, location, performance, scheduling, etc. Customer preferences may be considered as to a preferred type of communication regardless of the initial method of contact. Customer data such as location or hobbies may allow agents to strike up more personalized conversations with the customer to form a stronger relationship thus increasing sales. Typically, a round robin is performed 5108 until either an agent responds 5107, or the list of possible agents is exhausted and the customer will be routed to the voicemail on the primary agent's device 5110. Whether or not an agent makes contact with a customer 5109, messages 5112 such as SMS messages will be generated providing content as described in previous figures. Additionally, details and other telemetry will be sent to the agent of highest priority 5111. That agent may be any agent in the chain that actually made contact with the customer, or an agent that received a voicemail from the customer. Upon completion of a conversation, or lack thereof, recorded audio and other details and reports are stored 5113 with the customer's profile in the CRM database 5104. At all times, uniquely identifying contact information, e.g., phone number, email, etc., of the customer and agents are hidden from each other regardless of which communication channel is used. Furthermore, the dynamic routing of an interaction is pulled from the mobile application via a webservice according to one aspect.

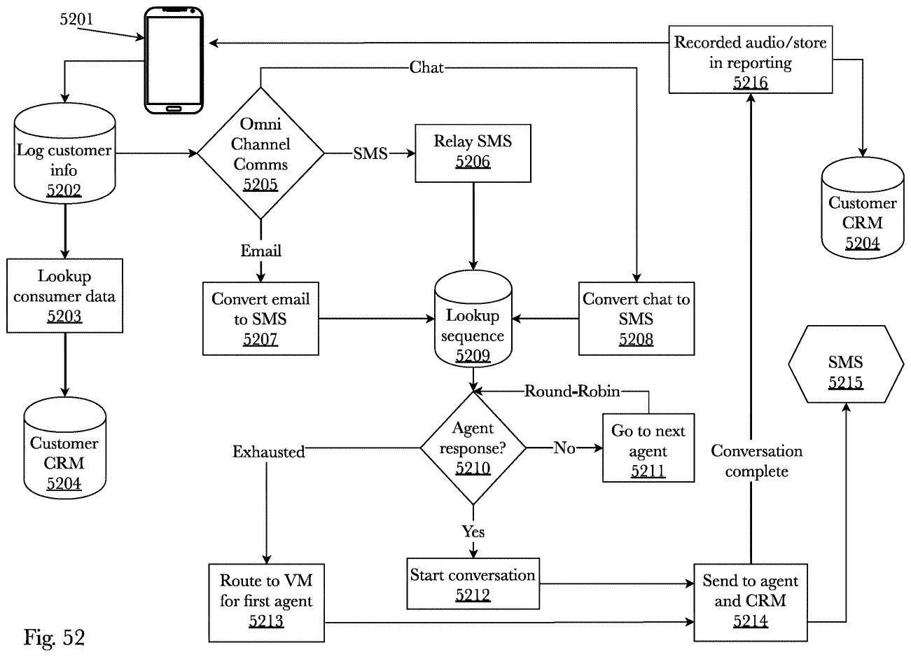

FIG. 52 is a method diagram illustrating omnichannel conversion to SMS between a customer and one or more agents, according to an embodiment. This diagram illustrates a method for converting all omnichannel communications to text. Specifically, when a customer is presented with an option for a chat, in this case meaning a web-based chat, and he or she chooses to chat, all communications from the customer are converted to SMS texts and sent directly to an agent without the agent needing the application. The same may happen for emails, whereby a media translation system converts SMS texts from the agent to emails sent to the customer.

A consumer mobile device running an integrated advertisement and communication application 5201 comprises a unique tracking ID. That unique tracking ID allows the advertisement and communication application to log customer information passively and actively 5202 and then is stored in a customer CRM database 5204 to a customer profile matching the unique tracking ID. During the use or various purposes involving the advertisement and communication application, such as a tap text link or interaction, a lookup of the user's data using the unique ID 5203 to better inform sales and business agents with data about the interaction and customer. For example, during the use of a tap text application, a user may be presented with an option for chat, email, and/or text 5205. If the user chooses email or text, a media translation system will receive, convert 5207, 5208, and facilitate a conversation between the user and an agent. The agent will not need to have any application or special software to participate in the conversation as all incoming communications from the user 5201 are converted to SMS texts for the agent. If the consumer requests communication with an agent via text, the media translation system will relay those messages 5206, keeping both numbers anonymous. A lookup sequence is initiated 5209 whereby agent locations (users) and route types (sequential, round robin, percentage) are first identified. Agents may be contacted in a prioritized manner according to various parameters such as expertise, location, performance, scheduling, etc. Customer preferences may be considered as to a preferred type of communication regardless of the initial method of contact. Customer data such as location or hobbies may allow agents to strike up more personalized conversations with the customer to form a stronger relationship thus increasing sales. Typically, a round robin is performed 5211 until either an agent responds 5210, or the list of possible agents is exhausted and the customer will be routed to the voicemail on the primary agent's device 5213. Whether or not an agent makes contact with a customer 5109, messages 5215 such as SMS messages will be generated providing content as described in previous figures. Additionally, details and other telemetry will be sent to the agent of highest priority 5214. That agent may be any agent in the chain that actually made contact with the customer, or an agent that received a voicemail from the customer. Upon completion of a conversation 5212, or lack thereof, recorded audio and other details and reports are stored 5216 with the customer's profile in the CRM database 5204. At all times, uniquely identifying contact information, e.g., phone number, email, etc., of the customer and agents are hidden from each other regardless of which communication channel is used. Furthermore, the dynamic routing of an interaction is pulled from the mobile application via a webservice according to one aspect.

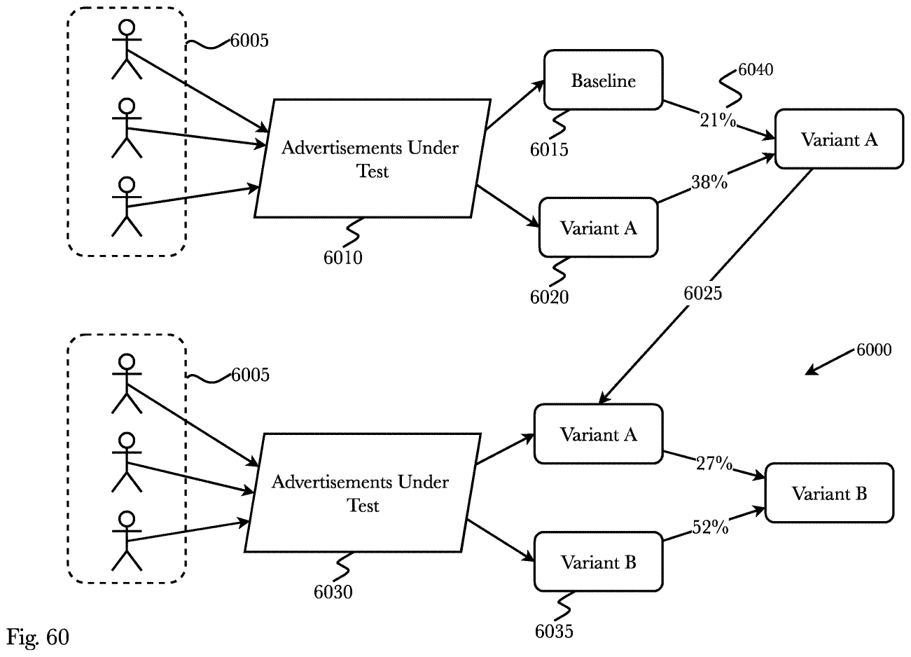

FIG. 60 is a diagram illustrating an exemplary process 6000 for conducting an advertisement variant test, according to an embodiment. Initially, two advertisements to be tested 6010 against each other are chosen by business personnel during ad campaign integration with the multi-channel dynamic advertisement system 5800. The two advertisements can include a baseline advertisement 6015 and a variant advertisement 6020 which may be identical to the baseline ad 6015 with the exception of a single element alteration between the two ads. Baseline advertisement 6015 may have statistical data associated with it, which can be used to compare against with the data collected and associated with the variant ad 6020. The two test ads may be deployed 6010 to a plurality of platforms, channels, and devices dependent upon the test plan associated with the ad campaign data stored in campaign database 2604. Customers 6005 may interact with the two test advertisements in a plurality of ways determined by the type of ad campaign being tested. During the course of test session and after the test session is concluded, analytic module 5806 may calculate the statistical difference 6040 between the two advertisements based on the received data including the customer 6005 interaction details regarding a performance goal metric as described in the test plan data. In this illustration, Variant A 6020 had a 38% conversion rate versus the 21% conversion rate attributed to the baseline ad 6015. Variant A 6020 is statistically better than baseline 6015 and as a result Variant A 6020 may be used 6025 in the next round of variant testing 6030, serving as the baseline to compare against a new Variant B 6035. Variant B 6035 may be based on a suggestion of an element alteration by the alteration module 5804 responsive to the received statistical data 6040 and other data sources such as, for example, test plan data, element data, and third-party data. Again, customers 6005 may participate in the advertisement variant test 6030 with analytic module 5806 gathering and analyzing the data associated with customer interactions with the variants under test. In this second round testing, Variant B 6035 outperforms Variant A in terms of conversion rates, and as a result Variant B 6035 may be used as the baseline ad in the next round of testing. This process can continue iteratively until a test plan goal is achieved, a business personnel ends the testing, or there is no statistically meaningful difference between the performance of the two advertisements under test.

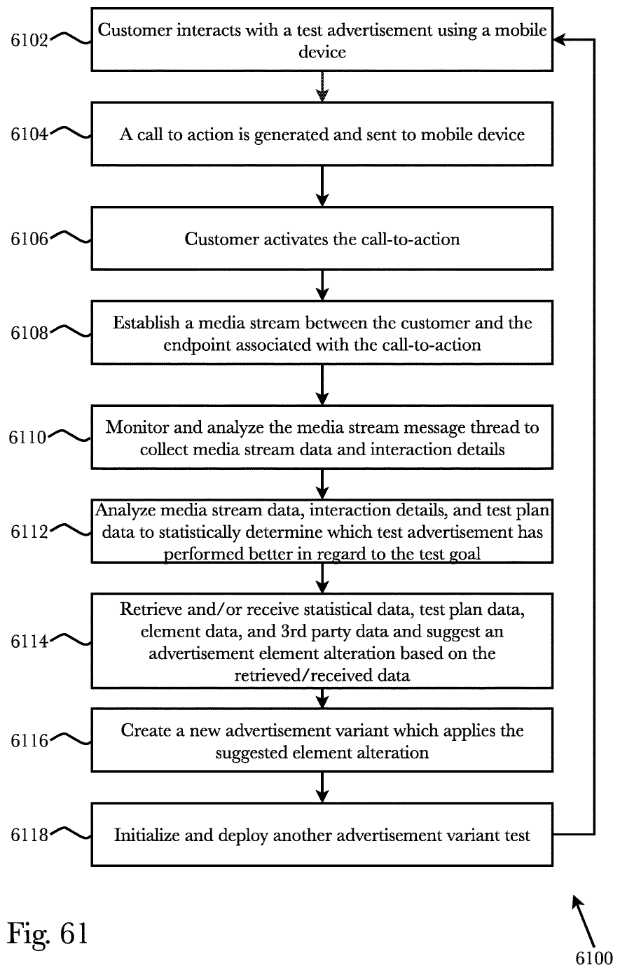

FIG. 61 is a method flow diagram of an exemplary process 6100 for performing advertisement variant testing, according to some embodiments. As a first step, 6102 a customer interacts with a test advertisement using his or her mobile device (e.g., smart phone). Generally, the customer is unaware that the advertisement is a test advertisement. There are plurality of ways (as described in the preceding figures) in which a customer may interact with the ad dependent upon the type of advertisement (e.g., email, website pop-up ad, scanning an NFC code, etc.). Once a customer interaction has occurred, multi-platform adaptive ad campaign manager 2602 may generate a call-to-action that appears in the default text-messaging application of the customer's mobile device 6104. As a next step, 6106 the customer activates the call-to-action by sending the text message that was auto-populated in the customer's default text messaging application. When the customer activates the call to action, omnichannel text-based communicator 160 can establish a media stream between the customer and the endpoint (e.g., business sales associate, customer service, etc.) associated with the call-to-action 6108. Communicator 160 may mask the device details of both the customer mobile device and also format the text-based messages being sent in order to facilitate cross-channel communication between the customer mobile device and the endpoint. A media analyzer 5810 may 6110 monitor and analyze the media stream message thread to collect media stream data and interaction details. As a next step, 6112 analytic module may analyze the media stream data, interaction details, and test plan data to statistically determine which test advertisement has performed better in regard to the test goal. The statistical data may be sent to or retrieved by alteration module 5804 as well as test plan data, element data, and third-party data, and then alteration module may suggest an advertisement element alteration based on the received/retrieved data 6114. Multi-channel dynamic advertisement system 5800 or business personnel may then create a new advertisement variant which applies the suggested element alteration 6116. This new ad variant may be used in the next round of advertisement variant testing 6118 wherein it can be compared and tested against one of the initial two ads which performed better. This process then proceeds back to step 6102 which allows for iterative testing of advertisement variants until a test goal has been achieved and/or a business personnel ends the test.

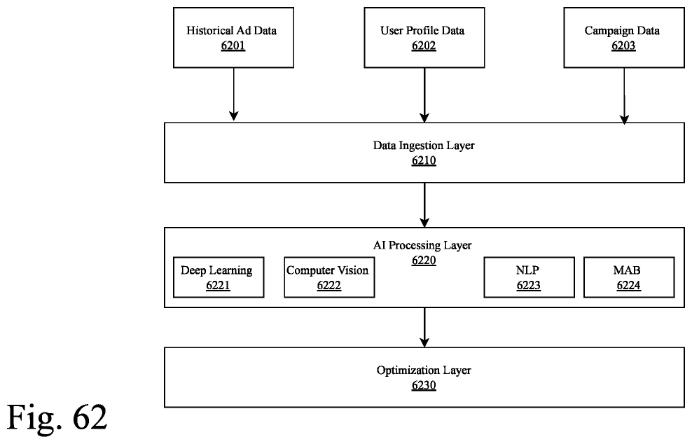

FIG. 62 illustrates a system diagram depicting an exemplary architecture of an AI-powered advertisement variant generation and optimization system. The system's external data sources form the foundation of the architecture, collecting three critical types of information. First, the historical ad data 6201 maintains a detailed repository of past campaign performance, including metrics such as click-through rates, conversion rates, and revenue generated, alongside the creative elements used in these campaigns such as images, copy, and layout configurations. Second, the user profile data 6202 creates comprehensive user personas by aggregating demographic information (such as age, gender, location), behavioral patterns (including browsing habits, purchase history, interaction preferences), and detailed interaction histories (tracking how users have engaged with previous advertisements). Third, the campaign data 6203 maintains specifications for both current and planned advertising initiatives, including targeting parameters, budget allocations, and campaign objectives.

A data ingestion layer 6210 serves as the system's initial processing gateway, handling multiple data streams simultaneously. When data enters the system, this layer performs several critical functions. It first standardizes incoming data formats-for example, converting various date formats to a consistent standard, normalizing numerical values, and standardizing text encodings. The layer then validates data integrity through a series of checks, such as ensuring required fields are present, verifying data types match expected formats, and confirming values fall within acceptable ranges. For instance, conversion rates must logically fall between 0 and 1, while age values might be restricted to realistic ranges. The layer also transforms data into optimized formats for downstream processing, such as creating derived metrics like customer lifetime value or aggregating performance data into hourly and daily summaries.

The AI processing layer 6220 represents the system's analytical core, comprising four specialized modules. The deep learning module 6221 utilizes advanced neural networks with multiple specialized layers to identify patterns in advertising performance. For example, it might recognize that certain image compositions perform better during specific times of day or that particular color schemes resonate more strongly with specific demographic groups. The computer vision module 6222 conducts sophisticated analysis of visual elements, evaluating aspects such as object placement, color harmony, and visual hierarchy within advertisements. The natural language processing (NLP) module 6223 analyzes and optimizes textual content, assessing factors like emotional tone, brand voice consistency, and message clarity. The multi-armed bandit (MAB) module 6224 manages the dynamic testing of advertisement variants, automatically adjusting the distribution of different versions based on real-time performance data.

The optimization layer 6230 functions as the system's decision-making engine, processing inputs from the AI layer to make real-time advertising decisions. This layer implements sophisticated reinforcement learning algorithms that continuously evaluate and adjust advertisement performance. For example, when analyzing a car dealership's advertisement campaign, the system might recognize that luxury vehicle ads perform better during evening hours and automatically adjust scheduling accordingly. The optimization layer also manages bid strategies across multiple advertising channels, dynamically adjusting spending based on performance metrics. If a particular advertisement variant shows strong performance among urban professionals between ages 25-34, the system automatically increases budget allocation for this demographic while testing slight variations to further improve results. The reinforcement learning algorithms maintain a complex state representation of the advertising environment, tracking factors such as time of day, user demographics, device types, and historical performance patterns to make informed decisions about advertisement placement and timing.

The system's architecture enables sophisticated processing at each layer. For instance, when a new advertisement variant is created, the data flows through a series of specialized transformations. The external data sources might identify that images featuring products in real-world settings historically perform better than studio shots. This information flows to the data ingestion layer, where it's normalized and validated. The AI processing layer then analyzes this pattern, using computer vision to identify key elements of successful product placements and natural language processing to optimize accompanying text. Finally, the optimization layer uses these insights to automatically adjust current campaign parameters, such as image selection and placement timing, to maximize performance.

The system maintains bi-directional feedback loop enables continuous refinement of advertising strategies. When an advertisement is deployed, the system tracks multiple performance indicators in real-time. For example, if a retail advertisement receives high click-through rates but low conversion rates, the system analyzes the entire customer journey to identify potential issues. The feedback loop might determine that the advertisement performs well in capturing attention but the landing page messaging doesn't align with user expectations. This information flows back through the system, triggering automatic adjustments to both the advertisement and the landing page content. The system might test variations in product presentation, call-to-action placement, or messaging tone, continuously measuring the impact of each change on overall performance metrics.

The entire system is designed to operate in real-time, processing incoming data and making optimization decisions with minimal latency. The system architecture supports horizontal scaling of individual components to handle increasing data volumes and processing requirements. Each layer implements redundancy and failover capabilities to ensure system reliability and continuous operation.

Real-time operation is achieved through sophisticated system architecture design. The system processes thousands of events per second, making instantaneous decisions about advertisement placement, content, and targeting. For example, when a user visits a website, the system analyzes their profile, behavior patterns, and current context within milliseconds to select the optimal advertisement variant. To maintain this performance at scale, the system implements horizontal scaling capabilities, automatically adding or removing processing capacity based on demand. Each component maintains redundant instances across multiple geographical locations, ensuring continuous operation even if individual components fail. For instance, if a primary processing node experiences issues, the system automatically redirects traffic to backup nodes without service interruption. This architecture ensures that advertisement optimization continues uninterrupted, maintaining high performance and reliability across all advertising channels.

The system employs sophisticated monitoring and alerting mechanisms to maintain optimal performance. Custom dashboards track key performance indicators (KPIs) such as advertisement response times, processing latency, and system resource utilization. If any metrics deviate from expected ranges, automated alerts notify system administrators and trigger predefined response protocols. For example, if advertisement serving latency exceeds 50 milliseconds, the system might automatically redirect traffic to less loaded servers while diagnosing the cause of the slowdown. This proactive monitoring ensures consistent advertisement delivery and optimization across all channels.

Strategic A/B testing capabilities are integrated throughout the system architecture. When testing new advertisement variants, the system intelligently segments user populations and controls exposure to different versions. For instance, when testing a new advertisement format for a luxury car brand, the system might initially expose the variant to a small percentage of users who match the target demographic profile. Performance metrics are continuously monitored, and if the new variant shows statistically significant improvements, the system gradually increases its distribution while continuing to test subtle variations to further optimize performance.

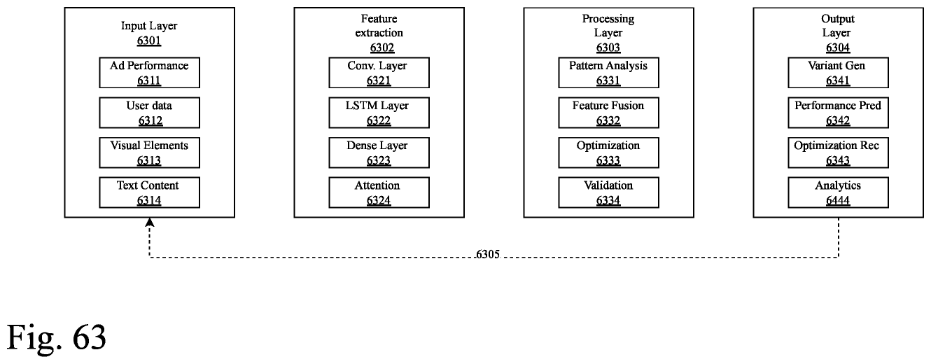

FIG. 63 presents a comprehensive architecture diagram of the deep learning subsystem, which forms the core intelligence of the advertisement variant generation system. The architecture is structured in four distinct but interconnected layers, each specialized for specific aspects of advertisement analysis and optimization. The input layer 6301 serves as the data gateway, while the feature extraction layer 6302 identifies key patterns and characteristics. The processing layer 6303 performs advanced analysis and optimization, and the output layer 6304 generates actionable results. These layers are connected through a sophisticated performance feedback loop 6305 that enables continuous system learning and improvement based on real-world results.

The input layer 6301 functions as a sophisticated data processing gateway, handling multiple streams of advertising-related information simultaneously. For example, when processing data for a luxury automotive campaign, the ad performance metrics 6311 might include historical data showing that video advertisements featuring vehicle interior shots generate 40% higher engagement rates during evening hours. The user data component 6312 processes complex demographic and behavioral information, such as identifying that urban professionals aged 35-45 show higher interest in performance vehicle features during weekday lunch hours. The visual elements processor 6313 analyzes design components like interior lighting angles, exterior color presentations, and vehicle positioning that historically drive engagement. Meanwhile, the text content component 6314 processes advertisement copy, analyzing elements such as “Experience Luxury” versus “Drive Excellence” to determine which messaging resonates most effectively with specific audience segments.

Within the feature extraction layer 6302 specialized neural network components work together to identify and process key advertising elements. The convolutional layer 6321 analyzes visual content with remarkable precision-for instance, identifying that vehicle advertisements showing the car at a three-quarter front angle with a cityscape background typically generate higher engagement rates. The LSTM layer 6322 examines temporal patterns, such as recognizing that luxury vehicle advertisements perform differently during various life events or seasonal periods. The dense layer 6323 combines these insights, creating rich feature representations that might link successful visual elements with specific demographic responses. The attention mechanism 6324 then prioritizes these features, perhaps identifying that for a particular campaign, the vehicle's distinctive grill design draws the most meaningful user engagement.

The processing layer 6303 represents the system's analytical powerhouse. The pattern analysis module 6331 might discover that potential luxury car buyers respond more positively to advertisements showing vehicles in motion during weekday evenings but prefer detailed static shots during weekend browsing. The feature fusion component 6332 combines these insights with other data points, such as weather conditions or local events, to create comprehensive understanding. The optimization module 6333 then processes this unified data to identify ideal combinations-for example, determining that pairing dynamic driving footage with achievement-oriented messaging maximizes engagement among target demographics. The validation component 6334 ensures these insights are statistically significant and reliable, preventing the system from acting on false patterns or temporary anomalies.

The output layer 6304 transforms analyzed data into actionable advertising strategies. The variant generation module 6341 creates new advertisement versions-for instance, automatically generating multiple variants of a luxury vehicle advertisement with different background settings, vehicle angles, and lighting conditions based on learned success patterns. The performance prediction component 6342 then estimates how each variant might perform across different channels and demographics. The optimization recommendations module 6343 might suggest specific improvements, such as adjusting the vehicle's positioning or modifying the call-to-action placement. The analytics module 6344 provides comprehensive performance insights, tracking metrics like engagement rates, conversion patterns, and audience response across different platforms and times.

The performance feedback loop 6305 represents the system's continuous learning mechanism. When an advertisement variant is deployed-for example, a luxury vehicle advertisement showing a silver sedan on a coastal road during sunset-the system tracks its performance across multiple metrics. If this variant achieves a 25% higher engagement rate among certain demographics, the feedback loop automatically analyzes the successful elements (coastal setting, timing, vehicle color) and feeds this information back to the input layer 6301. This creates a self-improving cycle where each advertisement's performance contributes to the system's growing knowledge base, enabling increasingly sophisticated and effective advertisement generation over time. For instance, if the system observes that the coastal road variant performs exceptionally well in urban markets despite its setting, it might generate new variants that explore this contrast between urban life and escape themes.

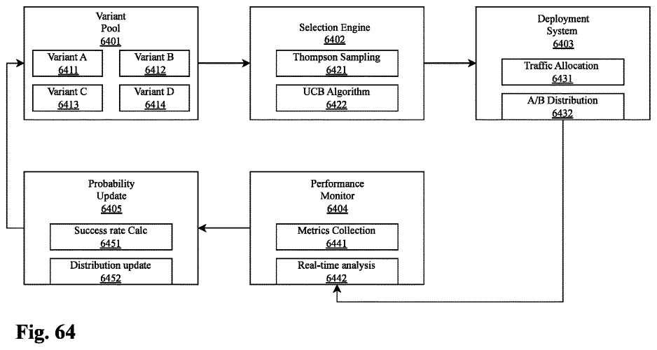

FIG. 64 illustrates a detailed system diagram of the Multi-Armed Bandit (MAB) implementation which functions as the core decision-making engine for advertisement optimization. Think of this system as an intelligent casino dealer who must learn which slot machines (variants) provide the best returns while still exploring new possibilities. The system comprises five interconnected components that work together to continuously optimize advertisement performance. Just as a skilled investor manages a portfolio of stocks, the variant pool 6401 maintains the advertisement options, the selection engine 6402 makes intelligent choices about which variants to deploy, the deployment system 6403 manages distribution, the performance monitor 6404 tracks results, and the probability update module 6405 refines future decisions based on observed performance.

The variant pool 6401 serves as a dynamic repository of advertisement versions, each carefully crafted to test different approaches to customer engagement. For example, in a luxury automotive campaign, Variant A 6411 might showcase a vehicle in an urban setting with professional-focused messaging, while Variant B 6412 presents the same vehicle in a scenic mountain backdrop with lifestyle-oriented copy. Variant C 6413 could test a different approach altogether, focusing on performance specifications with a dark, sophisticated color scheme, and Variant D 6414 might emphasize family-friendly features with a warmer, more inviting design. Each variant is more than just a different image-it represents a carefully constructed combination of visual elements, messaging, layout, and call-to-action placement that together form a cohesive advertising strategy.

The selection engine 6402 employs sophisticated mathematical algorithms to balance the classic exploration-exploitation dilemma. Thompson Sampling 6421 operates like a skilled poker player, using Bayesian probability to make educated guesses about which variants will perform best while maintaining enough uncertainty to explore new options. For instance, if the urban-themed variant shows promising early results among professional audiences, Thompson Sampling might allocate more traffic to this variant while still testing alternatives to avoid missing potentially better options. Meanwhile, the Upper Confidence Bound (UCB) algorithm 6422 acts as a safety net, ensuring that no potentially successful variant is ignored for too long, much like a fund manager ensuring that promising investments aren't overlooked in favor of current top performers.

The deployment system 6403 functions as the sophisticated traffic controller of the advertisement network. The traffic allocation module 6431 makes real-time decisions about which users see which variants. For example, during a new product launch, it might initially distribute traffic evenly across all variants to gather baseline performance data, then gradually shift traffic toward better-performing versions while maintaining enough exposure for newer variants to prove their potential. The A/B distribution component 6432 ensures statistical validity by maintaining appropriate sample sizes-for instance, ensuring that a luxury vehicle advertisement variant receives enough exposure across different demographics and time periods to draw meaningful conclusions about its effectiveness.

The performance monitor 6404 acts as the system's analytical nerve center, constantly gathering and processing performance data. The metrics collection module 6441 tracks comprehensive performance indicators-from immediate engagement metrics like click-through rates to deeper conversion metrics like test drive requests or purchase inquiries. For example, it might discover that while an advertisement variant generates high initial click rates, another variant produces more qualified leads and actual vehicle inquiries. The real-time analysis 6442 processes this information immediately, enabling the system to adapt to changing user responses within minutes rather than days or weeks.

The probability update module 6405 functions as the system's learning center, continuously refining its understanding of what works best. The success rate calculation 6451 processes complex performance metrics to determine true effectiveness. For instance, it might weigh different success metrics differently-giving more importance to actual purchase inquiries than to simple page views. The distribution update 6452 then translates these insights into action, adjusting the probability of each variant being shown based on its proven performance while maintaining enough flexibility to adapt to changing market conditions or user preferences.

Continuous optimization ties all these components together into a seamless, self-improving system. For example, if the system detects that the mountain backdrop variant suddenly starts performing better during weekend evenings, it automatically adjusts distribution patterns to capitalize on this insight. The loop ensures that learning from one deployment immediately influences future selections, creating a constantly evolving and improving advertisement strategy. This might manifest as subtle adjustments to image selections, copy modifications, or even complete strategy shifts based on accumulated performance data and changing user responses.

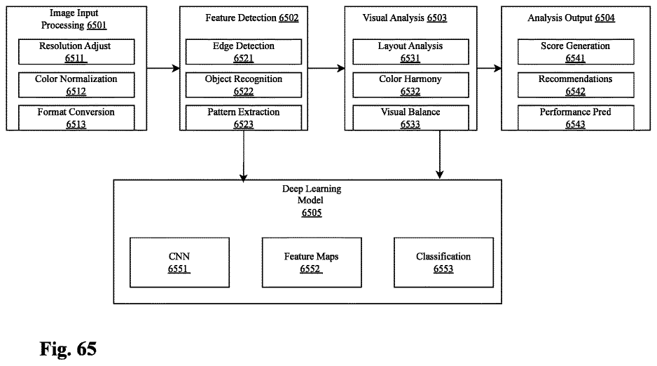

FIG. 65 illustrates a detailed system diagram of the Computer Vision Analysis Pipeline, a system designed to understand and optimize the visual elements of advertisements with the precision of a master artist combined with the analytical power of artificial intelligence. This system, comprising five interconnected components, functions like a highly trained art director with the ability to analyze thousands of visual elements simultaneously. Just as a professional photographer must consider lighting, composition, and subject matter, the system evaluates advertisements through multiple sophisticated lenses, processing everything from basic image characteristics to complex emotional responses triggered by visual elements.

The image input processing module 6501 employs sophisticated computational algorithms for image preparation and standardization. The resolution adjustment 6511 utilizes adaptive interpolation algorithms including bicubic and bilinear methods, dynamically selecting the optimal approach based on image characteristics. When processing a luxury vehicle advertisement, for example, the system implements a multi-stage resolution optimization process. First, it analyzes the input image quality through a statistical evaluation of pixel density and noise levels. Then, it applies an adaptive scaling algorithm that maintains crucial detail fidelity while transforming the image to standardized dimensions. The system implements a dynamic sharpening kernel, calculated as a 3×3 matrix with center-weighted values, which is selectively applied based on edge detection results to enhance fine details such as vehicle trim and surface textures.

The color normalization 6512 implements a sophisticated color space transformation pipeline. This process begins with conversion to the LAB color space, chosen for its perceptual uniformity and ability to separate luminance from chrominance information. The system applies Contrast Limited Adaptive Histogram Equalization (CLAHE) with configurable clip limits and tile grid sizes, typically initialized at 2.0 and 8×8 respectively, to optimize local contrast while preventing over-amplification of noise. Brand-specific color profiles are maintained in lookup tables, enabling precise color matching across different display mediums. The system employs color correction matrices, calculated through least squares optimization, to ensure consistent color representation across various display technologies and lighting conditions.

The format conversion 6513 implements an intelligent format optimization pipeline that adapts image encoding based on deployment context. For JPEG compression, the system utilizes a quality-driven parameter selection algorithm that balances file size against visual fidelity, typically operating within a quality range of 85-95 based on image complexity. PNG compression employs an adaptive compression level selection, with the algorithm analyzing image characteristics to determine optimal compression parameters. Color profile conversion is handled through ICC profile transformation matrices, ensuring color accuracy is maintained during format conversion processes. The system implements buffer-based processing to handle high-resolution images efficiently, utilizing streaming approaches for large-format advertisements.

The feature detection module 6502 employs advanced computer vision algorithms for element identification and analysis. The edge detection 6521 implements a multi-scale edge detection pipeline that begins with Gaussian blur preprocessing, using dynamically calculated kernel sizes based on image resolution. The system employs adaptive thresholding techniques where threshold values are computed using image statistics-specifically, the median pixel intensity value with upper and lower bounds calculated as percentile offsets. Edge enhancement is achieved through morphological operations, utilizing structuring elements optimized for advertising content, with particular attention to maintaining clean edges around primary subjects such as vehicles or products.

The object recognition 6522 implements a hierarchical neural network architecture optimized for advertising content analysis. The system utilizes a cascaded detection framework combining multiple pre-trained convolutional neural networks, each specialized for different aspects of advertisement analysis. The primary detection network employs a modified YOLO (You Only Look Once) architecture with custom anchor boxes optimized for advertising elements, operating at a base resolution of 416×416 pixels with dynamic scaling. The detection pipeline implements non-maximum suppression with an intersection-over-union threshold of 0.45 to eliminate redundant detections. Feature extraction utilizes a ResNet-based backbone network with feature pyramid networks (FPN) to handle multi-scale object detection, particularly crucial for identifying both prominent elements like vehicles and subtle details like brand logos.

The pattern extraction 6523 employs a sophisticated visual pattern analysis system utilizing both supervised and unsupervised learning approaches. The system implements a custom-designed Siamese network architecture for comparing visual patterns across advertisements, with a contrastive loss function optimized for advertising content similarity measurement. Pattern recognition occurs through a multi-stage process: first, the system applies a spatial pyramid pooling layer to handle varying input sizes, followed by regional proposal networks that identify potential pattern regions. These regions undergo feature extraction through densely connected convolutional layers, with features being cached in a hierarchical memory structure for efficient pattern matching. The system maintains a dynamic pattern database that continuously updates based on performance metrics, with patterns being ranked through a weighted scoring algorithm that considers both visual similarity and historical performance data.

The visual analysis module 6503 implements advanced computational aesthetics algorithms. The layout analysis 6531 utilizes a graph-based representation of visual elements, where nodes represent distinct components (such as product images, text blocks, or logos) and edges represent spatial relationships. The system applies spectral clustering algorithms to analyze element grouping, with eigenvalue decomposition used to identify optimal layout patterns. Spatial relationship analysis employs a custom distance metric that considers both Euclidean distance and visual weight of elements. Color harmony 6532 implements color mood mapping through a sophisticated color emotion algorithm that maintains a high-dimensional vector space of color combinations mapped to emotional responses, utilizing principal component analysis for dimensionality reduction and efficient processing.

The visual balance 6533 employs a physics-inspired algorithm that treats visual elements as masses in a 2D space, calculating the visual center of gravity through weighted moment analysis. The system implements a force-directed layout algorithm that considers both geometric and perceptual balance, utilizing a spring-mass model where visual elements are connected by virtual springs whose strengths are determined by semantic relationships and design principles. Balance calculations include consideration of negative space through a void detection algorithm that employs adaptive thresholding and connected component analysis.

The analysis output module 6504 implements a multi-faceted evaluation system. The score generation 6541 utilizes an ensemble of neural networks trained on historical performance data, each specializing in different aspects of visual assessment. The system employs a hierarchical scoring mechanism that combines low-level feature scores (such as contrast ratios and color harmony) with high-level aesthetic metrics (such as compositional balance and visual flow) through a weighted average algorithm where weights are dynamically adjusted based on campaign objectives. Recommendations component 6542 implements a decision tree-based system augmented with reinforcement learning, where each decision node considers multiple visual parameters and their historical impact on advertisement performance.

The deep learning model 6505 employs a state-of-the-art neural architecture with multiple specialized components. The CNN 6551 implements a hybrid architecture combining both residual and dense connections, with skip connections optimized for visual advertising content analysis. The network utilizes depth wise separable convolutions to reduce computational complexity while maintaining feature extraction capability, with channel attention mechanisms implemented through squeeze-and-excitation blocks. The feature maps component 6552 employs adaptive feature pooling with learned pooling kernels, allowing the system to optimize feature extraction based on content type. The classification component 6553 implements a multi-head attention mechanism that allows the system to focus on different aspects of the advertisement simultaneously, with each attention head specialized for specific visual attributes such as composition, color harmony, and brand consistency.

The system's bi-directional data flow ensures continuous learning and improvement, much like a creative team that becomes more effective with each campaign. For example, when the deep learning model identifies a particularly successful visual pattern in a luxury vehicle advertisement, this information flows back through the system, influencing future analysis and recommendations. This creates a constantly evolving understanding of visual effectiveness, where insights from each advertisement analysis contribute to more sophisticated and nuanced recommendations for future campaigns.

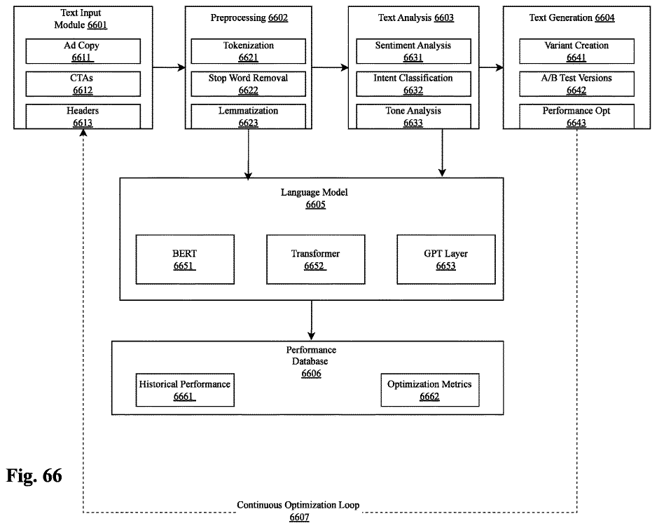

FIG. 66 presents a sophisticated Natural Language Processing Flow system that functions as an intelligent copywriting and optimization engine. Like a team of experienced copywriters, editors, and marketing analysts working in perfect harmony, the system comprises seven specialized components that collaborate to create and refine advertising copy. This comprehensive system combines the creativity of a seasoned copywriter with the analytical precision of artificial intelligence, processing everything from emotional resonance to performance metrics through its various components: text input 6601, preprocessing 6602, text analysis 6603, text generation 6604, language model 6605, performance database 6606, and a continuous optimization loop 6607.

The text input module 6601 implements a sophisticated natural language processing pipeline utilizing advanced text classification algorithms. The ad copy 6611 employs a hierarchical attention network architecture that processes multi-paragraph text through bidirectional GRU (Gated Recurrent Unit) layers, with attention mechanisms operating at both word and sentence levels. The system utilizes custom word embeddings trained on automotive industry corpora, with dimensionality typically set to 300 vectors. The CTAs 6612 implement a specialized LSTM (Long Short-Term Memory) network optimized for action-oriented phrase identification and generation, with an attention mechanism specifically weighted toward imperative verbs and temporal urgency indicators. The headers 6613 utilizes a transformer-based architecture with custom positional encoding optimized for short-form, high-impact text generation.

The preprocessing module 6602 implements advanced text normalization algorithms. The tokenization component 6621 employs a hybrid tokenization approach combining rule-based and statistical methods. It implements a modified WordPiece tokenizer with custom vocabulary optimization for advertising content, utilizing a dynamic programming algorithm for subword tokenization with a vocabulary size of 30,000 tokens. The stop word removal component 6622 maintains a dynamically updated stop word list using TF-IDF (Term Frequency-Inverse Document Frequency) scoring with industry-specific modifications. The lemmatization component 6623 implements a morphological analyzer based on WordNet with custom rules for advertising-specific terms, employing a Conditional Random Field model for part-of-speech tagging with an accuracy threshold of 98%.

The text analysis module 6603 employs state-of-the-art sentiment and intent analysis algorithms. The sentiment analysis component 6631 implements a fine-tuned BERT model with a custom attention head for emotional valence detection. The model utilizes a multi-task learning approach, simultaneously predicting both categorical emotions (confidence, luxury, excitement) and continuous sentiment scores (−1 to 1) through parallel output layers. The intent classification component 6632 employs a hierarchical classification system using an ensemble of specialized classifiers, each trained on specific advertising objectives (awareness, consideration, conversion) with custom loss functions weighted toward business objectives. The tone analysis component 6633 implements a BiLSTM-CRF (Bidirectional Long Short-Term Memory-Conditional Random Field) architecture for sequential tone consistency checking, maintaining brand voice through learned embeddings of tone-specific features.

The text generation module 6604 utilizes advanced generative models with controlled text generation capabilities. The variant creation component 6641 implements a controlled generation framework using conditional VAE-GAN (Variational Autoencoder-Generative Adversarial Network) architecture, allowing for specific attribute conditioning such as tone, length, and marketing objective. The A/B test versions component 6642 employs a multi-armed bandit algorithm with Thompson sampling for variant selection, utilizing a Beta distribution for exploration-exploitation balance. The performance optimization component 6643 implements a reinforcement learning framework with a custom reward function incorporating multiple performance metrics (engagement rates, conversion rates, brand alignment scores).

The language model 6605 utilizes state-of-the-art transformer architectures with domain-specific optimizations. The BERT component 6651 implements a custom pre-trained model on advertising corpus with additional pre-training tasks specific to advertising language understanding. The transformer component 6652 employs a modified attention mechanism with specific positional encodings and a custom vocabulary. The GPT layer 6653 implements autoregressive generation with controlled sampling techniques, utilizing nucleus sampling with a dynamic temperature parameter adjusted based on required creativity levels.

The performance database 6606 implements a sophisticated data storage and retrieval system. The historical performance component 6661 utilizes a time-series optimized database structure with automated feature extraction and indexing capabilities. It implements a custom caching mechanism with an LRU (Least Recently Used) policy optimized for quick retrieval of frequently accessed patterns. The optimization metrics component 6662 employs a real-time analytics engine with stream processing capabilities, utilizing a Lambda architecture for handling both batch and real-time metric updates.

The continuous optimization loop 6607, ensures the system evolves and improves over time, much like a marketing team that refines its approach based on campaign results. When a particular phrase or approach shows exceptional performance-for example, “Elevate Your Journey” generating 50% more test drive requests than “Upgrade Your Drive”-the system automatically incorporates these insights into future copy generation and optimization efforts.

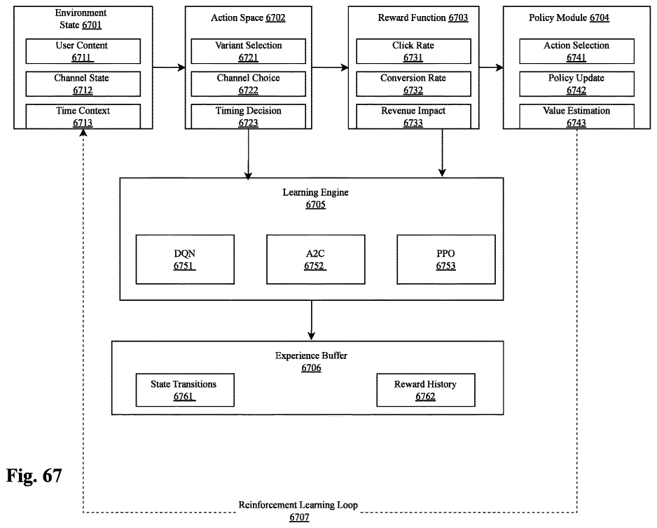

FIG. 67 presents a sophisticated Reinforcement Learning System that operates like an experienced marketing strategist who continuously learns and adapts from every campaign decision. Just as a chess grandmaster improves through analyzing thousands of games, this system comprises seven interconnected components that work together to optimize advertisement performance through real-world experience. The environment state module 6701 serves as the system's situational awareness, the action space module 6702 defines possible strategic moves, the reward function module 6703 evaluates success, the policy module 6704 makes strategic decisions, the learning engine 6705 implements advanced learning algorithms, the experience buffer 6706 maintains historical knowledge, and the reinforcement learning loop 6707 ensures continuous improvement.

The environment state module 6701 implements a sophisticated state representation system utilizing advanced neural network architectures. The user context component 6711 employs a hierarchical feature extraction pipeline using deep neural networks with multiple attention layers. The system maintains a dynamic state vector of dimension 512, encoding user behavioral patterns through a combination of sequential data processed by LSTM layers (for temporal patterns) and transformer encoders (for contextual understanding). The channel state component 6712 implements a real-time monitoring system utilizing stream processing with Apache Kafka, maintaining sliding windows of channel performance metrics with a time-decay factor of 0.95. The time context component 6713 employs a cyclical encoding mechanism for temporal features, utilizing sine and cosine transformations to capture both linear and periodic time patterns with a resolution of 5 minutes.

The action space module 6702 implements a structured decision space using advanced probabilistic models. The variant selection 6721 utilizes a hierarchical action representation with continuous action spaces mapped through a Gaussian mixture model with 8 components, allowing for smooth interpolation between creative variants. The channel choice component 6722 implements a constrained optimization framework using mixed-integer programming with dynamic constraint generation based on channel availability and budget allocation. The timing decision component 6723 employs a temporal decision model using recurrent neural networks with attention mechanisms, processing time-series data at multiple scales (hourly, daily, weekly) with a look-back window of 90 days.

The reward function module 6703 implements sophisticated multi-objective optimization algorithms. The click rate 6731 utilizes a custom-designed reward shaping function incorporating both immediate and delayed rewards, with temporal difference learning using a discount factor γ=0.95. The conversion rate 6732 implements a hierarchical Bayesian model for conversion attribution, using Monte Carlo sampling with 10,000 iterations to estimate true conversion probabilities. The revenue impact 6733 employs a deep Q-network architecture with dueling networks, separately estimating state values and action advantages with a target network update frequency of 1000 steps.

The policy module 6704 implements state-of-the-art policy optimization algorithms. The action selection component 6741 utilizes a Soft Actor-Critic architecture with automatic entropy tuning, maintaining a temperature parameter α that balances exploration and exploitation. The policy update 6742 implements Proximal Policy Optimization with a clipping parameter ε=0.2, using a trust region approach to ensure stable policy updates. The value estimation component 6743 employs a critic network with double Q-learning to reduce overestimation bias, utilizing a target network with soft updates (τ=0.005). This functions like an expert marketing director, making strategic decisions based on accumulated knowledge. The action selection component 6741 might choose to show performance-focused advertisements to users who frequently view sports car content, while the policy update 6742 continuously refines these decision rules based on results. The value estimation 6743 predicts outcomes-for example, estimating that showing a particular advertisement variant to a specific user segment during evening hours has a 75% higher likelihood of generating a dealer inquiry.

The learning engine 6705 implements advanced reinforcement learning algorithms. The DQN component 6751 utilizes a Rainbow DQN architecture combining multiple improvements including prioritized experience replay (α=0.6, β=0.4), noisy networks for exploration, and distributional RL with 51 atoms for value distribution. The A2C component 6752 implements an advantage actor-critic architecture with an n-step return (n=5) and parallel environment sampling using 16 concurrent environments. The PPO component 6753 employs a clipped surrogate objective with adaptive KL divergence penalty (target KL=0.01) and generalized advantage estimation (λ=0.95). This represents the system's artificial intelligence brain, implementing sophisticated learning strategies. The DQN component 6751 might learn complex patterns in user behavior, such as the relationship between ad interaction timing and purchase intent. The A2C component 6752 balances immediate results with long-term strategy-perhaps sacrificing immediate clicks to build stronger brand engagement. The PPO component 6753 ensures stable learning by making gradual, controlled adjustments to advertising strategies rather than dramatic shifts that could disrupt campaign performance.

The experience buffer 6706 implements an advanced memory system. The state transitions 6761 utilizes a prioritized experience replay buffer with a capacity of 1 million transitions, implementing sum-tree data structure for efficient sampling with importance sampling correction. The reward history 6762 employs a hierarchical storage system combining fast in-memory caching for recent experiences (last 24 hours) with distributed persistent storage for long-term learning, utilizing a custom compression algorithm achieving 10:1 compression ratio while maintaining retrieval latency under 10 ms. This serves as the system's institutional memory. For example, The state transitions component 6761 might track how user interactions evolve-noting that users who engage with feature-focused advertisements often progress to pricing-focused content before making dealer inquiries. The reward history 6762 maintains detailed records of success metrics, creating a rich dataset that informs future decision-making.

The reinforcement learning loop 6707 implements a distributed training architecture utilizing parameter servers for synchronous updates across multiple training nodes. The system employs importance sampling with a prioritized replay buffer of size 2\hat{ }20, with experiences prioritized by their temporal-difference error. The loop maintains a target network updated every 10,000 steps using a soft update mechanism (τ=0.001), with gradient updates performed using the Adam optimizer with a learning rate of 3e-4 and gradient clipping at a maximum norm of 10.0. The reinforcement learning loop ties everything together into a constantly improving system. For instance, if the system discovers that users who view vehicle interior features during evening hours are 50% more likely to schedule test drives, this information flows back through the entire system, influencing future decisions about content timing, variant selection, and targeting strategies. This creates a virtuous cycle where each interaction contributes to smarter, more effective advertising strategies.

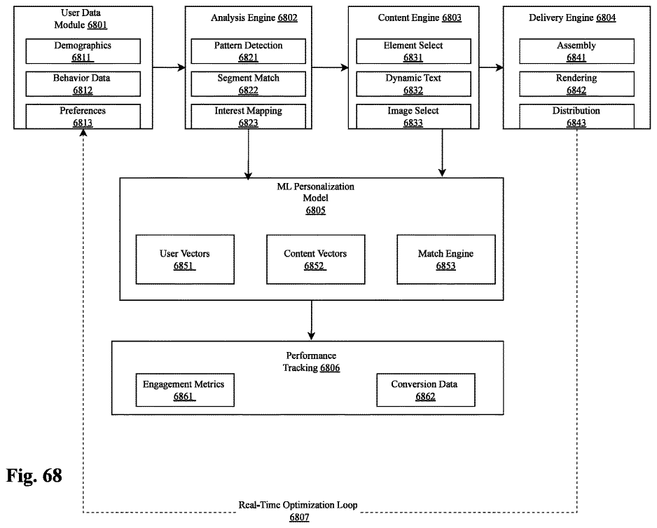

FIG. 68 showcases the Real-Time Personalization Engine's sophisticated architecture, designed to deliver highly customized advertising experiences with the precision of a personal shopper combined with the processing power of advanced artificial intelligence. Much like how a skilled retail consultant remembers customer preferences and adapts recommendations in real-time, this system processes vast amounts of data to create uniquely tailored advertising experiences for each user. The system's seven core components work in harmony, much like an orchestra, each playing its crucial role in creating a personalized advertising symphony.

The user data module 6801 functions as the system's memory bank, collecting and organizing user information with the thoroughness of a master biographer. The demographics 6811 utilizes a distributed data processing system built on Apache Spark, maintaining user profiles in a high-dimensional feature space (dimension=1024) with real-time update capabilities. The system implements probabilistic data structures (Bloom filters with false positive rate of 0.01) for efficient feature lookup, and employs locality-sensitive hashing (LSH) with 100 hash functions for rapid similarity matching. It maintains detailed profiles of user characteristics—for instance, in a luxury automotive campaign, it might track not just age and income levels, but also lifestyle indicators such as frequent travel patterns or high-end retail preferences. The behavior data 6812 operates like an attentive personal assistant, monitoring how users interact with various advertisements—perhaps noting that a particular user consistently engages with performance vehicle features during evening browsing sessions. It implements a real-time event processing system using Apache Kafka streams with custom serializers, maintaining sliding windows of user activity (window size=24 hours, slide interval=5 minutes). The preferences 6813 utilizes a collaborative filtering architecture combined with matrix factorization (SVD with 100 latent factors), implementing incremental updates using stochastic gradient descent (learning rate=0.01, regularization=0.001). This acts as a sophisticated preference learning system, recording and prioritizing user interests, such as noting a strong affinity for environmentally conscious luxury vehicles or specific interior design features.

The analysis engine 6802 implements advanced pattern recognition algorithms. This operates like an expert behavioral psychologist, processing user data to uncover meaningful patterns and preferences. The pattern detection 6821 employs a hierarchical temporal memory network with custom cortical learning algorithms, processing temporal sequences with variable-order Markov chains (order-3 to order-5). This functions similarly to a skilled detective, identifying subtle but significant behavioral trends-for example, recognizing that a user consistently researches vehicle features during lunch breaks and books test drives on weekends. The segment match component 6822 utilizes a combination of supervised and unsupervised learning approaches, implementing a deep clustering network (DCN) with autoencoder architecture (encoding dimensions: 512→256→128) and soft assignment matrix. This works like an experienced marketing strategist, categorizing users into meaningful groups such as “eco-conscious luxury seekers” or “performance enthusiasts.” The interest mapping component 6823 implements a graph neural network with attention mechanisms, representing user interests in a knowledge graph with TransE embeddings (dimension=200) and GraphSAGE convolutions. This connects behaviors to specific content preferences, much like a matchmaker pairing compatible partners.

The content engine 6803 implements a sophisticated content selection and generation system. This serves as a master curator, selecting and customizing content with the precision of a personal stylist. The element select component 6831 utilizes a multi-armed bandit algorithm with Thompson sampling (β distribution priors), incorporating contextual information through a deep neural network (4 layers, 256 units each). This chooses content elements as carefully as a designer selecting fabric swatches, ensuring each piece aligns with user preferences. The dynamic text component 6832 implements a controlled language generation model based on GPT architecture (12 layers, 768 hidden size) with custom attention heads for style control. This crafts personalized messaging like a skilled copywriter adapting their tone for different audiences -perhaps emphasizing performance specifications for enthusiast segments while focusing on comfort features for luxury-oriented users. The image select 6833 employs a deep metric learning approach using a Siamese network architecture with triplet loss (margin=0.2), training on user engagement patterns. The image select 6833 functions like a professional photographer, selecting visual content that resonates with each user's demonstrated preferences, such as showing vehicles in urban settings for city-dwelling professionals or scenic backgrounds for adventure-seeking segments.

The delivery engine 6804 operates like a sophisticated publishing house, ensuring content reaches users in optimal formats across all channels by implementing real-time content distribution systems. The assembly component 6841 works like a master editor, combining various elements into cohesive presentations by utilizing a dynamic programming algorithm for content layout optimization, implementing a constraint satisfaction solver with beam search (beam width=10). The rendering component 6842 employs a parallel processing pipeline with WebGL acceleration, maintaining a distributed cache system (Redis) with LRU eviction policy, which functions like a production department, ensuring content displays perfectly across all devices and platforms. The distribution component 6843 acts as a skilled distribution manager, by implementing a custom scheduling algorithm using reinforcement learning with a DQN architecture (double Q-learning, prioritized replay buffer size=1M), coordinating delivery across multiple channels from social media to email to display advertising.

The ML personalization model 6805 serves as the system's artificial intelligence brain, implementing sophisticated matching algorithms with the insight of a veteran marketing expert. The user vectors 6851 utilizes deep embedding networks trained with contrastive loss (temperature=0.07), maintaining dynamic embeddings updated through online learning (mini-batch size=64). This maintains detailed user profiles encoded as mathematical representations. The content vectors 6852 implements a multi-modal encoding system combining BERT for text (768 dimensions) and ResNet for images (2048 dimensions), with a fusion layer (1024 dimensions) to encode content characteristics. The match engine 6853 employs attention mechanisms with scaled dot-product attention (temperature scaling=√dk) and multi-head attention (8 heads) in order to function like an expert matchmaker, using these mathematical representations to identify optimal content-user pairings with unprecedented precision.

The performance tracking module 6806 operates like a team of expert analysts, continuously monitoring campaign effectiveness. The engagement metrics 6861 utilizes a stream processing architecture with Apache Flink, maintaining real-time aggregations with tumbling windows (window size=1 minute) and custom state backends to track user interactions with the thoroughness of a research scientist. The conversion data 6862 implements a probabilistic attribution model using Bayesian networks with Monte Carlo sampling (10,000 samples), maintaining confidence intervals for all metrics. This monitors business outcomes like a skilled business analyst, connecting user engagement to actual sales and revenue metrics.

The real-time optimization loop 6807 implements a distributed feedback system using parameter servers with asynchronous updates. The system maintains a replay buffer of recent experiences (buffer size=100,000) with prioritized sampling based on temporal-difference error. The optimization process utilizes Proximal Policy Optimization (PPO) with clipped surrogate objective (ε=0.2) and adaptive KL divergence penalty (target KL=0.01). The system implements experience replay with importance sampling (β annealing from 0.4 to 1.0) and maintains target networks updated every 1000 steps (τ=0.005). The real-time optimization loop 6807 ties these components together into a continuously learning system, much like a team that becomes more effective with each campaign. For example, when the system observes that personalized vehicle feature highlights result in higher test drive bookings for certain user segments, it automatically adjusts content selection and delivery strategies to capitalize on this insight. This creates a constantly evolving personalization engine that becomes increasingly effective at matching content to user preferences and behaviors.

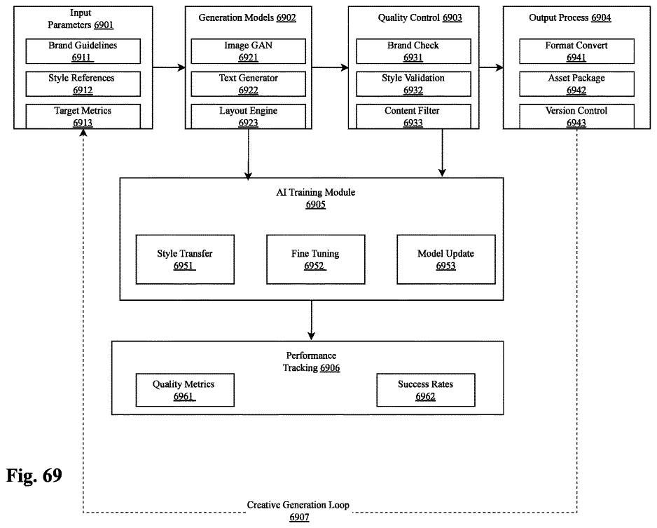

FIG. 69 presents the sophisticated architecture of the Generative AI Creative System, which functions as an AI-powered creative agency capable of automatically generating and optimizing advertisement content. Much like a full-service advertising agency staffed with creative directors, designers, copywriters, and quality assurance specialists, this system orchestrates the entire creative process through seven specialized components that work in concert to produce high-quality, brand-compliant advertising content.

The input parameters module 6901 serves as the system's creative brief manager, establishing the foundational guidelines for content generation. The brand guidelines 6911 utilizes a hierarchical constraint satisfaction system built on a graph database (Neo4j) with real-time rule validation. The system maintains brand specifications in a structured knowledge graph with embedded tensors (dimension=512) for visual and textual elements, implementing fast similarity search using FAISS (Facebook AI Similarity Search) with IVF (Inverted File Index) and 100,000 centroids. This functions like a brand guardian, ensuring every generated element adheres to established standards-for example, in a luxury automotive campaign, it might enforce specific logo placement rules, maintain consistent color schemes (such as ensuring the exact shade of Mercedes-Benz silver), and preserve brand voice characteristics. The style references 6912 employs a multi-modal neural network architecture combining ResNet-152 for visual analysis and BERT-large for textual understanding, with cross-attention mechanisms (16heads) for style extraction. This operates like an art director's mood board, providing creative direction through example materials—perhaps referencing successful past campaigns or competitor analyses. The target metrics 6913 implements a Bayesian optimization framework for objective setting, using Gaussian Processes with Matérn kernel (ν=2.5). This acts as a strategic planner, setting specific performance objectives such as engagement rates, click-through targets, or conversion goals for different audience segments.

The generation models 6902 function as the system's creative studio, producing various advertisement elements with artificial intelligence precision. The image GAN 6921 utilizes a StyleGAN3 architecture with adaptive discriminator augmentation (ADA) and path length regularization (λ=2), training at 1024×1024 resolution with a batch size of 32. The image GAN operates like a skilled digital artist, generating visual elements by learning from thousands of successful advertisements-for instance, creating multiple versions of vehicle imagery in different environments, lighting conditions, and angles. The text generator component 6922 implements a custom GPT-3 architecture fine-tuned on advertising copy (175B parameters) with controlled generation using PPLM (Plug and Play Language Model) for maintaining brand voice (attribute classifiers trained with 98% accuracy). This works like an experienced copywriter, crafting compelling advertising copy that resonates with target audiences while maintaining brand voice consistency. The layout engine component 6923 employs a constraint-based optimization system using mixed integer programming with custom neural guides trained on historical advertisement layouts, which functions as an expert graphic designer, arranging these elements into visually appealing compositions that guide the viewer's eye and emphasize key messages.

The quality control module 6903 implements advanced validation algorithms that serves as the system's review board, meticulously examining all generated content. The brand check 6931 utilizes a multi-task deep neural network performing simultaneous checks across 50 brand compliance metrics, with attention mechanisms focusing on critical brand elements (logo detection precision=0.99) operating like a brand compliance officer, verifying that every element aligns with brand guidelines-from proper logo usage to consistent messaging tone. The style validation 6932 implements an aesthetic quality assessment model using a deep siamese network trained on paired comparisons (margin=0.3), which functions as an art director, ensuring the aesthetic quality meets professional standards. The content filter 6933 employs a BERT-based content moderation system with custom toxic content detection (F1 score=0.95), which screens for inappropriate elements or potentially controversial content that could damage brand reputation.

The output processing module 6904 acts as the system's production department, preparing approved content for deployment across various platforms. The format conversion component 6941 utilizes an intelligent resizing network with content-aware cropping, implementing a saliency detection model (U-Net architecture) for preserving key visual elements. This functions like a technical production team, adapting content for different medium requirements-ensuring an advertisement looks as impressive on a mobile device as it does on a desktop billboard. The asset package component 6942 employs a distributed asset management system with content-addressed storage (IPFS) and versioning. This works like a project manager, organizing and bundling related elements for efficient deployment. The version control 6943 implements a specialized Git-like version control system optimized for binary assets with deduplication (achieving 80% storage efficiency). This maintains a detailed history of content iterations, much like a digital librarian tracking creative evolution.

The AI training module 6905 operates as the system's learning and development department, continuously improving its creative capabilities. The style transfer 6951 utilizes an adaptive instance normalization network with custom style attachment loss (λstyle=10.0, λcontent=1.0). This functions like an artistic apprentice, learning to replicate and adapt successful visual styles from high-performing advertisements. The fine-tuning component 6952 implements gradient-based meta-learning (MAML) with first-order approximation and task-specific adaptation (α=0.01). This works like a creative director, optimizing the system's understanding of what makes effective advertising. The model update 6953 employs continual learning techniques with elastic weight consolidation (λ=5000) to prevent catastrophic forgetting. This acts as a knowledge manager, incorporating new insights and trends into the system's creative capabilities.

The performance analysis module 6906 serves as the system's analytics team, rigorously evaluating the effectiveness of generated content. The quality metrics component 6961 utilizes a multi-modal quality assessment framework combining technical metrics (PSNR, SSIM) with perceptual metrics using a learned quality model (correlation with human judgments r=0.95). This functions like a quality assurance specialist, measuring various aspects of output quality—from technical parameters to creative effectiveness. The success rates 6962 implements a multi-armed bandit system with contextual Thompson sampling (α=1.0, β=1.0) for performance tracking. This operates like a performance analyst, tracking how well generated content meets its objectives across different channels and audiences.

The creative generation loop 6907 implements a distributed feedback optimization system. The system maintains an experience replay buffer (size=500,000) with prioritized sampling based on novelty and performance metrics. The optimization process utilizes Soft Actor-Critic (SAC) with automatic entropy tuning (target entropy=−dim(A)) and twin delayed DDPG (TD3) for stable policy updates. The system implements adaptive batch sizes based on gradient noise scale, with synchronous updates across multiple training nodes using parameter servers. Performance metrics are tracked using a hierarchical time-series database (InfluxDB) with automatic downsampling and retention policies. This ties these components together into a continuously improving creative ecosystem. For example, when the system generates a particularly successful luxury vehicle advertisement that achieves exceptional engagement rates, this information flows back through the system, influencing future creative decisions. If a specific visual style or messaging approach proves especially effective with certain audience segments, the system automatically incorporates these insights into its generation parameters, creating an ever-evolving and improving creative process.

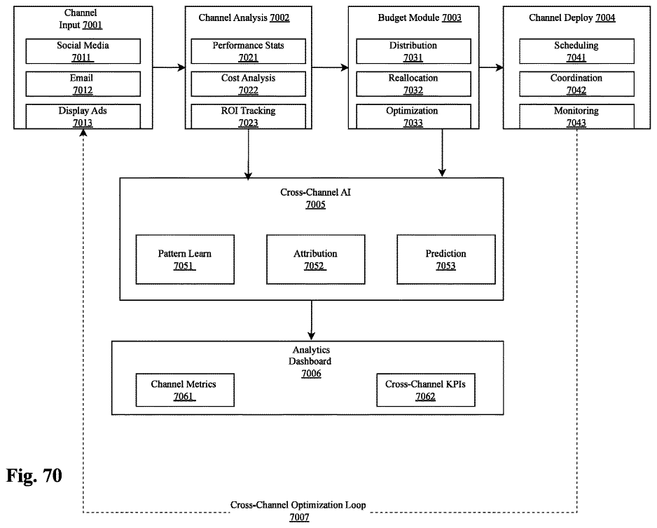

FIG. 70 presents the sophisticated Cross-Channel Optimization System, which functions like a master orchestra conductor coordinating multiple instruments to create a harmonious advertising performance across diverse platforms. This system operates with the precision of a global trading desk, managing and optimizing advertising efforts across various channels while ensuring each platform works in concert with others to maximize overall campaign effectiveness.

The channel input module 7001 serves as the system's command center, orchestrating multiple advertising channels with the expertise of a seasoned media director. The social media 7011 functions like a specialized social media agency, processing platform-specific data from channels like Instagram, Facebook, and LinkedIn-for example, tracking how luxury vehicle advertisements perform differently across professional networking sites versus lifestyle-focused platforms. This utilizes a distributed stream processing architecture built on Apache Kafka with custom connectors for each platform (Instagram, Facebook, LinkedIn), implementing real-time data ingestion with protocol buffers for efficient serialization. The system maintains platform-specific adapters with rate limiting (400 requests/minute) and automatic retries (exponential backoff, max_retries=5). The email 7012 employs an SMTP/IMAP integration layer with custom event processing using RabbitMQ for message queuing (queue size=100,000 messages). This operates like an email marketing specialist, managing campaign flows and response patterns perhaps noting that vehicle feature announcements generate higher engagement rates on Monday mornings. The display ads 7013 implements a real-time bidding system using WebSocket connections with binary message protocol, maintaining bid response latency under 100 ms. This works like a programmatic advertising expert, coordinating real-time bidding and placement strategies across various ad networks and websites frequented by target audiences.

The channel analysis module 7002 functions as the system's performance intelligence unit, evaluating channel effectiveness with the precision of a financial analyst. The performance stats component 7021 utilizes a time-series analytics engine built on TimescaleDB with custom aggregation functions (window size=15 minutes). The system implements real-time statistical analysis using welch's t-test for performance comparison across channels (confidence level=0.95), which tracks comprehensive engagement metrics-for instance, comparing how the same luxury vehicle advertisement performs across different platforms, noting that video content might drive higher engagement on social media while detailed specifications generate better results in email campaigns. The cost analysis 7022 employs a gradient boosting model (XGBoost, max_depth=8) for spend optimization, this operates like a financial controller, monitoring spending efficiency across channels, while the ROI tracking 7023 implements a probabilistic attribution model using Bayesian networks (MCMC sampling, 10,000 iterations). ROI tracking functions as an investment analyst, calculating and comparing return on investment across different platforms and campaign types.

The budget module 7003 acts as the system's treasury department, managing resource allocation with the sophistication of an investment portfolio manager. The distribution component 7031 utilizes a hierarchical Thompson sampling approach with Gaussian Process priors (kernel=Matérn, ν=2.5) for initial budget allocation, which functions like a strategic financial planner, making initial budget allocations based on historical performance and market opportunities-for example, allocating higher budgets to channels that historically perform well during specific seasons or events. The reallocation 7032 implements a deep reinforcement learning model using TD3 (Twin Delayed DDPG) with custom action space for budget adjustments (action bounds=[−0.2, 0.2]). This operates like a real-time trader, dynamically adjusting spending based on performance signals, while the optimization 7033 employs a constrained optimization framework using mixed-integer linear programming with dynamic constraint generation, which works like a portfolio optimizer, ensuring maximum efficiency across all advertising channels.

The channel deployment module 7004 serves as the system's operations center, coordinating campaign execution with military precision. The scheduling component 7041 utilizes a custom scheduling algorithm based on genetic programming (population size=1000, generations=50) with multi-objective optimization, which functions like a master event planner, managing the timing of advertisements across channels-for instance, coordinating a luxury vehicle launch campaign to begin with teaser content on social media, followed by detailed email campaigns, and supported by targeted display advertising. The coordination 7042 implements a message passing interface using gRPC for cross-channel synchronization (buffer size=1024 MB), which operates like a brand manager, ensuring messaging remains consistent yet optimized for each channel, while the monitoring component 7043 employs a distributed tracing system using OpenTelemetry with custom sampling strategies (sampling rate=0.1). This works like a real-time surveillance system, tracking performance across all channels simultaneously.

The cross-channel AI module 7005 operates as the system's strategic intelligence unit, implementing sophisticated optimization strategies. Pattern learning 7051 utilizes a graph neural network architecture (GraphSAGE with 3 layers) for cross-channel pattern detection. This functions like a market researcher, identifying complex trends across channels-such as recognizing that customers who engage with social media ads during evening hours are more likely to convert through email campaigns the following morning. Attribution 7052 implements a deep learning-based attribution model using attention mechanisms (8 heads) and sequential modeling (Transformer architecture, 6 layers). This works like a customer journey analyst, tracking how users move between channels before converting, while the prediction component 7053 employs an ensemble of forecasting models combining LSTM networks (hidden size=256) with Prophet for trend analysis, which operates like a forecasting specialist, predicting future performance patterns across channels.

The analytics dashboard 7006 serves as the system's command and control center, providing comprehensive performance visualization. The channel metrics component 7061 utilizes a custom data streaming pipeline built on Apache Flink with exactly-once processing guarantees. The system implements materialized views for fast query performance (refresh interval=1 minute) and maintains a multi-level caching system (Redis) for frequently accessed metrics. This functions like a specialized reporting system, displaying detailed performance data for each channel-from social media engagement rates to email open rates to display ad click-through rates. The cross-channel KPIs component 7062 employs dimensional reduction techniques (t-SNE) for visualization of high-dimensional performance data, which operates like an executive dashboard, showing integrated performance measures that reveal how channels work together to drive overall campaign success.

The cross-channel optimization loop 7007 implements a distributed reinforcement learning system using A3C (Asynchronous Advantage Actor-Critic) with multiple worker processes (16 workers). The system maintains a shared experience replay buffer (size=1M) with prioritized sampling based on TD-error. The optimization process utilizes PPO (Proximal Policy Optimization) with clipped surrogate objective (ε=0.2) and adaptive KL penalty. The system implements multi-gpu training using Horovod for distributed optimization, with synchronous parameter updates every 64 steps. Performance tracking utilizes a custom metrics pipeline with automatic anomaly detection (isolation forest, contamination=0.01). The cross-channel optimization loop 7007 connects all components into a continuously learning and improving system. For example, when the system detects that social media advertisements for a luxury SUV generate higher engagement rates when coordinated with targeted email campaigns, it automatically adjusts budget allocations and timing to capitalize on this synergy. This creates a self-improving cycle where insights from one channel inform and enhance performance across all channels, leading to increasingly efficient and effective multi-channel campaigns.

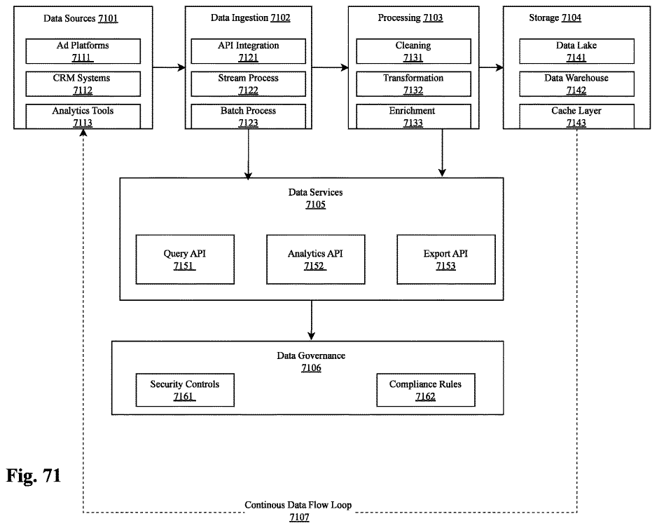

FIG. 71 presents the sophisticated Data Flow Architecture, functioning as the nervous system of the entire advertising intelligence platform. Like a modern city's infrastructure system managing water, electricity, and communications simultaneously, this architecture orchestrates the flow of advertising data from multiple sources through various processing stages to deliver actionable insights.

The data sources module 7101 operates as the system's sensory network, collecting information from diverse platforms with the thoroughness of a global news organization. The ad platforms 7111 utilizes a distributed event collection system built on Apache Kafka (partition size=1 GB, retention=7 days) with custom connectors implementing OAuth2 authentication and rate limiting (max_requests=1000/minute). For example, this functions like a specialized data journalist, gathering detailed performance data from various advertising channels-for instance, tracking how luxury vehicle advertisements perform across social media, search engines, and display networks. The CRM systems 7112 employs a real-time synchronization framework using Change Data Capture (CDC) patterns with Debezium, maintaining consistency through exactly-once delivery semantics. For example, this works like a customer relations specialist, maintaining comprehensive profiles of customer interactions and preferences-perhaps noting that certain customers consistently engage with performance vehicle content across multiple platforms. The analytics tools 7113 implements a custom ETL pipeline using Apache Airflow with directed acyclic graphs (DAGs) for workflow orchestration (max_concurrent_tasks=32). For example, this serves as a master statistician, aggregating performance metrics to reveal patterns such as the correlation between ad exposure frequency and test drive requests.

The data ingestion module 7102 functions as the system's intake processing center, managing data collection with the efficiency of a modern automated factory. The API integration 7121 utilizes a microservices architecture built on gRPC (buffer size=4 MB) with circuit breakers (failure threshold=5%, reset timeout=30 s) for fault tolerance. This operates like a universal translator, enabling seamless communication with external systems-from social media platforms to dealership management systems. The stream process 7122 implements a real-time processing engine using Apache Flink with event-time processing and watermarks (max_lateness=5 minutes). For example, this works like a real-time traffic controller, handling continuous data flows such as live engagement metrics and bid adjustments. The batch process 7123 employs distributed processing using Apache Spark with dynamic resource allocation (executor memory=16 GB, max executors=100). For example, this functions like a warehouse manager, coordinating larger periodic data imports such as monthly campaign performance reports or customer satisfaction surveys.

The processing module 7103 serves as the system's data refinement facility, transforming raw information into valuable insights. The cleaning component 7131 utilizes anomaly detection based on Isolation Forests (contamination=0.01) and DBSCAN clustering for outlier removal. For example, this operates like a quality control specialist, identifying and removing invalid or suspicious data patterns-such as bot-generated clicks or anomalous engagement spikes. The transformation component 7132 implements a custom schema evolution system using Avro with backward compatibility verification. This functions like a data standardization plant, ensuring consistent formats across all data types. The enrichment component 7133 employs feature engineering pipelines using deep learning models (DenseNet-201) for derived metric calculation, which works like a data enhancement laboratory, adding valuable derived metrics such as lifetime value predictions or propensity to purchase scores.

The storage module 7104 acts as the system's intelligent archive, maintaining data with the sophistication of a modern digital library. The data lake component 7141 utilizes Delta Lake for ACID transactions with time travel capabilities (retention=30 days), implementing data skipping and Z-ordering for optimal query performance. This functions like a vast digital repository, storing raw data in its original format for future analysis. The data warehouse 7142 employs a columnar storage format (Parquet) with predicate pushdown and partition pruning. This operates like an organized research library, maintaining structured data for efficient querying. The cache layer 7143 implements Redis clusters with adaptive cache invalidation (TTL=15 minutes) and least-recently-used eviction policy, which works like a high-speed reference desk, providing instant access to frequently requested information such as current campaign performance metrics or active customer segments.

The data services module 7105 serves as the system's information distribution center, providing controlled data access like a sophisticated research facility. The query API component 7151 utilizes GraphQL with DataLoader for batching and caching (batch size=100, cache TTL=60 s). This functions like a research librarian, helping users locate and retrieve specific data points. The analytics API component 7152 implements real-time aggregation using materialized views with incremental maintenance, which operates like a data scientist team, providing advanced analysis capabilities. The export API component 7153 employs rate-limited streaming responses (chunk size=1 MB) with resumable transfers, this works like a secure document delivery service, facilitating controlled data extraction for authorized users and systems.

The data governance module 7106 functions as the system's regulatory compliance department, ensuring proper data handling with the rigor of a financial institution. The security controls 7161 utilizes role-based access control (RBAC) with attribute-based policies (ABAC) and encryption at rest (AES-256) and in transit (TLS 1.3). The compliance rules 7162 implements automated data classification using natural language processing (BERT-base) with regular expression pattern matching for PII detection (accuracy=99.9%). This ensures all data handling meets relevant privacy and security regulations such as GDPR or CCPA.

The continuous data flow loop 7107 implements a feedback optimization system using stream processing with Apache Beam. The system maintains a sliding window of performance metrics (window size=1 hour, slide=1 minute) for adaptive optimization. Query patterns are analyzed using a custom cost-based optimizer with cardinality estimation. The system implements automated index management using machine learning (random forests) to predict query patterns and optimize physical storage layout. Performance monitoring utilizes distributed tracing (OpenTelemetry) with custom sampling strategies (sampling rate=0.1) and automatic instrumentation. The continuous data flow loop connects these components into a self-improving ecosystem. For example, when the system detects new patterns in customer behavior across channels, this information flows back through the processing pipeline, enriching existing data and improving future analysis capabilities. If certain data points consistently drive better decision-making, the system automatically adjusts its processing and storage priorities to optimize access to these valuable insights.

The entire system implements horizontal scalability through containerization (Kubernetes) with auto-scaling policies based on CPU utilization (target=70%) and request latency (p99<100 ms). Data consistency is maintained through a distributed consensus protocol (Raft) with configurable consistency levels. The system employs blue-green deployments for zero-downtime updates and maintains high availability through multi-region deployment with automated failover (RPO=0, RTO<1 minute).

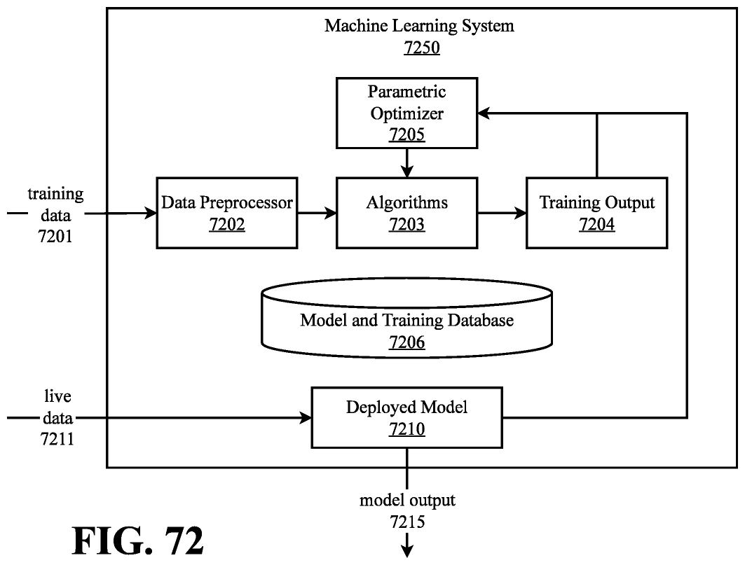

FIG. 72 is a block diagram illustrating an exemplary architecture for the AI-powered advertisement generation and optimization system's Machine Learning Engine 7250. According to the embodiment, the ML engine comprises a model training stage comprising a data preprocessor 7202, one or more machine and/or deep learning algorithms 7203, training output 7204, and a parametric optimizer 7205, and a model deployment stage comprising deployed and fully trained models 7210 configured to perform tasks described herein such as advertisement generation, visual analysis, copy optimization, and personalization.

At the model training state, a plurality of training data 7201 may be received at the ML engine. The training data includes historical advertisement performance data, user interaction data, visual elements, copy text, and campaign results. Data preprocessor 7202 performs various preprocessing tasks including data cleansing, normalization, and feature extraction. For visual data, this includes image normalization and feature extraction. For textual data, this includes tokenization and embedding generation. The preprocessor creates training (80%), validation (10%), and test (10%) datasets for model deployment.

The ML engine is fine-tuned to ensure each model performs optimally for its specific task. For computer vision models, this means optimizing for advertisement visual analysis. For NLP models, optimization focuses on copy generation and analysis. The multi-armed bandit and reinforcement learning models are tuned for optimal exploration-exploitation balance in advertisement selection and deployment. The fine-tuned models provide improved accuracy in real-time advertisement generation, analysis, and optimization.

During model training, training output 7204 measures model accuracy across multiple metrics. A parametric optimizer 7205 performs algorithmic tuning between iterations. Parameters include learning rates, network architectures, attention mechanisms, and optimization algorithms. For computer vision models, this includes convolutional layer configurations and feature extraction parameters. For NLP models, it includes transformer architecture configurations and language model parameters. For reinforcement learning, it includes state-space definitions and reward function configurations.

Various metrics evaluate model performance including: click-through rates and conversion rates; visual element effectiveness scores; copy performance metrics; user engagement measurements; cross-channel optimization metrics; and real-time personalization accuracy.

The test dataset validates model performance before deployment. Successfully trained models move to production as deployed models 7210, processing live advertisement data 7211. Model predictions feed back into the training state, enabling continuous learning from both training and live data.

A model and training database 7206 stores: training/test datasets; developed models for each component: computer vision models, NLP models, reinforcement learning models, and personalization models; historical model versions; and performance metrics.

The system implements multiple specialized algorithms including: Computer Vision: CNN architectures for visual analysis; NLP: transformer models for copy generation/analysis; Reinforcement learning: Actor-Critic architectures; Multi-Armed Bandits: Thompson Sampling implementations; Generative Models: GANs and GPT-based architectures; and Personalization: Deep learning recommendation models.

The system generates standardized model scorecards tracking: model architectures and frameworks; training data specifications; hyperparameter configurations; cross-channel performance metrics; real-time optimization results, and A/B testing outcomes.

The system generates multiple types of model output 7215 through its AI components including: Visual outputs consisting of resolution-optimized advertisement images (1024×1024, 2048×2048) with platform-specific dimensions, dynamic layouts with attention-based element positioning, and brand-compliant variations; Text outputs including AI-generated headlines (40-60 characters), body copy (50-200 words), and engagement-optimized calls-to-action, all maintaining brand voice consistency (measured on a 0-1 scale); Personalization outputs delivering user-specific content based on behavioral patterns and real-time engagement data; Performance analytics providing click-through rates, conversion tracking, and ROI calculations; and Cross-channel coordination outputs that optimize timing, budget allocation, and campaign orchestration across platforms. All outputs are continuously monitored and refined through a real-time feedback loop that updates performance metrics every 5 minutes, enabling automated content adjustments and optimization recommendations while maintaining brand safety and compliance standards through automated quality assurance checks (scoring 0-100) for visual elements, voice consistency, and regulatory requirements.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (“ASIC”), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

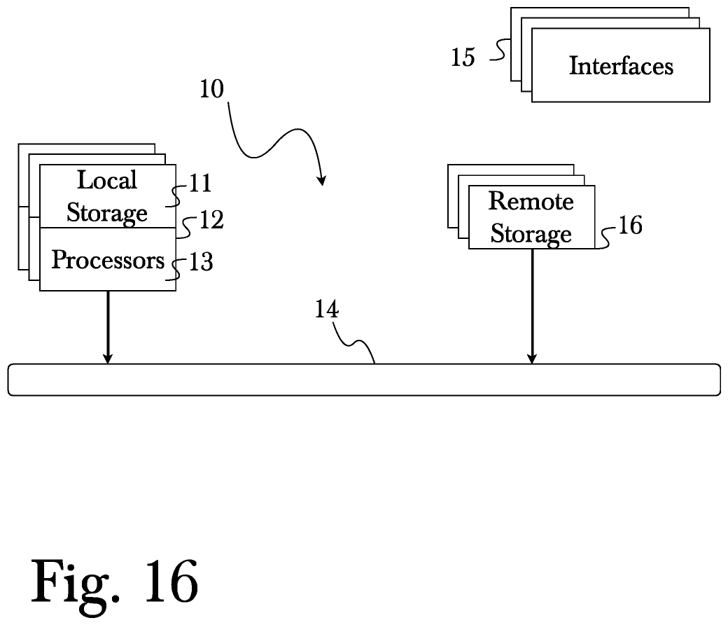

Referring now to FIG. 16, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software-or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 16 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system that includes a client device (such as a tablet device or smartphone running client software) and server systems (such as a server system described in more detail below).

Regardless of network device configuration, the system may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

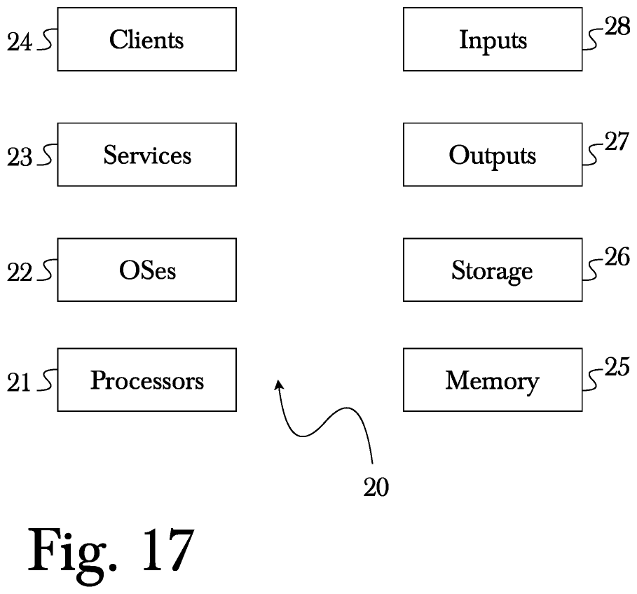

In some embodiments, systems may be implemented on a standalone computing system. Referring now to FIG. 17, there is shown a block diagram depicting a typical exemplary architecture of one or more embodiments or components thereof on a standalone computing system. Computing device 20 includes processors 21 that may run software that carry out one or more functions or applications of embodiments, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 16). Examples of storage devices 26 include flash memory, magnetic hard drive, CD-ROM, and/or the like.

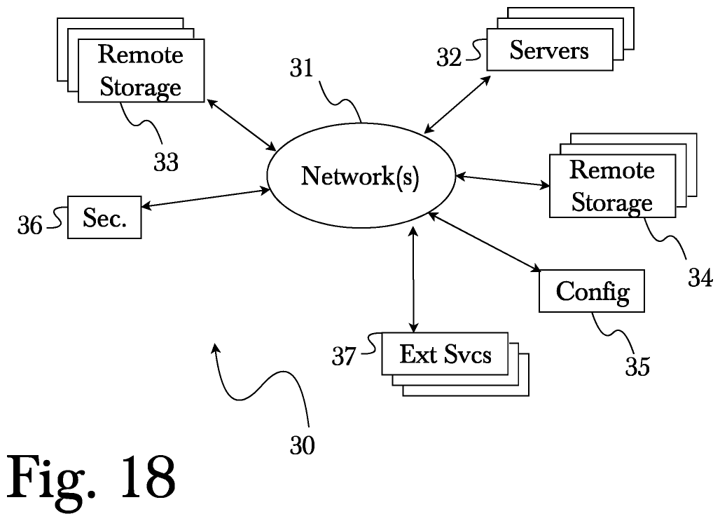

In some embodiments, systems may be implemented on a distributed computing network, such as one having any number of clients and/or servers. Referring now to FIG. 18, there is shown a block diagram depicting an exemplary architecture 30 for implementing at least a portion of a system on a distributed computing network. According to the embodiment, any number of clients 33 may be provided. Each client 33 may run software for implementing client-side portions; clients may comprise a system 20 such as that illustrated in FIG. 17. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as Wi-Fi, WiMAX, LTE, and so forth), or a local area network (or indeed any network topology known in the art. Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a SQL, while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific embodiment.

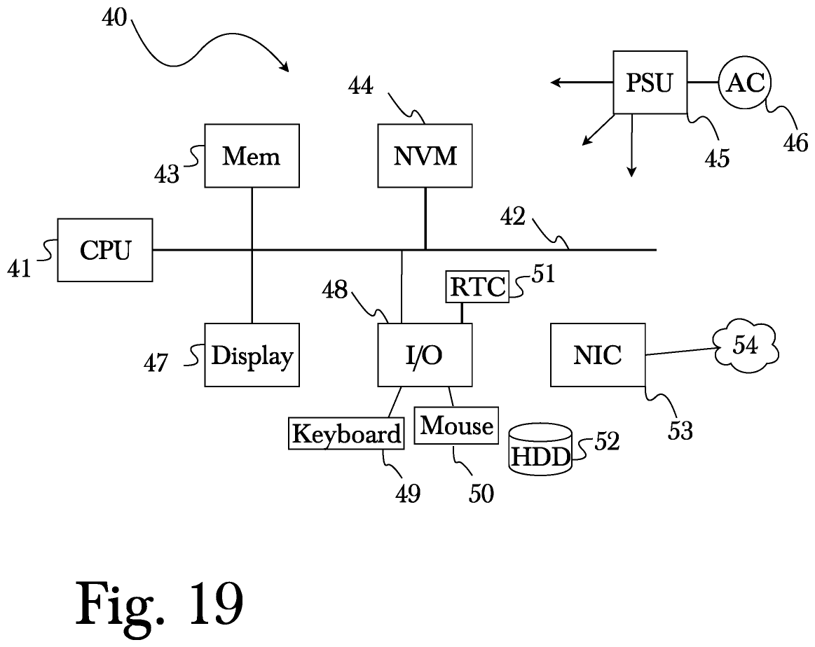

FIG. 19 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods may be distributed among any number of client and/or server components. For example, various software modules may be implemented for performing various functions in connection with the various embodiments, and such modules may be variously implemented to run on server and/or client components.

The skilled person will be aware of a range of possible modifications of the various embodiments described above. Accordingly, the present invention is defined by the claims and their equivalents.

What is claimed is:

1. A computer system comprising:
one or more processors; and
a memory storing instructions that, when executed by the one or more processors, cause the computer system to:
initialize a test advertisement, the test advertisement comprising a baseline advertisement and a variant advertisement, and being associated with test plan data comprising a test plan goal and an element variant list;
receive, from the first user device, an electronic request to establish a text-based connection to a second user device, the second user device being one of a plurality of user devices associated with an enterprise, wherein the electronic request comprises device-identifying data associated with the first user device and advertisement-identifying data associated with the test advertisement;
responsive to receiving the electronic request, create an interaction instance and store the interaction instance in an interaction database;
select the second user device from the plurality of user devices based on a routing priority, wherein the routing priority is determined using a machine learning model trained on historical interaction data associated with the enterprise;
establish, between the first user device and the second user device, a plurality of interaction control legs over one or more communication protocols selected from a group consisting of short message service (SMS), electronic mail, and web chat;
mask the device-identifying data associated with the first user device from the second user device, and mask device-identifying data associated with the second user device from the first user device, such that neither the first user device nor the second user device receives the other device's underlying contact information;
establish a real-time media stream between the first user device and the second user device, wherein content originating from the first user device in a first communication protocol is converted, by a media translation process, into a second communication protocol compatible with the second user device, and wherein content originating from the second user device in the second communication protocol is converted into the first communication protocol compatible with the first user device;
monitor the real-time media stream to collect media stream data and interaction data, wherein the media stream data comprises data indicative of a sentiment associated with the first user device toward the test advertisement;
analyze the media stream data, the test plan data, and the interaction data to statistically determine whether the baseline advertisement or the variant advertisement satisfied the test plan goal;
select, using a multi-armed bandit algorithm, one of the baseline advertisement or the variant advertisement for display to a third user device, wherein the multi-armed bandit algorithm maintains a probability distribution over the baseline advertisement and the variant advertisement, and the selection is based on a sample drawn from the probability distribution as updated using the statistical determination; and
generate, using one or more generative AI models, a new advertisement variant comprising a suggested element variant from the element variant list, the suggested element variant being selected based on the statistical determination.

2. The computer system of claim 1, wherein masking the device-identifying data associated with the first user device comprises:
generating a proxy destination address distinct from a native address of the first user device;
associating the proxy destination address with the interaction instance in the interaction database; and
routing communications directed to the first user device, from the second user device, to the proxy destination address, wherein the media translation process resolves the proxy destination address to the native address of the first user device without exposing the native address to the second user device.

3. The computer system of claim 1, wherein the instructions further cause the computer system to predict a future performance of the new advertisement variant using one or more trained neural networks.

4. The computer system of claim 1, wherein the computer system is further configured to:
process historical advertisement performance data;
identify patterns in successful advertisements; and
generate feature vectors for advertisements and users;
train deep learning models for content generation; and
continuously update models based on new performance data.

5. A computer-implemented method comprising the steps of:
initializing a test advertisement, the test advertisement comprising a baseline advertisement and a variant advertisement, and being associated with test plan data comprising a test plan goal and an element variant list;
receiving, from the first user device, an electronic request to establish a text-based connection to a second user device, the second user device being one of a plurality of user devices associated with an enterprise, wherein the electronic request comprises device-identifying data associated with the first user device and advertisement-identifying data associated with the test advertisement;
responsive to receiving the electronic request, creating an interaction instance and store the interaction instance in an interaction database;
selecting the second user device from the plurality of user devices based on a routing priority, wherein the routing priority is determined using a machine learning model trained on historical interaction data associated with the enterprise;
establishing, between the first user device and the second user device, a plurality of interaction control legs over one or more communication protocols selected from a group consisting of short message service (SMS), electronic mail, and web chat;
masking the device-identifying data associated with the first user device from the second user device, and mask device-identifying data associated with the second user device from the first user device, such that neither the first user device nor the second user device receives the other device's underlying contact information;
establishing a real-time media stream between the first user device and the second user device, wherein content originating from the first user device in a first communication protocol is converted, by a media translation process, into a second communication protocol compatible with the second user device, and wherein content originating from the second user device in the second communication protocol is converted into the first communication protocol compatible with the first user device;
monitoring the real-time media stream to collect media stream data and interaction data, wherein the media stream data comprises data indicative of a sentiment associated with the first user device toward the test advertisement;
analyzing the media stream data, the test plan data, and the interaction data to statistically determine whether the baseline advertisement or the variant advertisement satisfied the test plan goal;
selecting, using a multi-armed bandit algorithm, one of the baseline advertisement or the variant advertisement for display to a third user device, wherein the multi-armed bandit algorithm maintains a probability distribution over the baseline advertisement and the variant advertisement, and the selection is based on a sample drawn from the probability distribution as updated using the statistical determination; and
generating, using one or more generative AI models, a new advertisement variant comprising a suggested element variant from the element variant list, the suggested element variant being selected based on the statistical determination.

6. The method of claim 5, wherein masking the device-identifying data associated with the first user device comprises:
generating a proxy destination address distinct from a native address of the first user device;
associating the proxy destination address with the interaction instance in the interaction database; and
routing communications directed to the first user device, from the second user device, to the proxy destination address, wherein the media translation process resolves the proxy destination address to the native address of the first user device without exposing the native address to the second user device.

7. The method of claim 5, further comprising predicting a future performance of the new advertisement variant using one or more trained neural networks.

8. The method of claim 5, further comprising the steps of:
processing historical advertisement performance data;
identify patterns in successful advertisements; and
generating feature vectors for advertisements and users;
train deep learning models for content generation; and
continuously update models based on new performance data.
